(19) United States
(12) Patent Application Publication
(10) Pub. No.: US 2024/0092992 A1
(43) Pub. Date: Mar. 21, 2024

(54) METHOD FOR PURIFYING RECLAIMED POLYMERS

(71) Applicant: The Procter & Gamble Company, Cincinnati, OH (US)

(72) Inventors: Dimitris Ioannis Collias, Mason, OH (US); Norman Scott Broyles, Hamilton, OH (US); John Moncrief Layman, Liberty Township, OH (US)

(21) Appl. No.: 18/215,275

(22) Filed: Jun. 28, 2023

Related U.S. Application Data
(60) Provisional application No. 63/408,525, filed on Sep. 21, 2022.

(51) Int. Cl. C08J 11/08; B29B 17/02; C08F 6/28; C08L 23/04; C08L 23/10

(52) U.S. Cl. CPC C08J 11/08; B29B 17/02; C08F 6/28; C08L 23/04; C08L 23/10; B29B 2017/0293; B29K 2023/04; B29K 2023/10; C08L 2207/20

(57) ABSTRACT

A method for purifying a reclaimed polymer to a purer polymer is disclosed. In embodiments of the present invention, the method involves obtaining a reclaimed polymer, leaching various contaminants with a leaching solvent producing a leached polymer, extracting the leached polymer with a first fluid solvent to produce an extracted polymer, and then dissolving the extracted polymer in a solvent to produce a first solution comprising the dissolved polymer. The first solution is settled and then filtered. A purer polymer is separated from the resulting solution.

### FIELD OF THE INVENTION

The present invention generally relates to a method for purifying a contaminated reclaimed polymer to a purer polymer by combining a flooded leaching process and a purification process and using a leaching solvent and a pressurized solvent. More specifically, the reclaimed polymer is selected from the group consisting of post-consumer reclaimed (PCR) polymers, post-industrial reclaimed (PIR) polymers, and combinations thereof. The purer polymer is colorless or clear, odor free, and virgin-like polymer. The present invention is particularly useful for purifying polyolefins, such as polyethylene and polypropylene.

### BACKGROUND OF THE INVENTION

Synthetic polymers are ubiquitous in daily life due to their relatively low production costs and good balance of material properties. They are used in a wide variety of applications, such as packaging, automotive components, medical devices, and consumer goods. To meet the high demand of these applications, hundreds of millions of tons of synthetic polymers are produced globally on an annual basis. The overwhelming majority of these polymers are produced from increasingly scarce fossil sources, such as petroleum and natural gas. Additionally, the manufacturing of these synthetic polymers from fossil sources causes the emission of greenhouse gases (GHGs), primarily CO₂, in the atmosphere.

The ubiquitous use of synthetic polymers has consequently resulted in millions of tons of plastic waste being generated every year. While the majority of plastic waste is landfilled via municipal solid waste programs, a significant portion of plastic waste is found in the environment as litter, which is unsightly and potentially harmful to ecosystems. Plastic waste is often washed into river systems and ultimately out to sea.

Plastics recycling has emerged as one solution to mitigate the issues associated with the wide-spread usage of plastics. Recovering and re-using plastics diverts waste from landfills and reduces the demand for virgin plastics made from fossil-based resources, which consequently reduces GHG emissions. In developed regions, such as the United States and the European Union, rates of plastics recycling are increasing due to greater awareness by consumers, businesses, and industrial manufacturing operations. The majority of recycled materials, including plastics, are mixed into a single stream which is collected and processed by a material recovery facility (MRF). At the MRF, materials are sorted, washed, and packaged for resale. Plastics can be sorted into individual materials, such as high-density polyethylene (HDPE) or poly(ethylene terephthalate) (PET), or mixed streams of other common plastics, such as polypropylene (PP), low-density polyethylene (LDPE), liner low-density polyethylene (LLDPE), poly(vinyl chloride) (PVC), polystyrene (PS), polycarbonate (PC), and polyamide (PA). The single or mixed streams can then be further sorted, washed, and reprocessed at a plastics recovery facility (PRF) into pellets that are suitable for re-use in plastics processing, for example blow molding, profile extrusion, injection molding, and film making.

Though recycled plastics are sorted into predominately uniform streams and are washed with aqueous and/or caustic solutions, the final reprocessed pellet often remains highly contaminated with unwanted waste impurities, such as spoiled food residue and residual perfume components. In addition, recycled plastic pellets, except for those from recycled beverage containers, are darkly colored due to the mixture of dyes and pigments commonly used to colorize plastic articles. While there are some applications that are insensitive to color and contamination (e.g., black plastic paint containers and concealed automotive components), the majority of applications require non-colored pellets. The need for high quality, “virgin-like” recycled resin is especially important for food and drug contact applications, such as food packaging. In addition to being contaminated with impurities and mixed colorants, many recycled resin products are often heterogeneous in chemical composition and may contain a significant amount of polymeric contamination, such as polyethylene (PE) contamination in reclaimed PP and vice versa.

The utilization of these recycled plastics is currently limited due to contamination, which renders the plastics less valuable compared to virgin plastics. A key to increasing the recycling rates and lowering the GHG emissions and plastics pollution is to reduce the contamination to a level allowing broader utilization across more end markets, especially those involving demanding applications.

Films are a special case of recycled plastics and are predominately polyolefin in composition. Films offer unique challenges for recycling that have yet to be resolved. The recycled film supply stream can be split into two general categories: 1) pre-consumer recycled film, which includes both in-plant scrap/edge-trim that can be re-used in the same process that generated it and PIR film, which is film generated by internal plant waste that is not used in the same process that produced it; and 2) PCR film including post-commercial recycled film, which is film that has been used in commerce but not directly by at-home consumers (e.g., back-of-store shrink wrap, pallet wrap, wholesale bags, furniture wrap, agricultural film, etc.) and post-household recycled film, which is film that has been used in commerce directly by at-home consumers (e.g., retail bags, retail food packaging, overwraps for diapers and hygiene products, trash bags, etc.). PIR film waste for use in recycling is collected on a plant-by-plant basis for controlled end markets and may or may not involve (or require) significant cleaning steps before recycling. PCR film is collected at the point of sale and transported to various PRFs specializing in film for various cleaning operations and eventual distribution to an end market. In the US, post-household film is primarily collected in store take-back prog where the end consumer returns the film to a collection bin at a local store. Film-based PRFs collect the film waste and deliver it to end markets after sortation and cleaning. The utilization of film recycled materials is quite limited due to contamination. The contamination of films is higher than other forms due to the high surface area to volume ratio which allows greater opportunity for external contamination. Currently, most film-based recycled plastics are down-cycled into markets that are not circular and are of limited size, such as plastics lumber. As the collection of film-based waste grows, the need for end markets beyond plastics lumber is essential. Ideally, film-based waste will eventually discover a second life in film-based applications, thus ensuring ongoing circularity.

The end markets cannot grow unless contamination is greatly reduced. Considering the high volume of film that is used in the demanding applications, it is important that recycled plastics coming from these markets re-enter the same end markets to support circularity. As such, the ability to remove even greater levels of contaminants is critical to achieving circularity and reducing GHG emissions and plastics pollution. Plastics pollution is even more problematic for film considering the tremendous surface area per use and the mobility of the waste in the environment by both air and water.

While contamination is problematic for all end market applications, the demanding applications have even stricter requirements especially on certain chemical contaminants. The relevant chemical contaminants are grouped into various chemical classes depending on the chemical structure of the contaminants. Non-limiting examples of these chemical classes of contaminants are heavy metals, pesticides, dioxins, furans, polychlorinated biphenyls (PCBs), phthalates, polycyclic aromatic hydrocarbons (PAHs), organotins, bisphenols, isothiazolins, glyphosate, alkyl phenols, alkylphenol ethoxylates, aromatic amines, and flame retardants. In addition, the target levels of these contaminants can be extremely low. For instance, the target levels may be on the order of parts per million (ppm), parts per billion (ppb), and parts per trillion (ppt), wherein the initial contaminated plastic may contain levels 1,000 times the targeted levels. Net, a 1,000× reduction in chemical contamination is often required.

Mechanical recycling, also known as secondary recycling, is a process of converting recycled plastic waste into a re-usable form for subsequent manufacturing. A more detailed review of mechanical recycling and other plastics recovery processes are described in S. M. Al-Salem, P. et al., Waste Management, 29(10) (2009), 2625-2643. Mechanical recycling of rigid plastics typically involves some form of surface washing followed by drying and melt densification. The melt densification step typically includes melt filtration and devolatilization. While advances in mechanical recycling technology have improved the quality of recycled polymers to some degree, there are fundamental limitations of mechanical decontamination approaches, such as the physical entrapment of pigments within a polymer matrix. Thus, even with the improvements in mechanical recycling technology, the dark color and high levels of chemical contamination in currently available recycled plastic waste prevents broader usage of recycled resins by the plastics industry. For film-based materials, there are dry and wet processes. In the dry process, a controlled film stream is typically shredded, dried, and then melt extruded into the final form. Melt filtration and devolatilization are typically part of the extrusion step. In wet processes, a controlled film stream is typically shredded, washed in an aqueous solution or solutions, dried, and then melt extruded into the final form. Melt filtration and devolatilization are typically part of the extrusion step. The above methods are generally acceptable at removing intentional surface contamination, such as paper labels, and unintentional surface contamination, such as dirt, but are poor at removing bulk contaminants.

U.S. Pat. No. 10,022,725 discloses a mechanical recycling method for cleaning linear low-density polyethylene (LLDPE)/LDPE film for use in recycling. The '725 patent further discloses the steps of shredding, a first water washing step, a second size reduction step involving wet grinding, a friction washing step or steps where hot water is used in at least one step, a drying or multiple drying steps, and a compaction step. The method is likely to be quite effective at removing some surface contamination that is loosely bound but will be ineffective at removing bulk contamination due to extremely low solubility of the bulk contaminants in the aqueous washing media and/or limited diffusivity of the bulk contaminants within the plastic.

U.S. Pat. No. 9,616,595 discloses a mechanical recycling method for de-inking surface-printed plastic films. The '595 patent further discloses steps of grinding, ink removal steps, general washing, recovery of the cleaning solution, recovering pigments, and drying. The ink removal step involves the use of an aqueous cleaning fluid with high pH and selective cleaning agents, such as dodecyl sulfate, and high turbulence. The method claims the ability to remove surface printed ink, which potentially contributes to chemical contamination following heating in the recycling process. The process will have limited ability to remove bulk contaminants due to limited solubility of the bulk contaminants in the aqueous washing media and/or limited diffusivity of the bulk contaminants within the plastic.

To overcome the fundamental limitations of mechanical recycling, there have been many methods developed to purify contaminated polymers via chemical approaches, or chemical recycling. Most of these methods use solvents to decontaminate and purify polymers. The use of solvents enables the extraction of impurities and the dissolution of polymers, which further enables alternative separation technologies. For example, U.S. Pat. No. 7,935,736 describes a method for recycling polyester from polyester-containing waste using a solvent to dissolve the polyester prior to cleaning. The '736 patent also describes the need to use a precipitant to recover the polyester from the solvent.

U.S. Pat. No. 6,555,588 describes a method to produce a polypropylene blend from a plastic mixture comprised of other polymers. The '588 patent describes the extraction of contaminants from a polymer at a temperature below the dissolution temperature of the polymer in the selected solvent, such as hexane, for a specified residence time. The '588 patent further describes increasing the temperature of the solvent (or a second solvent) to dissolve the polymer prior to filtration. The '588 patent yet further describes the use of shearing or flow to precipitate polypropylene from solution. The polypropylene blend described in the '588 patent contained polyethylene contamination up to 5.6 wt %.

European Patent Application No. 849,312 (translated from German to English) describes a process to obtain purified polyolefins from a polyolefin-containing plastic mixture or a polyolefin-containing waste. The '312 patent application describes the extraction of polyolefin mixtures or wastes with a hydrocarbon fraction of gasoline or diesel fuel with a boiling point above 90° C. at temperatures between 90° C. and the boiling point of the hydrocarbon solvent. The '312 patent application further describes contacting a hot polyolefin solution with bleaching clay and/or activated carbon to remove foreign components from the solution. The '312 patent further describes cooling the solution to temperatures below 70° C. to crystallize the polyolefin and then removing adhering solvent by heating the polyolefin above the melting point of the polyolefin or evaporating the adhering solvent in a vacuum or passing a gas stream through the polyolefin precipitate, and/or extraction of the solvent with an alcohol or ketone that boils below the melting point of the polyolefin.

U.S. Pat. No. 5,198,471 describes a method for separating polymers from a physically commingled solid mixture (e.g., waste plastics) containing a plurality of polymers using a solvent at a first lower temperature to form a first single phase solution and a remaining solid component. The '471 patent further describes heating the solvent to higher temperatures to dissolve additional polymers that were not solubilized at the first lower temperature. The '471 patent describes filtration of insoluble polymer components.

U.S. Pat. No. 5,233,021 describes a method of extracting pure polymeric components from a multi-component structure (e.g., waste carpeting) by dissolving each component at an appropriate temperature and pressure in a supercritical fluid and then varying the temperature and/or pressure to extract particular components in sequence. However, similar to the '471 patent, the '021 patent only describes filtration of the precipitated component.

U.S. Pat. No. 5,739,270 describes a method and apparatus for continuously separating a polymer component of a plastic from contaminants and other components of the plastic using a co-solvent and a working fluid. The co-solvent at least partially dissolves the polymer and the second fluid (that is in a liquid, critical, or supercritical state) solubilizes components from the polymer and precipitates some of the dissolved polymer from the co-solvent. The '270 patent further describes the step of filtering the thermoplastic-co-solvent (with or without the working fluid) to remove particulate contaminants, such as glass particles.

U.S. Pat. No. 5,368,796 discloses a method for surface cleaning polyethylene films. The '796 patent further discloses the steps of shredding, a first surface washing step (involving a boiling solvent at a temperature below the melting temperature of the polyethylene and at or near ambient pressure, while applying vigorous mechanical agitation for 30 min to rub the ink off), a second surface washing step (involving fresh solvent below the melting temperature of the polyethylene, while applying vigorous mechanical agitation for 30 min), a third surface washing step (involving the solvent below the melting temperature of the polyethylene, while applying vigorous mechanical agitation for 30 to 60 min, and devolatilization), and melt densification. Optionally, the method may include a water washing step prior to treatment with solvent to remove surface dirt. The '796 patent further discloses that the solvent washing accomplishes extraction wherein the solvent does not dissolve the polymer. However, a small amount of wax, typically less than 1 wt % may be removed. The solvent washing and extraction steps are further disclosed as occurring at the boiling point of the solvent, which is selected to be below the softening point of the polyethylene to avoid agglomeration. The above method is focused on the removal of surface printed inks and is silent on the removal of bulk permeable contaminants such as those described previously.

U.S. Patent Application No. 2009/0178693 discloses a method for purifying a plastic. The '693 patent application further discloses a multi-step process involving granulation to form plastic chips, surface washing with supercritical CO₂, surface washing and extraction with a high boiling solvent or mixture of solvents (such as limonene and ethylene lactate), a final surface washing with supercritical CO₂ to remove the high boiling solvent on the surface, and devolatilization. Further disclosed is that the plastic chip feed material is stirred with the solvent and the shape of the chip is maintained. Also, it is disclosed that the recovered material remains as chips, which implies the process is completed at temperatures below the plastic's primary melting point.

U.S. Pat. No. 9,834,621 discloses a method for purifying polypropylene. The '621 patent further discloses contacting the reclaimed polypropylene at a temperature from about 80° C. to about 280° C. and at a pressure from about 10 atm to about 544 atm with a first fluid solvent having a standard boiling point less than about 70° C., to produce an extracted reclaimed polypropylene; dissolving the extracted reclaimed polypropylene in a solvent selected from the group consisting of the first fluid solvent, a second fluid solvent, and mixtures thereof, at a temperature from about 90° C. to about 280° C. and a pressure from about 14 atm to about 544 atm to produce a first solution comprising polypropylene, at least one dissolved contaminant, and at least one suspended contaminant; settling the first solution at a temperature from about 90° C. to about 280° C. and at a pressure from about 14 atm to about 544 atm to produce a second solution comprising polypropylene, at least one dissolved contaminant, and less of the at least one suspended contaminant; filtering the second solution at a temperature from about 90° C. to about 280° C. and at a pressure from about 14 atm to about 544 atm to produce a third solution comprising purer polypropylene, at least one dissolved contaminant, and even less of the at least one suspended contaminant; and separating the purer polypropylene from the third solution; and where the second fluid solvent has the same chemical composition or a different chemical composition as the first fluid solvent. The above method is highly suitable for removing contamination. However, the ability to dissolve, settle, and filter plastics is quite difficult and may not be feasible or practical for plastics with high molecular weight (MW), such as those used in films and blow molded containers. In addition, the above method is silent on removing surface contamination prior to extraction and dissolution, thus increasing the burden on such disclosed processes, especially filtration.

In summary, the known solvent-based methods to purify contaminated plastics, as described above, do not produce “virgin-like” polymers as they do not address the issue of removing both surface and bulk contaminants from plastics sufficiently and efficiently to enable utilization in demanding applications, particularly in films and rigid applications involving high MW plastics. Also, in the previous methods, co-dissolution and thus cross contamination of other polymers often occurs. If adsorbent is used, a filtration and/or centrifugation step is often employed to remove the used adsorbent from solution. In addition, isolation processes to remove solvent, such as heating, vacuum evaporation, and/or precipitation using a precipitating chemical, are used to produce a polymer free of residual solvent.

Accordingly, there is a need for an improved solvent-based method to purify contaminated reclaimed polymers that: 1) uses a solvent that is readily and economically removed from the polymer; 2) removes both surface and bulk contamination in an efficient way; 3) is readily simple in terms of the number of unit operations; 4) can be used in high MW plastics, such as those sourced from film and rigid applications; 5) produces a polymer without a significant amount of polymeric cross contamination; and 6) produces a virgin-like polymer (i.e., similar in properties to a virgin polymer; essentially contaminant-free, colorless, odorless, etc.).

### SUMMARY OF THE INVENTION

In embodiments of the present invention, a method for purifying a reclaimed polymer is disclosed. The method comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); b) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, and PAHs, each having a concentration; and wherein said average removal efficiency of said leached polymer is greater than about 55%; c) extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer; d) dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant; e) settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant; f) filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant; g) filtering the third solution by adsorptive filtration at a temperature from about 90° C. to about 280° C. and at a pressure from about 200 psig (1.38 MPa) to about 9,000 psig (62.05 MPa) to produce a fourth solution comprising a filtered polymer; and h) separating the filtered polymer from the fourth solution to produce a purer polymer with an average removal efficiency; wherein said purer polymer comprises at least one of pesticides, alkylphenol ethoxylates, alkylphenols, bisphenols, dioxins and dioxin-like compounds, PCBs, metals, organotins, phthalates, and PAHs each having a concentration; wherein the second fluid solvent has the same chemical composition or a different chemical composition as the first fluid solvent; and wherein said average removal efficiency of said purer polymer is greater than about 75%.

In embodiments of the present invention, a method for purifying a reclaimed polymer is disclosed. The method comprises: a) obtaining the reclaimed polyethylene; wherein the reclaimed polyethylene is post-consumer reclaimed (PCR) polyethylene; and wherein said reclaimed polyethylene comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); b) surface washing said reclaimed polymer in a non-densified state to produce a surface-washed polymer; wherein said surface washing results in a greater than about 80% reduction in loosely bound surface contamination; c) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature between about 55° C. and about 65° C. and at a pressure of about atmospheric, using ethyl acetate, in a counter-current auger extraction, for a total residence time, to produce a leached polymer comprising at least one of pesticides, alkylphenol ethoxylates, alkylphenols, bisphenols, dioxins and dioxin-like compounds, PCBs, metals, organotins, phthalates, and PAHs, each having a concentration; wherein said average removal efficiency of said leached polymer is greater than about 90%; d) extracting the leached polymer at a temperature of about 160° C. and at a pressure of about 3,000 psig (20.7 MPa) with normal butane to produce an extracted polymer; e) dissolving the extracted polymer in normal butane at a temperature of about 160° C. and at a pressure of about 4,700 psig (32.4 MPa) to produce a first solution comprising a dissolved polymer, at least one dissolved contaminant, and at least one suspended contaminant; f) settling the first solution at a temperature of about 160° C. and at a pressure of about 4,700 psig (32.4 MPa) to produce a second solution comprising a settled polymer, at least one dissolved contaminant, and less of the at least one suspended contaminant; g) filtering the second solution by mechanical filtration at a temperature of about 160° C. and at a pressure of about 4,700 psig (32.4 MPa) to produce a third solution comprising a filtered polymer, at least one dissolved contaminant, and even less of the at least one suspended contaminant; h) filtering the third solution by adsorptive filtration at a temperature of about 160° C. and at a pressure of about 4,700 psig (32.4 MPa) by contacting the third solution with one or more solid media to produce a fourth solution comprising a twice filtered polymer; and i) separating the filtered polymer from the fourth solution to produce a purer polymer with an average removal efficiency; wherein said purer polymer comprises at least one of pesticides, alkylphenol ethoxylates, alkylphenols, bisphenols, dioxins and dioxin-like compounds, PCBs, metals, organotins, phthalates, and PAHs each having a concentration; and wherein said average removal efficiency of said purer polymer is greater than about 95%.

### BRIEF DESCRIPTION OF THE DRAWINGS

FIG. 1A is a block flow diagram showing the major steps of one embodiment of the present invention.

FIG. 1B is a block flow diagram showing the major steps of another embodiment of the present invention.

FIG. 2 is a calibration curve for the calculation of polyethylene content in polypropylene using enthalpy values from DSC measurements.

FIG. 3A is a schematic of the experimental apparatus used in the extraction step of the dissolution recycling process.

FIG. 3B is a schematic of the experimental apparatus used in the dissolution, settling, filtration, and separation steps of the dissolution recycling process.

FIG. 4 is a table with the removal data from the dissolution recycling process alone, flooded leaching process alone, and a combined process of flooded leaching and dissolution recycling.

### DETAILED DESCRIPTION OF THE INVENTION

### I. Definitions

As used herein, the term “plastic” refers to polymer, such as polyethylene (PE), PP, PET, LLDPE, LDPE, HDPE, polyethylene co-polymers, ethyl vinyl acetate copolymer (EVA), ethyl vinyl alcohol copolymer (EVOH), ethylene acrylic acid copolymer (EAA), PS, PC, PVC, styrene butadiene styrene (SBS), PA, etc., or mixtures thereof. Such polymers are characterized by high MW, which generally determines melt processability and solid-state mechanical properties. For the purposes of the present invention, the terms “polymer” and “plastic” are used interchangeably, and the term “MW” refers to the weight-average molecular weight of the polymer.

As used herein, the term “reclaimed polymer” refers to a polymer used for a previous purpose and then recovered for further processing.

As used herein, the term “post-consumer” refers to a source of material that originates after the end consumer has used the material in a consumer good or product.

As used herein, the term “post-consumer reclaimed” (PCR) refers to a material that is produced after the end consumer has used the material and has disposed of the material in a waste stream.

As used herein, the term “post-industrial reclaimed” (PIR) refers to a source of a material that originates during the manufacture of a good or product and before its consumer use.

As used herein, the term “fluid solvent” refers to a substance that may exist in the liquid state under specified conditions of temperature and pressure. In some embodiments, the fluid solvent may be a predominantly homogenous chemical composition of one molecule or isomer, while in other embodiments, the fluid solvent may be a mixture of several different molecular compositions or isomers. Further, in some embodiments of the present invention, the term “fluid solvent” may also apply to substances that are at, near, or above the critical temperature and critical pressure (critical point) of that substance. It is well known to those having ordinary skill in the art that substances above the critical point of that substance are known as “supercritical fluids” which do not have the typical physical properties (i.e., density) of a liquid.

As used herein, the term “dissolved” means at least partial incorporation of a solute (polymeric or non-polymeric) in a solvent at the molecular level. Further, the thermodynamic stability of the solute/solvent solution can be described by the following equation: ΔGₘᵢₓ=ΔHₘᵢₓ−TΔSₘᵢₓ, where ΔGₘᵢₓ is the Gibbs free energy change of mixing of a solute with a solvent, ΔHₘᵢₓ is the enthalpy change of mixing, T is the absolute temperature, and ΔSₘᵢₓ is the entropy of mixing. To maintain a stable solution of a solute in a solvent, the Gibbs free energy must be negative and at a minimum. Thus, any combination of solute and solvent that minimize a negative Gibbs free energy at appropriate temperatures and pressures can be used for the present invention.

As used herein, the term “standard boiling point” refers to the boiling temperature at an absolute pressure of exactly 100 kPa (1 bar, 14.5 psia, 0.9869 atm) as established by the International Union of Pure and Applied Chemistry (IUPAC).

As used herein, the term “standard enthalpy change of vaporization” refers to the enthalpy change required to transform a specified quantity of a substance from a liquid into a vapor at the standard boiling point of the substance.

As used herein, the term “polymer solution” refers to a solution of polymer dissolved in a solvent. The polymer solution may contain undissolved matter (e.g., at least one suspended contaminant) and thus the polymer solution may also be a “slurry” of undissolved matter suspended in a solution of polymer dissolved in a solvent.

As used herein, the terms “sedimentation” and “settling” are used interchangeably and refer to the tendency of particles within a suspension to separate from a liquid in response to a force (typically a gravitational force) acting upon the particles.

As used herein, the term “suspended contaminant” refers to an unwanted or undesired constituent present throughout the bulk of medium of a heterogeneous mixture.

As used herein, the term “dissolved contaminant” refers to an unwanted or undesired constituent at least partially incorporated into a solvent at the molecular level.

As used herein, the term “filtration” and “filtering” refers to a separation of at least one dissolved and/or suspended contaminant from a fluid by using mechanical and/or physical operations (e.g., passing the contaminated fluid through a filtration system). As used herein, the terms “filtration system” and “filter” are used interchangeably.

As used herein, when referring to a solution, the term “less suspended contaminant” refers to a subsequent condition of the solution, with respect to a prior condition (e.g., prior to a contaminant removal step), in which the prior solution had a relatively greater quantity of the suspended contaminant.

As used herein, when referring to a solution, the term “comprising even less of a suspended contaminant” refers to a subsequent condition of the solution, with respect to a prior condition (e.g., “comprising less of a suspended contaminant”), in which the prior solution had a relatively greater quantity of the suspended contaminant.

As used herein, the terms “solid media” and “solid medium” refer to a substance that exists in the solid state under the conditions of use. The solid media may be crystalline, semi-crystalline, or amorphous. The solid media may be granular and may be supplied in different shapes (i.e., spheres, cylinders, pellets, etc.). If the solid media are granular, the particle size and particle size distribution of solid media may be defined by the mesh size used to classify the granular media. An example of standard mesh size designations can be found in the American Society for Testing and Materials (ASTM) standard ASTM E11 “Standard Specification for Woven Wire Test Sieve Cloth and Test Sieves.” The solid media may also be a non-woven fibrous mat or a woven textile.

As used herein, the term “purer polymer solution” refers to a polymer solution having less of one or more contaminants relative to the same polymer solution prior to a purification step.

As used herein, the term “extraction” refers to the practice of transferring a solute species from a liquid phase (or solid matrix) across a phase boundary to a separate immiscible liquid phase. The driving force(s) for extraction are described by partition theory.

As used herein, the term “extracted” refers to a material having less of one or more solute species relative to the same material prior to an extraction step. As used herein, the term “extracted reclaimed polymer” refers to a reclaimed polymer having less of one or more solute species relative to the same reclaimed polymer prior to an extraction step.

As used herein, the term “virgin-like” means essentially contaminant-free, colorless odorless, homogenous, and similar in properties to virgin polymers.

As used herein, the term “primarily polypropylene copolymer” refers a copolymer with greater than 70 mol % of propylene repeating units.

As used herein, the term “primarily polyethylene copolymer” refers a copolymer with greater than 70 mol % of ethylene repeating units.

As used herein, any reference to international units of pressure (e.g., MPa) refers to gauge pressure.

As used herein, the term “axial flow direction” refers to a fluid flowing parallel to the long axis of a filter medium.

As used herein, the term “radial flow direction” refers to a fluid flowing perpendicular to the long axis of a filter medium.

As used herein, the term “candle filter” refers to an apparatus that uses pressure to separate solids from a liquid. A detailed description of candle filters, as well as other solid-liquid separation apparatuses, is provided in the following reference: Perry, Robert H, and Don W. Green. Perry's Chemical Engineers' Handbook. New York: McGraw-Hill, 2008.

As used herein, the term “pre-coated with filtration aid” refers to a solid-liquid separation apparatus where the filtration medium is comprised of a rigid or semi-rigid screen on which a layer or layers of fine solid material (e.g., diatomaceous earth, perlite, cellulosic fiber, clay, activated carbon, alumina, silica, alumina silicate, zeolite, and mixtures thereof) are deposited.

As used herein, the term “body feed” refers to the addition of filtration aid to a fluid before the fluid is filtered.

As used herein, the term “contaminant” refers to any undesirable material contained on the surface of the plastic or in the bulk of the plastic. The term “chemical contaminant” refers to any undesirable chemical species on the surface of the plastic or within the bulk of the plastic and comprises the molecular or elemental composition of the contaminant. The terms may be used interchangeably depending upon the intent. For example, paper contamination comprises cellulose. Net, cellulose would be one chemical contaminant within the paper contaminant.

As used herein, the term “contamination” refers to the sum of all contaminants and the term “chemical contamination” refers to the sum of all chemical contaminants. The chemical contaminants are grouped in classes, which include chemical contaminants that have similar chemical structure. For example, As, Hg, and Cr are chemical contaminants in the “heavy metals” classification. Each contaminant may have different chemical attributes, such as solubility and diffusivity in the plastic, and target levels depending upon concentration and end use market.

As used herein, the term “surface contaminant” refers to a contaminant that is on the surface of the plastic. Similarly, the term “surface chemical contaminant” refers to the molecular or elemental composition of the surface contaminant. The surface contaminant may be attached to the surface of the plastic either loosely through physical attraction forces, or more strongly through polar or other forces. In general, a surface contaminant will have less than about 80% of its surface area embedded in the plastic.

As used herein, the term “bulk contaminant” refers to a contaminant that is in the bulk of the plastic. Similarly, the term “bulk chemical contaminant” refers to the molecular or elemental composition of the bulk contaminant. In general, a bulk contaminant will have more than about 80% of its surface area embedded in the plastic.

As used herein, the term “surface contamination” and “surface chemical contamination” refers to the sum of all surface contaminants and all surface chemical contaminants, respectively.

As used herein, the term “bulk contamination” and “bulk chemical contamination” refers to the sum of all bulk contaminants and all bulk chemical contaminants, respectively.

As used herein, the term “total contamination” refers to the sum of the surface contamination and bulk contamination and the sum of all the surface chemical contamination and bulk chemical contamination, respectively.

As used herein, the term “permeable contaminant” refers to a chemical contaminant that is both soluble and diffusible in the plastic. Non-limiting examples of permeable contaminants are formaldehyde, bisphenol A, and naphthalene.

As used herein, the term “impermeable contaminant” refers to a chemical contaminant that is either insoluble or non-diffusible in the plastic. Non-limiting examples of impermeable contaminants are heavy metals and gel particles composed of cross-linked or ultra-high MW plastic (too large to diffuse).

As used herein, the term “permeable contamination” refers to the sum of all permeable contaminants, and the term “impermeable contamination” refers to the sum of all impermeable contaminants. The sum of all permeable and impermeable contamination is the “chemical contamination” if described in molecular or elemental terms or just simply “the contamination” if described in general terms (such as cellulose vs paper).

As used herein, the term “intentional contaminant” refers to a contaminant that is intentionally added by the supply chain for a specific purpose to benefit the producer, retailer, or consumer, but may not be desired in the recycled plastic. Examples include print, paper labels, adhesives for labels, pigments (such as TiO₂), process additives (such as antioxidant—AO), etc., that are necessary for marketing, branding, processability, and/or end use performance. As used herein, the term “intentional chemical contaminant” refers to an intentional contaminant described by its chemical composition. As used herein, the term “intentional contamination” refers to the sum of all intentional contaminants and the term “intentional chemical contamination” refers to the sum of all intentional contaminants described by their chemical composition.

As used herein, the surface area to volume ratio of the plastic is calculated as follows. For generally spherical objects, like pellets, ground pellets, micronized pellets, etc., the surface area to volume ratio is calculated by 3/r, where r is the mass average radius. For generally flat and thin objects, like film, the surface area to volume ratio is calculated by 2/t, where t is the mass average thickness. For generally long columnar objects, like fibers, the surface area to volume ratio is calculated by 2/r, where r is the mass average radius. For the purposes of the present invention, the terms “mass average surface area to volume ratio” and “surface area to volume ratio” are used interchangeably.

As used herein, the term “unintentional contaminant” refers to any contaminant not intentionally added. Examples include dirt and cross-contamination that is not intentionally added by the producer, retailer, or consumer. As used herein, the term “unintentional chemical contaminant” refers to an unintentional contaminant described by its chemical composition. As used herein, the term “unintentional contamination” refers to the sum of all unintentional contaminants and the term “unintentional chemical contamination” refers to the sum of all unintentional contaminants described by their chemical composition.

As used herein, the term “densified” refers to a state of plastic in which the bulk density of the plastic is higher than the bulk density of the original/pre-densified plastic and the original surface of the plastic is reduced and/or rendered inaccessible to wetting fluids. The process of producing a densified material is referred to as densification.

As used herein, the term “melt densification” refers to densification done near, at, or above the primary melting point of the plastic. Non-limiting methods of melt densification include melt extrusion and agglomeration with equipment, such as the Herbold HV series plastcompactor.

As used herein, the term “primary melting point” refers to the peak melting point (highest endothermic peak on a zero-slope baseline) of the plastic as measured using Differential Scanning calorimetry (DSC). For the purposes of the present invention, the terms “primary melting point”, “melting point”, “melting temperature”, and “primary melting temperature” are used interchangeably. For amorphous materials and/or materials lacking a distinct melting point, the defining temperature will be the approximate softening point of the material, which may be best characterized by the glass transition temperature. Those skilled in the art will understand the appropriateness of the criteria for non-semi-crystalline materials.

As used herein, the term “hexanes” refers to a blend of hexane isomers, such as normal hexane (at least 45 vol %, and typically, about 53 vol %), isohexane (2-methylpentane, 3-methylpentane, and 2,3-dimethylbutane), and neohexane (2,2-dimethylbutane).

As used herein, the term “limit of quantification” or “LOQ” refers to the lower detection limit for a given chemical contaminant as determined by the analytical methods disclosed in Section IX. The LOQ is a function of the methods used and may vary from test method to test method. The LOQ used herein is specific to the method listed in Section IX.

As used herein, the term “removal efficiency” refers to the efficiency of a process to remove a particular contaminant, is calculated as 100×(initial concentration−final concentration)/initial concentration and expressed as a percentage. In case the final concentration is lower than LOQ and for simplicity, the removal efficiency is considered 100%. In certain cases, the purer plastic will have a higher level of a contaminant than the reclaimed polymer due to: 1) measurement error, 2) contaminant hot spots and cold spots in the reclaimed polymer, and 3) external contamination during sampling. In such cases, the removal efficiency is set to 0% to not bias the average results. If such occurs consistently for a given process, then such is more likely attributable to the process and should be more closely examined, but such was not generally the case for the processes of the present invention. As used herein, the term “average removal efficiency” refers to the average of the removal efficiency for each contaminant.

For the purposes of the present invention, the terms “purification process” and “dissolution recycling process” are used interchangeably. Also, for the purposes of the present invention, the terms “step” and “process step” are used interchangeably.

As used herein, the word “or” when used as a connector of two or more elements is meant to include the elements individually and in combination; for example X or Y, means X or Y or both.

As used herein, the articles “a” and “an” are understood to mean one or more of the material that is claimed or described.

### II. Reclaimed Polymer

Polymers are predominately free of contamination when first produced at resin suppliers (virgin polymers), such as Dow, Nova, ExxonMobil, etc. However, during the polymer's lifecycle (from production through distribution, consumer use, and eventual recycling) contamination is introduced either intentionally or unintentionally.

Non-limiting examples of intentional contamination include surface print, paper labels, adhesives for labels, pigments (such as TiO₂), process additives (such as AO), etc., that are necessary for marketing, branding, processability, and/or end use performance. Non-limiting examples of unintentional contamination are dirt, cross-contamination, certain heavy metals, pesticides, dioxins, furans, PCBs, etc. Also, unintentional contamination can be produced from reactions involving intentional contaminants, such as the oxidation of paper labels to dioxins, degradation of adhesives or print binders, etc. Most of the latter occurs during melt densification methods used during the recycling process. Further, oxidation of the plastic during melt processing steps, such as those used for original package or product creation and/or latter recycling, will produce unintentional contamination, such as gels. In addition, unintentional contamination may result from interaction with products. For example, packaging materials that contain cleaning mixtures (e.g., limonene, surfactants, etc.), food (e.g., various organics), etc., will potentially become contaminated with such products. Finally, unintentional contamination can enter the plastic during production, e.g., contamination of a plastic with reaction by-products, unreacted monomers, etc.

It is recognized that different reclaimed polymer sources have different contamination and associated risks. Clearly, reclaimed polymer streams of unknown origin and lifecycle will be most abundant but also represent the highest potential for contamination. On the other side, controlled reclaimed polymer streams are available and represent lower potential risk for demanding applications. For instance, if a reclaimed polymer stream is known to be from demanding applications, then such reclaimed polymer stream will not contain any undesirable contaminants up to the point of distribution to the consumer else these plastics would not have been approved for use in these applications. As such, contamination preventing re-use in these same applications would primarily be unintentional contamination, which must originate from external sources and enter the plastic through surface contamination. A small amount of contamination could result from reactions involving intentional contamination such as oxidation of cellulosic materials to dioxins during melt densification.

Pre-consumer plastic generally has the lowest level of contamination due to its known composition and controlled history. It may include intentional contamination, such as surface print and opacifiers, but because these are known and controlled, it is quite easy to find applications tolerating such known contaminants. In addition, pre-consumer plastic tends to have low amounts of unintentional contamination due to the controlled history preventing external contamination. Thus, pre-consumer plastics that were originally destined for use in demanding applications will be ideal sources of reclaimed polymer for the same end markets with minimal cleaning/purification. The latter pre-consumer plastic in the form of film is referred to as “Approved Sourced Post-Industrial Film” (ASPIF). On the downside, the ASPIF stream is very limited in supply and does not support circularity.

Post-consumer plastics are generally more contaminated than pre-consumer plastics. The post-commercial subclass of post-consumer plastic has the next lowest level of contamination relative to pre-consumer recycled considering the somewhat controlled life cycle within the commerce supply chain. In general, post-commercial reclaim plastic will have a known and controlled level of intentional contamination, thus enabling broad utilization as reclaimed polymer. However, unintentional contamination is known to be ubiquitous and problematic with this stream, which prevents broad usage in demanding applications. Post-commercial plastic that is sourced from demanding applications, will be potentially usable back into these fields following adequate cleaning/purification. Post-commercial plastic sourced from demanding applications in the form of film is referred to as “Approved Source Post-Commercial Film” (ASPCF). To accommodate the on-going need of purer reclaimed polymer, recycled material suppliers have recently introduced post-commercial film sources with more controlled and known history. These new sources are called High-Custody sources and are primarily utilized with the post-commercial film stream. Net, High-Custody Post-Commercial film sources should have reduced level of contamination relative to general post-commercial film sources. On the downside, these High-Custody sources are of limited volume and are more costly.

The post-household subclass of post-consumer has the highest level of contamination considering the uncontrolled life cycle within the commerce channel. Such plastic has high levels of both intentional and unintentional contamination that is highly variable, unknown, and uncontrolled. Such plastic may include plastic sources that were originally unacceptable for use in demanding applications. As such, there are limited markets for this plastic source and essentially none in the demanding applications.

Surprisingly, plastics made purer by the present invention may allow source plastics from post-industrial (both ASPIF and uncontrolled source), post-commercial (both ASPCF and uncontrolled source), and post-household plastic to be used more broadly in the demanding applications with some limitations. In addition, most recycled material customers desire purer materials beyond what is available today and the purer plastics of the present invention meet this broader need for purer plastics from any source.

For the purposes of the present invention, non-limiting examples of polymer are film, sheet, injection molded parts, blow molded parts, fiber, non-wovens, wovens, thermoformed parts, and extruded strands.

The reclaimed polymer can be a first-life plastic (has been used only once before it entered the reclaimed polymer stream), second-life plastic (has been used twice before it entered the reclaimed polymer stream), or higher-life plastic (has been used many times before it entered the reclaimed polymer stream). In embodiments of the present invention, the reclaimed polymer comprises a virgin plastic. In embodiments of the present invention, the reclaimed polymer comprises film. In embodiments of the present invention, the reclaimed polymer is selected from the group comprising film, injection molded part, blow molded part, fiber, nonwoven, woven, thermoformed part, extruded strand, or mixtures thereof.

In embodiments of the present invention, the reclaimed polymer comprises a regrind/edge-trim/in-plant waste plastic. In embodiments of the present invention, the reclaimed polymer comprises a PIR polymer. In embodiments of the present invention, the reclaimed polymer comprises a PIR polymer film. In embodiments of the present invention, the reclaimed polymer comprises a PIR polymer non-woven. In embodiments of the present invention, the PIR polymer film is ASPIF. In embodiments of the present invention, the reclaimed polymer comprises a PCR polymer. In embodiments of the present invention, the reclaimed polymer comprises a PCR polymer film. In embodiments of the present invention, the reclaimed polymer comprises a PCR polymer non-woven. In embodiments of the present invention, the PCR polymer film is ASPCF. In embodiments of the present invention, the reclaimed polymer comprises High-Custody PCR polymer film. In embodiments of the present invention, the reclaimed polymer comprises a post-household polymer. In embodiments of the present invention, the reclaimed polymer comprises a post-household polymer film. In embodiments of the present invention, the reclaimed polymer comprises a post-household polymer non-woven.

In embodiments of the present invention, the reclaimed polymer comprises PS, co-polystyrene, PA, co-polyamides, PC, thermoplastic elastomers, styrenic block copolymers, polyesters, co-polyesters, PVC, and copolymers of any of the above and mixtures of any of the above. In embodiments of the present invention, the reclaimed polymer comprises polyolefins, polyolefin copolymers, and polyolefin polar copolymers. In embodiments of the present invention, the reclaimed polymer comprises LDPE and LLDPE copolymers. In embodiments of the present invention, the reclaimed polymer comprises PP. In embodiments of the present invention, the reclaimed polymer comprises HDPE and HDPE copolymers. In embodiments of the present invention, the reclaimed polymer comprises film, and the film comprises polyethylene and poly ethylene copolymers.

In embodiments of the present invention, the reclaimed polymer is PCR polymer. In embodiments of the present invention, the reclaimed polymer is a polypropylene homopolymer or a primarily polypropylene copolymer. In embodiments of the present invention, the reclaimed polymer is a polyethylene homopolymer or a primarily polyethylene copolymer. In embodiments of the present invention, a method for purifying a reclaimed polymer comprises obtaining the reclaimed polymer; and wherein the reclaimed polymer is selected from the group consisting of PCR polymers, PIR polymers, and combinations thereof. The reclaimed polymer may be in many forms including, but not limited to, pellets, micronized pellets, ground pellets, shredded film, shredded or ground injection molded parts, shredded or ground blow molded parts, thermoformed parts, shredded nonwoven or woven, extruded strands, or agglomerated particles. In embodiments of the present invention, the reclaimed polymer comprises pellets.

In embodiments of the present invention, the reclaimed polymers has an average surface area to volume ratio greater than about 1 mm⁻¹. In embodiments of the present invention, the reclaimed polymers has an average surface area to volume ratio greater than about 5 mm⁻¹. In embodiments of the present invention, the reclaimed polymers has an average surface area to volume ratio greater than about 20 mm⁻¹. In embodiments of the present invention, the reclaimed polymers has an average surface area to volume ratio greater than about 50 mm⁻¹.

For the purposes of the present invention, the reclaimed polymer is sourced from post-consumer, post-industrial, post-commercial, and/or other special reclaimed waste streams. For example, PCR polymers can be derived from curbside recycled streams where end-consumers place used polymers from packages and products into a designated bin for collection by a waste hauler or recycler. PCR polymers can also be derived from in-store “take-back” programs where the consumer brings waste polymers into a store and places the waste polymers in a designated collection bin. An example of PIR polymers can be waste polymers produced during the manufacture or shipment of a good or product that are collected as unusable material by the manufacturer (i.e., trim scraps, out of specification material, start-up scrap). An example of waste polymers from a special waste stream can be waste polymers derived from the recycling of electronic waste, also known as “e-waste.” Another example of waste polymers from a special waste stream can be waste polymers derived from the recycling of automobiles. Another example of waste polymers from a special waste stream can be waste polymers derived from the recycling of used carpeting and textiles.

For the purposes of the present invention, the reclaimed polymer is a homogenous composition of an individual polymer or a mixture of several different polymer compositions. Non-limiting examples of reclaimed polymeric compositions are homopolymers and copolymers of polyolefins, such as polyethylene and isotactic polypropylene, polyesters, such as poly(ethylene terephthalate), vinyl polymers, such as poly(vinyl chloride), styrenic polymers, such as polystyrene, polyamides, such as poly(hexamethylene adipamide), polycarbonates, such as poly(bisphenol-A carbonate), polyacrylates, such as poly(methyl methacrylate), polysiloxanes, such as poly(dimethylsiloxane), thermoplastic elastomers, such as styrene-butadiene block copolymers and ethylene-propylene rubber, and other dissolvable polymers that may be apparent to those having ordinary skill in the art.

The reclaimed polymer may also contain various pigments, dyes, process aides, stabilizing additives, fillers, and other performance additives that were added to the polymer during polymerization or conversion of the original polymer to the final form of an article. Non-limiting examples of pigments are organic pigments, such as copper phthalocyanine, inorganic pigments, such as titanium dioxide, and other pigments that may be apparent to those having ordinary skill in the art. A non-limiting example of an organic dye is Basic Yellow 51. Non-limiting examples of process aides are antistatic agents, such as glycerol monostearate and slip-promoting agents, such as erucamide. A non-limiting example of a stabilizing additive is octadecyl-3-(3,5-di-tert·butyl-4-hydroxyphenyl)-propionate. Non-limiting examples of fillers are calcium carbonate, talc, and glass fibers.

### III. Contaminants

Contaminants can generally be broken down into two migration categories: 1) permeable; and 2) impermeable. Contaminants that are permeable have solubility and diffusivity in the reclaimed polymer to allow migration into, through the polymer, and out of the polymer due to a chemical potential gradient. In other words, permeable contaminants and the grouping called permeable contamination are mobile. Impermeable implies that the contaminant does not have sufficient solubility and diffusivity to significantly move into, through the polymer, and out of the polymer. In other words, impermeable contamination represented by the summation of all impermeable contaminants is essentially immobile. Net, wherever impermeable contamination is first deposited, such contamination will remain in that location until physically removed, convectively transferred, or placed in contact with a different material which is permeable to the contaminant.

The chemical contaminants in the reclaimed polymer may be numerous but generally fall into one of several relevant chemical classes. Non-limiting examples of relevant chemical classes are pesticides, aldehydes, allergic fragrances, izioalines, alkylphenol ethoxylates, alkylphenols, bisphenols, dioxins, dioxin-like compounds, furans, PCBs, organotins, metals, phthalates, and polyaromatic hydrocarbons (PAHs). Only some of these chemical classes are routinely found in pre- and post-consumer reclaimed polymers, such as pesticides, alkylphenol ethoxylates, alkylphenols, bisphenols, dioxins, dioxin-like compounds, furans, PCBs, metals, organotins, phthalates, and PAHs.

Using the analytical methods disclosed in Section IX, the LOQs of the various contaminants may differ by orders of magnitude. For example, the LOQ of a typical pesticide is about 10 ppb; the LOQ of a typical alkylphenol ethoxylate is about 50 ppb; the LOQ of a typical alkylphenol is about 5 ppb; the LOQ of bisphenol-A is about 5 ppb; the LOQ of a typical dioxin is about 0.2 ppt; the LOQ of a typical furan is about 0.2 ppt; the LOQ of a typical PCB is about 5 ppt; the LOQ of a typical heavy metal is about 100 ppb; the LOQ of a typical organotin is about 300 ppt; the LOQ of a typical phthalate is 50 ppb; the LOQ of a typical PAH is 1 ppb.

Several film sources were broadly classified for chemical contamination including three ASPIF sources, three High-Custody Post-Commercial Film sources, three post-commercial film sources, and one post-household film source using the analytical methods disclosed in Section IX, as shown in TABLES 1a-1i. To simplify the presentation of chemical contamination results, the concentration data are displayed in terms of LOQ instead of absolute weight fraction. For example, if the contaminant concentration is 10 ppm and the LOQ is 1 ppm, then the concentration would be 10×LOQ or just 10 displayed in the data tables. Also, “dnt” stands for “did not test”.

### Tables 1a-1i

### Chemical Contamination of ASPIF, High-Custody Post-Commercial (HCPC), Post-Commercial (PC), and Post-Household (PH) Film Sources

TABLE 1a
Chemical Contamination - Pesticides

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Pesticides | xLOQ | | | | | | | | | |
| Pendimethalin | <1 | <1 | <1 | <1 | <1 | <1 | <1 | <1 | <1 | 1.4 |
| Diethyltoluamide (DEET) | <1 | <1 | <1 | <1 | <1 | <1 | <1 | <1 | <1 | 3.7 |
| Piperonyl butoxide | <1 | <1 | <1 | <1 | <1 | <1 | 1.0 | 12.0 | 28.0 | 6.6 |
| Phenylphenol, ortho- | <1 | <1 | <1 | <1 | <1 | <1 | 1.1 | <1 | <1 | <1 |
| Chlorprofam | <1 | <1 | <1 | <1 | <1 | <1 | <1 | <1 | <1 | 1.3 |
| Permethrin | <1 | <1 | <1 | <1 | <1 | <1 | <1 | <1 | <1 | 3.0 |

TABLE 1b
Chemical Contamination - Alkylphenol Ethoxylates

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Alkylphenol ethoxylates | xLOQ | | | | | | | | | |
| 4-t-Octylphenolmonoethoxylate | <1 | <1 | <1 | <1 | <1 | <1 | 10.6 | <1 | 4.2 | 9.4 |
| 4-t-Octylphenoldiethoxylate | <1 | <1 | <1 | <1 | <1 | <1 | 5.2 | <1 | 3.6 | 9.0 |
| 4-t-Octylphenoltriethoxylate | <1 | <1 | <1 | <1 | <1 | <1 | 4.2 | <1 | 5.0 | 6.6 |
| 4-t-Octylphenoltetraethoxylate | <1 | <1 | <1 | <1 | <1 | <1 | 4.4 | <1 | 5.6 | 8.4 |
| 4-t-Octylphenolpentaethoxylate | <1 | <1 | <1 | <1 | <1 | <1 | 2.6 | <1 | 6.0 | 11.2 |
| 4-t-Octylphenolhexaethoxylate | <1 | <1 | <1 | <1 | <1 | <1 | 5 | <1 | 6.2 | 17.4 |
| iso-Nonylphenolmonoethoxylate | <1 | <1 | <1 | <1 | <1 | <1 | 2.4 | 1.7 | <1 | 4.0 |
| iso-Nonylphenoldiethoxylate | <1 | <1 | <1 | <1 | <1 | <1 | 2.8 | 8.6 | <1 | 28.0 |
| iso-Nonylphenoltriethoxylate | <1 | <1 | <1 | <1 | <1 | <1 | 3.2 | 6.2 | 5.8 | 32.0 |
| iso-Nonylphenoltetraethoxylate | <1 | <1 | <1 | <1 | <1 | <1 | 1.8 | 4.2 | 6.2 | 22.0 |
| iso-Nonylphenolpentaethoxylate | <1 | <1 | <1 | <1 | <1 | <1 | 2.2 | <1 | 6.2 | 19.2 |
| iso-Nonylphenolhexaethoxylate | <1 | <1 | <1 | <1 | <1 | <1 | <1 | <1 | <1 | 12.0 |

TABLE 1c
Chemical Contamination - Alkylphenols

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Alkylphenols | xLOQ | | | | | | | | | |
| iso-Nonylphenol | 2.2 | <1 | 320.0 | 190.0 | 120.0 | 86.0 | 920.0 | 168.0 | 260.0 | 300.0 |
| 4-tert-Butylphenol | <1 | <1 | <1 | 3.8 | 1.2 | <1 | 2 | 2.4 | <1 | 6.8 |
| 4-tert-Pentylphenol | <1 | 24.0 | 550.0 | 19.4 | 52.0 | 40.0 | 1660.0 | 3.6 | 116.0 | 1720.0 |

TABLE 1d
Chemical Contamination - Bisphenols

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Bisphenols | xLOQ | | | | | | | | | |
| Bisphenol A | <1 | <1 | <1 | 46,000.0 | 1800.0 | 114.0 | 4.8 | 320.0 | 760.0 | 144 |

TABLE 1e
Chemical Contamination - Dioxins, Dioxin-like compounds, Furans, and PCBs

| Parameter | ASPIF | | | HCPC | | | PC | | | PH |
|---|---|---|---|---|---|---|---|---|---|---|
| Dioxins and dioxin-like | #1 | #2 | #3 | #1 | #2 | #3 | #1 | #2 | #3 | #1 |
| compounds and PCB | xLOQ | | | | | | | | | |
| 1,2,3,4,7,8-HxCDD | <1 | <1 | <1 | <1 | <1 | <1 | <1 | <1 | <1 | 1.9 |
| 1,2,3,6,7,8-HxCDD | <1 | <1 | <1 | <1 | <1 | <1 | <1 | <1 | 6.1 | 7.4 |
| 1,2,3,7,8,9-HxCDD | <1 | <1 | <1 | <1 | <1 | <1 | <1 | <1 | 3.8 | 4.5 |
| 1,2,3,4,6,7,8-HpCDD | <1 | <1 | <1 | 2.8 | <1 | 3.4 | 3.8 | 10.9 | 84.5 | 63.0 |
| OCDD | <1 | <1 | <1 | 11.1 | 2.6 | 8.9 | 39.6 | 17.2 | 205.0 | 308.5 |
| 2,3,7,8-TCDF | <1 | <1 | <1 | 2.6 | 1.8 | 1.2 | 2.6 | 4.7 | <1 | 16.5 |
| 1,2,3,7,8-PeCDF | <1 | <1 | <1 | <1 | <1 | <1 | <1 | <1 | 2.7 | <1 |
| 2,3,4,7,8-PeCDF | <1 | <1 | <1 | <1 | <1 | <1 | <1 | <1 | <1 | 2.1 |
| 1,2,3,4,7,8-HxCDF | <1 | <1 | <1 | <1 | <1 | <1 | <1 | <1 | 3.3 | 2.0 |
| 1,2,3,6,7,8-HxCDF | <1 | <1 | <1 | <1 | <1 | <1 | <1 | <1 | 2.2 | 1.3 |
| 1,2,3,4,6,7,8-HpCDF | <1 | <1 | <1 | <1 | <1 | <1 | 1.29 | <1 | 7.9 | 6.2 |
| OCDF | <1 | <1 | <1 | <1 | <1 | <1 | 5.45 | <1 | 6.5 | 13.8 |
| PCB 77 | <1 | <1 | <1 | 26.8 | 13.4 | 12.2 | 8.25 | 2.7 | 39.2 | 83.0 |
| PCB 81 | <1 | <1 | <1 | 46.4 | 19.9 | 21.8 | 10.58 | 5.6 | 88.2 | 79.4 |
| PCB 126 | <1 | <1 | <1 | 11 | 6.3 | 13.3 | 19.1 | 2.9 | 65.2 | 128.8 |
| PCB 169 | <1 | <1 | <1 | <1 | <1 | <1 | <1 | <1 | <1 | 11.2 |
| PCB 105 | <1 | <1 | <1 | 24.6 | 9.9 | 9.2 | 35.2 | 19.8 | 157.2 | 116.4 |
| PCB 114 | <1 | <1 | <1 | 1.9 | <1 | <1 | 2.22 | 1.3 | 10.5 | 7.1 |
| PCB 118 | <1 | <1 | <1 | 50.7 | 14.5 | 14.3 | 45.7 | 28.5 | 227.0 | 15.1 |
| PCB 123 | <1 | <1 | <1 | 4.9 | 1.8 | 2 | 4.46 | 6.6 | 23.8 | 28.0 |
| PCB 156 | <1 | <1 | <1 | 5.7 | 2.8 | <1 | 3.52 | 4.9 | 24.2 | 22.4 |
| PCB 157 | <1 | <1 | <1 | <1 | <1 | <1 | <1 | <1 | 5.0 | <1 |
| PCB 167 | <1 | <1 | <1 | 3.1 | 1.3 | <1 | <1 | 2.6 | 13.7 | 7.9 |
| PCB 189 | <1 | <1 | <1 | <1 | <1 | <1 | <1 | <1 | 1.3 | <1 |

TABLE 1f
Chemical Contamination - Metals

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Elements | xLOQ | | | | | | | | | |
| Aluminium | 7.6 | <1 | 88.0 | 99.0 | 76.0 | dnt | dnt | dnt | 349 | 503.0 |
| Antimony | <1 | <1 | <1 | <1 | <1 | dnt | dnt | dnt | 2.0 | 9.0 |
| Arsenic | <1 | 9.0 | <1 | <1 | <1 | dnt | dnt | dnt | <1 | 1.0 |
| Barium | <1 | <1 | 2.8 | <1 | <1 | dnt | dnt | dnt | 4.8 | 288.0 |
| Bismuth | <1 | 295 | <1 | <1 | <1 | dnt | dnt | dnt | <1 | 1.0 |
| Lead | <1 | <1 | <1 | <1 | <1 | dnt | dnt | dnt | 3.0 | 140.0 |
| Boron | <1 | 3 | <1 | <1 | <1 | dnt | dnt | dnt | 4.4 | 1.4 |
| Calcium | 6.2 | 12.0 | 794.0 | 6.2 | 2.6 | dnt | dnt | dnt | 56.0 | 690.0 |
| Cerium | <1 | <1 | <1 | <1 | <1 | dnt | dnt | Dnt | 2.0 | 3.0 |
| Chromium | <1 | <1 | 7.0 | <1 | <1 | dnt | dnt | dnt | 7.0 | 45.0 |
| Cobalt | <1 | <1 | <1 | <1 | <1 | dnt | dnt | dnt | 5.0 | 1.0 |
| Iron | <1 | <1 | 45.0 | 9.3 | 3.4 | dnt | dnt | dnt | 77.0 | 160.0 |
| Gallium | <1 | <1 | <1 | <1 | <1 | dnt | dnt | dnt | <1 | 1.0 |
| Germanium | <1 | 3.0 | <1 | <1 | <1 | dnt | dnt | dnt | <1 | <1 |
| Iridium | <1 | 126.0 | <1 | <1 | <1 | dnt | dnt | dnt | <1 | <1 |
| Potassium | <1 | 2.0 | <1 | <1 | 1 | dnt | dnt | dnt | 2.1 | 7.2 |
| Copper | <1 | 1.0 | 4.0 | 4.0 | <1 | dnt | dnt | dnt | 9.0 | 360.0 |
| Lithium | <1 | 568.0 | <1 | <1 | <1 | dnt | dnt | dnt | 3.0 | 3.0 |
| Magnesium | 32.0 | <1 | 226.0 | 64.0 | 26.0 | dnt | dnt | dnt | 154.0 | 1172.0 |
| Manganese | <1 | 11.1 | 8.0 | <1 | 1 | dnt | dnt | dnt | 10.0 | 35.0 |
| Molybdenum | <1 | <1 | <1 | <1 | <1 | dnt | dnt | dnt | <1 | 22.0 |
| Sodium | <1 | <1 | 222.0 | 74.0 | 72.0 | dnt | dnt | dnt | 132.0 | 358.0 |
| Nickel | <1 | <1 | <1 | <1 | <1 | dnt | dnt | dnt | 4.0 | 6.0 |
| Phosphorus | 3.9 | <1 | 5.9 | 4.0 | 3.9 | dnt | dnt | dnt | 2.2 | 6.2 |
| Rubidium | <1 | 3.4 | <1 | <1 | <1 | dnt | dnt | dnt | <1 | <1 |
| Ruthenium | <1 | 2.0 | <1 | <1 | <1 | dnt | dnt | dnt | <1 | <1 |
| Strontium | <1 | 8.2 | 8.4 | <1 | <1 | dnt | dnt | dnt | 2.2 | 17.2 |
| Titanium | 4.0 | <1 | 36.0 | 4.4 | 3 | dnt | dnt | dnt | 80.0 | 7900.0 |
| Uranium | <1 | 240 | <1 | <1 | <1 | dnt | dnt | dnt | <1 | <1 |
| Tungsten | <1 | 41 | <1 | <1 | <1 | dnt | dnt | dnt | <1 | 6.0 |
| Yttrium | <1 | <1 | <1 | <1 | <1 | dnt | dnt | dnt | <1 | 3.0 |
| Zinc | 2.0 | 240.0 | 2470.0 | 100.0 | 2920.0 | dnt | dnt | dnt | 3150 | 890.0 |
| Tin | <1 | <1 | <1 | <1 | <1 | dnt | dnt | dnt | <1 | 8.0 |
| Zirconium | <1 | 41.0 | 1.0 | <1 | 2.0 | dnt | dnt | dnt | 4.0 | 48.0 |

TABLE 1g
Chemical Contamination - Organotins

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Organotin compounds | xLOQ | | | | | | | | | |
| Monomethyltin | 2.0 | <1 | <1 | <1 | <1 | dnt | dnt | <1 | dnt | <1 |
| Dimethyltin | <1 | <1 | <1 | 4.0 | <1 | dnt | dnt | <1 | dnt | 5.0 |
| Monobutyltin | <1 | <1 | <1 | 4.0 | 5.0 | dnt | dnt | 2.3 | dnt | 3.0 |
| Dibutyltin | 1.7 | <1 | <1 | 1.3 | <1 | dnt | dnt | 20.7 | dnt | 11.7 |
| Tributyltin | <1 | <1 | <1 | <1 | <1 | dnt | dnt | <1 | dnt | 3.0 |
| Dioctyltin | <1 | <1 | <1 | 45.0 | <1 | dnt | dnt | <1 | dnt | 2.0 |

TABLE 1h
Chemical Contamination - Phthalates

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| Phthalates | xLOQ | | | | | | | | | |
| Di-2-propylheptyl phthalate | <1 | <1 | <1 | <1 | <1 | 1.2 | <1 | 1.7 | 1.2 | 14.6 |
| Diethyl phthalate | <1 | <1 | <1 | <1 | <1 | <1 | <1 | <1 | <1 | 4.6 |
| Diisobutyl phthalate | <1 | <1 | <1 | 24 | 9.6 | 1.3 | 12.6 | 6.2 | 6.6 | 22.0 |
| Dibutyl phthalate | <1 | <1 | <1 | 26 | 10.8 | 8.4 | 4.6 | 9.2 | 22.0 | 32.0 |
| Dimethoxyethyl phthalate | <1 | <1 | <1 | <1 | <1 | <1 | <1 | <1 | 1.7 | <1 |
| Benzylbutyl phthalate | <1 | <1 | <1 | <1 | <1 | <1 | <1 | <1 | 2.6 | 10.4 |
| Di-2-ethylhexyl phthalate | <1 | <1 | <1 | 12.8 | 8.4 | 3.0 | 12.6 | 15.4 | 17.8 | 700.0 |
| Diisononyl phthalate | <1 | <1 | <1 | <1 | <1 | <1 | 24 | 20.0 | 26.0 | 240.0 |

TABLE 1i
Chemical Contamination - PAHs

| | ASPIF | | | HCPC | | | PC | | | PH |
|---|---|---|---|---|---|---|---|---|---|---|
| Parameter | #1 | #2 | #3 | #1 | #2 | #3 | #1 | #2 | #3 | #1 |
| PAHs | xLOQ | | | | | | | | | |
| Acenaphthene | <1 | <1 | <1 | 10 | 5.6 | 3.8 | 4.1 | 9.7 | 1.8 | 22.0 |
| Acenaphthylene | <1 | <1 | <1 | <1.0 | <1 | <1 | <1 | 8.2 | <1 | <1 |
| Anthracene | <1 | <1 | <1 | 1.9 | 1.4 | 2.7 | <1 | 11.0 | 7.1 | 6.8 |
| Benzo[a]anthracene | <1 | <1 | <1 | <1.0 | <1 | <1 | <1 | 2.4 | 2.1 | 6.6 |
| Benzo[a]pyrene | <1 | <1 | <1 | <1.0 | <1 | <1 | <1 | <1 | <1 | 5.1 |
| Benzo[b]fluoranthene | <1 | <1 | <1 | <1.0 | <1 | <1 | <1 | 1.3 | 1.5 | 6.3 |
| Benzo[c]fluorene | <1 | <1 | <1 | <1.0 | <1 | <1 | <1 | <1 | <1 | 1.8 |
| Benzo[e]pyrene | <1 | <1 | <1 | <1.0 | <1 | <1 | <1 | 1.4 | 1.7 | 6.5 |
| Benzo[g,h,i]perylene | <1 | <1 | <1 | <1.0 | <1 | <1 | <1 | 1.4 | 1.7 | 12.0 |
| Benzo[j]fluoranthene | <1 | <1 | <1 | <1.0 | <1 | <1 | <1 | <1 | 1.2 | 2.9 |
| Benzo[k]fluoranthene | <1 | <1 | <1 | <1.0 | <1 | <1 | <1 | <1 | <1 | 2.4 |
| Chrysene | <1 | <1 | <1 | <1.0 | <1 | <1 | <1 | 2.9 | 3.8 | 8.5 |
| Fluoranthene | <1 | <1 | <1 | 33.0 | 11.0 | 7.9 | 8.3 | 46.0 | 63.0 | 44.0 |
| Fluorene | 1.5 | <1 | <1 | 18.0 | 8.5 | 7.6 | 7 | 21.0 | 2.7 | 20.0 |
| Indeno[1,2,3-c,d]pyrene | <1 | <1 | <1 | <1.0 | <1 | <1 | <1 | <1 | <1 | 4.1 |
| Naphthalene | 2.4 | <1 | <1 | 6.0 | <1 | 5.3 | 2.8 | 14.0 | <1 | 5.7 |
| Phenanthrene | 5.2 | <1 | <1 | 59.0 | 27.0 | 28.0 | 18.0 | 120.0 | 62.0 | 100.0 |
| Pyrene | <1 | <1 | <1 | 29.0 | 13.0 | 9.2 | 9.9 | 33.0 | 59.0 | 57.0 |

The tested ASPIF sources were primarily absent detectable levels of chemical contaminants except for alkylphenols and heavy metals and small amounts of organotins and PAHs. The chemical contaminant results for these ASPIF sources serve as a guide for the level of chemical contamination representative of these controlled end markets and demonstrates that heavy metals, which are of low transfer risk anyway, are ubiquitous across all film sources. Hence, heavy metals were not included in ongoing analysis within this application. The tested High-Custody Post-Commercial film sources were largely free of pesticides and alkylphenol ethoxylates, but contained detectable levels of alkylphenols, bisphenol-A, dioxins/furans/PCBs, and PAHs and low levels of phthalates. The tested Post-Commercial Film sources were heavily contaminated with every class evaluated; for example, dioxins were typically as high as 40×LOQ, but for one source, dioxins were as high as 200×LOQ. The tested post-household source was the most heavily contaminated; for example, dioxins were as high as 300×LOQ, and PCBs were as high as 180×LOQ.

From TABLES 1a-1i, representative chemical species were selected from the various classes based upon prevalence across the spectrum of reclaimed polymer sources. The selected chemicals within these classes are: piperonyl butoxide representing pesticides; 4-t-octylphenolhexaethoxylate and iso-nonylphenoltriethoxylate representing alkylphenol ethoxylates; iso-nonylphenol and 4-tert-pentylphenol representing alkylphenols; bisphenol-A representing phenols; 1.2.3.6.7.8-HxCDD, 1.2.3.4.6.7.8-HpCDD, and OCDD representing dioxins; OCDF representing furans; PCB 105 and PCB 118 representing PCBs; monobutyltin and dibutyltin representing organotins; dibutyl phthalate and di-2-ethylhexyl phthalate representing phthalates; and fluoranthene and phenanthrene representing PAHs (Table 2).

In embodiments of the present invention, said chemical contaminants in said reclaimed polymer include at least one chemical contaminant and such is selected from the group comprising pesticides, alkyl phenols, alkylphenol ethoxylates, bisphenols, dioxins, furans, PCBs, phthalates, PAHs, or mixtures thereof.

In embodiments of the present invention, the pesticides comprise piperonyl butoxide, benzalkonium chloride (BAC), N,N-diethyl-meta-toluamide (DEET), and didecyldimethylammonium chloride (DDAC). In embodiments of the present invention, the alkylphenol ethoxylates comprise iso-Nonylphenolmonoethoxylate, iso-Nonylphenoldiethoxylate, iso-Nonylphenoltriethoxylate, and iso-Nonylphenoltetraethoxylate. In embodiments of the present invention, the alkyl phenols comprise iso-Nonylphenol, 4-tert-butylphenol, and 4-tert-Pentylphenol. In embodiments of the present invention, the bisphenols comprise bisphenol-A. In embodiments of the present invention, the dioxins comprise 1,2,3,6,7,8-HxCDD, 1.2.3.4.6.7.8-HpCDD, and OCDD. In embodiments of the present invention, the furans comprise OCDF. In embodiments of the present invention, the PCBs comprise PCB 77, PCB 81, PCB 126, PCB 105, PCB 114, PCB 118, PCB 123, PCB 156, and PCB 167. In embodiments of the present invention, the phthalates comprise di-2-propylheptyl phthalate, disobutyl phthalate, dibutyl phthalate, di-1-ethylhexyl phthalate, and diisononyl phthalate. In embodiments of the present invention, the PAHs comprise acenaphthene, acenaphthylene, anthracene, benzo[a]anthracene, benzo[b]fluoroanthene, benzo[e]pyrene, benzo[g.h.i]perylene, chrysene, cyclopenta[c.d]pyrene, flyoroanthene, fluorene, naphthalene, phenanthrene, and pyrene. In embodiments of the present invention, the organotins comprise monobutylin, dibutyltin, and dioctylin.

In embodiments of the present invention, the contaminants in the reclaimed polymer may comprise 4-tert-pentylphenol. In embodiments of the present invention, the contaminants in the reclaimed polymer may comprise bisphenol-A. In embodiments of the present invention, the contaminants in the reclaimed polymer may comprise OCDD. In embodiments of the present invention, the contaminants in the reclaimed polymer may comprise PCB 118. In embodiments of the present invention, the contaminants in the reclaimed polymer may comprise di-2-ethylhexyl phthalate.

In order to simplify the presentation of the purification results for objects of the present invention and associated examples, the number of chemical species presented per chemical class is limited to the aforementioned representative chemical species for each chemical class as shown in Table 2 along with the associated LOQ and the respective levels for the tested ASPIF sources. Even though more in-depth and complete chemical analysis was completed for all objects of the present invention, only the selected chemicals are shown ongoing. This simplification does not impact or alter the inventive matter or conclusions reached from such. The selected chemicals, adequately and consistently represent the broader class with respect to purification.

TABLE 2
Selected Chemical Contaminants and
Associated LOQ Concentrations

| | LOQ | |
|---|---|---|
| Pesticides | | |
| Piperonyl butoxide | 10 | ppb |
| Alkylphenol ethoxylates | | |
| 4-t-Octylphenolhexaethoxylate | 5 | ppb |
| iso-Nonylphenoltriethoxylate | 50 | ppb |
| Alkylphenols | | |
| iso-Nonylphenol | 50 | ppb |
| 4-tert-Pentylphenol | 5 | ppb |
| Bisphenols | | |
| Bisphenol A | 5 | ppb |
| Dioxins, Dioxin-like compounds, and PCB | | |
| 1,2,3,4,6,7,8-HpCDD | 0.2 | ppt |
| OCDD | 0.2 | ppt |
| OCDF | 0.2 | ppt |
| PCB 105 | 5 | ppt |
| PCB 118 | 10 | ppt |
| Organotin compounds | | |
| Monobutyltin | 300 | ppt |
| Dibutyltin | 300 | ppt |
| Phthalates | | |
| Dibutyl phthalate | 50 | ppb |
| Di-2-ethylhexyl phthalate | 50 | ppb |
| PAHs | | |
| Fluoranthene | 1 | ppb |
| Phenanthrene | 1 | ppb |

In embodiments of the present invention, the concentration of each pesticide in the purer plastic is lower than its respective LOQ; wherein the reclaimed polymer has at least one detectable pesticide. In embodiments of the present invention, the concentration of bis-phenol A in the purer plastic is lower than its respective LOQ; wherein the reclaimed polymer has at least detectable bis-phenol A. In embodiments of the present invention, the concentration of each dioxin in the purer plastic is lower than its respective LOQ; wherein the reclaimed polymer has at least one detectable dioxin. In embodiments of the present invention, the concentration of each PCB in the purer plastic is lower than its respective LOQ; wherein the reclaimed polymer has at least one detectable PCB. In embodiments of the present invention, the concentration of each phthalate in the purer plastic is lower than its respective LOQ; wherein the reclaimed polymer has at least one detectable phthalate.

In embodiments of the present invention, the concentration of piperonyl butoxide in said purer plastic is less than about 10 ppb; wherein said reclaimed polymer has a concentration of piperonyl butoxide above 10 ppb; the concentration of 4-tert-Pentylphenol in said purer plastic is less than about 5 ppb; wherein said reclaimed polymer has a concentration of 4-tert-pentylphenol is above 5 ppb; the concentration of bisphenol-A in said purer plastic is less than about 5 ppb; wherein said reclaimed polymer has a concentration of bisphenol-A is above 5 ppb; the concentration of OCDD in said purer plastic is less than about 0.2 ppt; wherein said reclaimed polymer has a concentration of OCDD above 0.2 ppt; the concentration of PCB 118 in said purer plastic is less than about 10 ppt; wherein said reclaimed polymer has a concentration of PCB 118 above 10 ppt; and the concentration of di-2-ethylhexyl phthalate in said purer plastic is less than about 50 ppb; wherein said reclaimed polymer has a concentration of di-2-ethylhexyl phthalate above 50 ppb.

In embodiments of the present invention, the removal efficiency of the piperonyl butoxide contaminant is greater than 55%; and the concentration of said piperonyl butoxide in the reclaimed polymer is at least 10 ppb. In embodiments of the present invention, the removal efficiency of the piperonyl butoxide contaminant is greater than 85%; and the concentration of said piperonyl butoxide in the reclaimed polymer is greater than about 10 ppb.

In embodiments of the present invention, the removal efficiency of the 4-tert-pentylphenol contaminant is greater than 55% wherein said 4-tert-pentylphenol concentration in the reclaimed polymer is at least 5 ppb. In embodiments of the present invention, the removal efficiency of the 4-tert-pentylphenol contaminant is greater than 85% wherein said 4-tert-pentylphenol concentration in the reclaimed polymer is at least 5 ppb.

In embodiments of the present invention, the removal efficiency of the bisphenol A contaminant is greater than 55%, and the concentration of said bisphenol A in the reclaimed polymer is at least 5 ppb. In embodiments of the present invention, the removal efficiency of the bisphenol A contaminant is greater than 79%, and the concentration of said bisphenol A concentration in the reclaimed polymer is greater than about 5 ppb.

In embodiments of the present invention, the removal efficiency of the OCDD contaminant is greater than 55%, and the concentration of said OCDD in the reclaimed polymer is greater than about 0.2 ppt. In embodiments of the present invention, the removal efficiency of the OCDD contaminant is greater than 95%, and the concentration of said OCDD in the reclaimed polymer is greater than about 0.2 ppt.

In embodiments of the present invention, the removal efficiency of the OCDF contaminant is greater than 55%, and the concentration of said OCDF in the reclaimed polymer is greater than about 0.2 ppt. In embodiments of the present invention, the removal efficiency of the OCDF contaminant is greater than 93%, and the concentration of said OCDF in the reclaimed polymer is greater than about 0.2 ppt.

In embodiments of the present invention, the removal efficiency of the PCB 118 contaminant is greater than 55%, and the concentration of said PCB 118 in the reclaimed polymer is at least 10 ppt. In embodiments of the present invention, the removal efficiency of the PCB 118 contaminant is greater than 66%, and the concentration of said PCB 118 in the reclaimed polymer is greater than about 10 ppt.

In embodiments of the present invention, the removal efficiency of the Di-2-ethylhexyl phthalate contaminant is greater than 55%, and the concentration of said Di-2-ethylhexyl phthalate in the reclaimed polymer is greater than about 50 ppb. In embodiments of the present invention, the removal efficiency of the Di-2-ethylhexyl phthalate contaminant is greater than 78%, and the concentration of said Di-2-ethylhexyl phthalate in the reclaimed polymer is greater than about 50 ppb.

In embodiments of the present invention, the removal efficiency of the Phenanthrene contaminant is greater than 55%, and the concentration of said Phenanthrene in the reclaimed polymer is at least 1 ppb. In embodiments of the present invention, the removal efficiency of the Phenanthrene contaminant is greater than 93%, and the concentration of said Phenanthrene in the reclaimed polymer is at least 1 ppb.

Contamination can be located on the surface of the plastic or in the bulk. Contamination on the surface is most readily and easily removed by surface cleaning technologies available on the market today. If the surface contamination is permeable in the plastic, then it will become bulk contamination over time through diffusion mechanisms, thus complicating reduction and limit the effectiveness of surface cleaning technologies. If the surface contamination is impermeable in the plastic, then such contamination will not diffuse into the bulk and will be reduced by simple surface cleaning methods, such as aqueous washing. Bulk contamination of either permeable or impermeable type typically cannot be effectively removed via simple surface purification methods, such as aqueous washing. Bulk contamination of the impermeable type (also known as bulk impermeable contamination) is trapped in the bulk plastic and may be freed through mechanisms comprising melt convection, melt filtration, or dissolution/disintegration of the bulk plastic.

As discussed previously, contamination can be introduced externally throughout the lifecycle of the plastic. If the contamination is impermeable, then such contamination will largely remain on the surface during the plastic lifecycle up to the point of reclaiming. If the contamination is permeable, then over time, the contamination will migrate into the bulk plastic. Thus, absent a contamination or purification event, the contamination will remain essentially constant, but the balance of surface to bulk contamination will change with time but will approach equilibrium at long time. In general, loosely bound surface contamination, such as dirt, may be in the 0.01 to about 0.1 wt %; whereas the chemical contamination, especially the chemical contaminants of concern for this invention, will be at the ppm, ppb, or even ppt levels.

Permeable and impermeable contamination represents different challenges in the demanding applications. For instance, permeable contamination, whether in the bulk plastic or on the surface of the plastic, will have the potential to migrate to uncontaminated materials, such as a product or to human skin. Thus, if a package contains permeable contaminants, then such contaminants will have the potential to migrate into the product and render it unsuitable for these demanding end markets. However, if the contaminant is impermeable and in the bulk of the plastic, then it will have low ability to transfer to the product or to the user's skin unless the bulk plastic is disintegrated or ingested. Thus, a package could potentially use this contaminated plastic material and not risk contamination transfer to the product or transfer directly to skin. However, if the contaminant is impermeable and on the surface of the plastic, then such contamination would have the ability to transfer to the product or skin by direct contact transfer and would be unacceptable for use in these demanding applications. Surface contamination, both permeable and impermeable, can be transformed into bulk contamination through convective mechanism, such as melt mixing and melt densification. These methods exchange or eliminate surface area with bulk material. For example, if surface contaminated film is melt-densified or melt extruded into a different shape, such as a pellet, then all original surface contamination will become bulk contamination whether such is impermeable or not and such bulk contamination will be more difficult to remove with purification processes. Melt densification is common in the recycle industry. It is also common in the recycle industry to shred incoming plastics. The latter methods generally do not convert surface contamination to bulk contamination. Ideally, surface purification methods, such as surface washing, take place on the original contaminated surface such as shredded film wherein all original surface area is reachable by the surface washing fluid.

In general, surface contamination and bulk contamination are difficult to differentiate using analytical methods. Most analytical methods for permeable chemical contaminants involve solvent extraction of the contaminant from the plastic over extended periods of time greater than 6 h and with exposure to extreme solvent to plastic mass ratios greater than 100:1 and then quantifying the contaminant in the solvent using methods, such as Gas Chromatography—Mass Spectrometry (GC-MS). Such analytical methods quantify contamination but do not differentiate surface from bulk contaminants. The efficiency of a purification method to remove surface contamination can be estimated from the difference in contamination before and after the surface cleaning step but such assumes bulk contamination is not significant impacted, which is likely the case for surface washing with aqueous surface washing fluids discussed in the current invention. A more accurate way to quantify surface contamination is through washing and then solvent extraction of the contaminant at various times and then extrapolating the amount of the contaminant removed at infinitesimal time, which will approximate the amount of surface contamination. However, this method is time consuming and costly especially for contaminants that are difficult to measure in general. In addition, since the balance of surface and bulk contaminants are dynamic, it is difficult to quantify without referencing an exact sampling time. A simple method for quantifying general surface contamination (not chemical surface contamination or species based chemical contaminants) is weighing the reclaimed polymer before and after the surface washing step.

In general, bulk contamination will not be appreciably removed by simple aqueous surface washing. Permeable bulk contamination can be removed by diffusion mechanisms through gradients in chemical potential. Whereas bulk impermeable contamination is essentially trapped by the bulk polymer and methods to free the trapped contaminant comprise melt convection, melt filtration, and dissolution/disintegration of the plastic.

1. In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of alkyl phenols, bisphenols, dioxins, PCBs, and phthalates. In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of 4-tertpentylphenol, bisphenol A, OCDD, PCB 118, and 2-ethylhexyl phthalate. In embodiments of the present invention, said alkyl phenols, bisphenols, dioxins, PCBs, and phthalates comprise at least one of 4-tertpentylphenol, bisphenol A, OCDD, PCB 118, and 2-ethylhexyl phthalate.

### IV. Surface Purification Process

Surface purification reduces surface contamination. One such method is surface washing with a surface washing fluid that is typically water-based. Surface washing is ideally completed before any melt mixing or melt densification to allow effective cleaning of the original contaminated surface. The reclaimed polymer will generally be in the form of pellets, loose or compacted film, loose or compacted flexible packages, loose or compacted rigids, loose or compacted non-wovens, etc. which will be difficult to surface wash due to excessive overall size. Hence, prior to surface washing, a granulation or shredding step is preferred. For films, it is especially important to exfoliate all available film layers, such that the washing fluid can access all original surface contamination. Thus, the size reduction step prior to surface washing should not significantly decrease the average surface area to volume ratio of the reclaimed source or exchange such with new surface area.

In embodiments of the present invention, said surface washing of said reclaimed polymer is conducted after a shredding or granulation step. The surface washing will include significant mechanical agitation to loosen surface dirt and other contaminants to allow physical removal and transfer to the washing fluid wherein the dirt or other contaminants may or may not solubilize.

As used herein, in a surface washing step, the reclaimed plastic in its original contaminated form (except for the possibility of bulk size reduction that does not eliminate more than 25% of the original surface) is contacted with an aqueous solution under mechanical agitation and then separated from the aqueous media, which now contains such contamination. Such a surface washing step will in general remove the majority of loosely bound surface contamination including but not limited to dirt, wood, loosely bound paper, and some surface chemical contamination. Typical levels of loosely bound surface contamination for film based reclaimed sources are between about 0.01 and 0.1 wt %. In embodiments of the present invention, the surface washing will remove greater than about 80% of the loosely bound surface contamination.

Surface washing technologies are available extensively on the market. One technology is from Lindner (Lindner Washtech GmbH, Häldenfeld 4, Germany). The technology is described in detail elsewhere (https://www.lindner-washtech.com/system-solutions) but involves water washing under vigorous mechanical agitation and the potential for application of caustic to remove adhesives followed by drying and pelletization. Another technology is from Herbold (Herbold Meckesheim USA, North Smithfield, RI). The technology is described in detail elsewhere (https://www.herbold.com/en/machines/washing-separating-drying-2/), but also involves various water washing steps under vigorous mechanical agitation followed by drying and pelletization. Another technology is from Sorema (Sorema S.r.l., Anzano del Parco, Italy). The technology is described in detail elsewhere (http://sorema.it/en_US/applications/washing-line/) but involves similar aqueous operations relative to Lindner and Herbold. Finally, another technology is from Cadel, called De-inking (Cadel Deinking, Alicante, Spain). The technology is described elsewhere (http://cadeldeinking.com/en/), but essentially involves the surface washing of materials using high temperature aqueous based solutions with specific surfactants, followed by water rinsing and drying. The process optionally may include densification, melt filtration, de-volatilization, and pelletization following the surface washing. This method differs from other known methods in that it claims to remove surface printed inks. Such would be advantageous due to lowering the burden for chemical contaminant removal by the bulk purification methods of the current invention.

Three surface washing technologies of the prior art were evaluated for the average removal efficiency of the five selected contaminants (COMPARATIVE EXAMPLES 1, 2, and 3). Each of the surface washing technologies was evaluated using a different reclaimed film with different levels of contamination. Overall, the surface washing technologies of the prior art were not able to purify the reclaimed polymers sufficiently for use in controlled end markets. For the selected contaminants, the commercial technologies were not able to reduce to levels near the LOQ despite low initial contamination of the respective reclaimed polymers. In addition, the average removal efficiency for 4-tert-pentylphenol, bisphenol A, OCDD, PCB 118, di-2-ethylhexyl phthalate was less than about 55%.

In embodiments of the present invention, the reclaimed polymer is surface washed in a non-densified state in a surface washing step prior to the leaching step to produce a surface-washed polymer; wherein said surface washing results in greater than about 80% reduction in loosely bound surface contamination. In embodiments of the present invention, the reclaimed polymer is surface washed in a non-densified state in a surface washing step prior to the leaching step to produce a surface-washed polymer; wherein said surface washing results in greater than about 80% reduction in loosely bound surface contamination; wherein said reclaimed polymer prior to surface washing has an average surface area to volume ratio greater than about 1 mm⁻¹; wherein said surface washing process is of the de-inking type; and wherein said de-inking process results in a ΔE change of less than about 10% between the de-inked polymer and the reclaimed polymer without surface printed ink.

### V. Melt Densification Process

The plastic coming out of the surface purification step will generally be in a similar geometric form and with similar average surface area to volume ratio as the incoming reclaimed polymer, assuming the surface purification temperature was less than the primary melting point of the reclaimed polymer. For example, if the reclaimed plastic is loose film, then after shredding and surface washing at a temperature below the primary melting point of the reclaimed polymer, the film will exit surface purification as a shredded film. Because such loose plastic is difficult to feed to certain bulk purification methods, such as liquid-liquid extraction, it may be desirable to melt densify such plastic prior to bulk purification.

A preferred method for melt densification is melt extrusion. Melt extrusion not only densities the plastic, but it may provide the pressure necessary for the downstream bulk purifications like liquid-liquid extraction. The melt extrusion may also include optional steps, such as melt filtration, and/or devolatilization to remove large bulk contaminants and/or volatile bulk contaminants. In addition, the molten densified plastic may be further pressurized using a melt pump. The melt pump may be necessary to increase the pressure necessary for the downstream bulk purification step. Other methods of densification are known in the art including rotating disc and rotating drum densifiers, which occur at lower temperatures relative to melt based methods.

In embodiments of the present invention, said melt densification comprises melt extrusion. In embodiments of the present invention, said melt extrusion comprises melt filtration. In embodiments of the present invention, said melt extrusion comprises melt devolatilization. In embodiments of the present invention, said melt extrusion comprises melt pumping. In embodiments of the present invention, said melt densification comprises melt extrusion, melt filtration, melt devolatilization, and melt pumping.

### VI. Flooded Leaching Process

Unexpectedly, it has been found that the flooded leaching step (disclosed in this Section VI) or the combined steps of surface purification and flooded leaching (disclosed in Section VII) combined with the purification process (disclosed in Section VIII) produces a purer polymer from a reclaimed polymer with much higher efficiency than when the purification process is used alone. Although not wishing to be bound by any theory, applicants hypothesize that the removal of contaminants in the leaching step allows for the higher efficiency of removing the remaining contaminants in the various steps of the purification process compared to when the leaching step or the surface purification and leaching steps are absent. Although not wishing to be bound by any theory, applicants believe that the surface contaminants of the reclaimed polymer become bulk contaminants in the absence of the leaching step or the surface purification and leaching steps and thus they become difficult to be removed in the various steps of the purification process.

In general, bulk contamination will not be appreciably reduced by simple aqueous surface washing. Melt filtration and melt devolatilization will have the potential to remove bulk contaminants of large geometric size and remove some volatile bulk contaminants but will be largely ineffective against most bulk contaminants especially to the required levels.

One commercial technology for bulk purification is InterRema Refresher™ from EREMA (EREMA Group, Ansfelden, Austria; https://www.erema.com/en/refresher/). The technology is described in detail elsewhere but essentially consists of devolatilization of pelletized materials over extended periods of time at temperatures below the primary melting point of the plastic to remove volatile organics. Most of the chemical contaminants relevant to reclaimed polymers and discussed in the prior Sections are highly non-volatile with normal boiling points typically above 200° C. Hence, this type of devolatilization technology will have limited ability to remove most chemical contamination referenced in this application.

Other technologies based upon devolatilization are common. These may be stand-alone unit operations or combined with other operations including extrusion and melt filtration. Those utilizing sub-ambient pressure over a molten stream of the reclaimed plastic are common. One bulk purification technology involving devolatilization was analyzed for its purification capability. The technology involved slightly elevated temperatures, but below the primary melting point of the plastic, long residence times (greater than about 2 h), and continuous reflux of purified air to provide the devolatilization (COMPARATIVE EXAMPLE 4). The commercial devolatilization technology was unable to sufficiently remove the selected contaminants. For example, the selected contaminants were still well above LOQ, and the average removal efficiency was about 41%.

Extraction is a preferred bulk purification method. Extraction involves the use of a purification solvent to remove bulk permeable contaminants through creation of a chemical potential gradient between the reclaimed polymer and the solvent. The rate of permeable chemical contaminant removal will depend upon the diffusivity and solubility of the contaminant in the plastic under the conditions created in the process. For high MW plastics, the diffusivity of large molecules indicative of chemical contaminants is quite low, especially in the solid state of the plastic. In addition, the solubility may be limited due to the high MW of the reclaimed polymer and lack of enthalpic mixing. Thus, the time required to remove permeable contaminants through diffusion mechanisms can be quite long and not conducive to economically viable processes at commercial scale. Methods to resolve these time scale limitations include: 1) increased diffusivity through elevated temperature and/or plastic relaxation through solvent swelling, 2) decrease of diffusion path length through increased average surface area to volume ratio of the reclaimed polymer exposed to the solvent, and 3) increased convective transport of the contaminant through the plastic/solvent interface by: increased solubility of the contaminant in the solvent, increased partitioning of the contaminant within the solvent relative to the plastic; increased convection around the plastic/solvent interface, and increased solvent sink relative to plastic sink. The solubility of the bulk purification solvent in the plastic can be increased by operating the extraction at high pressures especially at, near, or above the critical pressure.

It is important for the extraction method to be scalable to large volumes at low cost. Hence, the time required for extraction should be low to allow for such scalability. In embodiments of the present invention, the total time for extraction is less than about 6 h, preferably less than about 4 h, more preferably less than about 2 h, and even more preferably less than about 1 h. If the extraction is completed in stages, then the time per stage may be less than this range but the overall time will still fall within these times.

Extractions may take place above, near, at, or below the primary melting point of the reclaimed polymer. Extraction taking place at, near, or above the primary melting point of the reclaimed polymer are called liquid-liquid extractions. Extractions taking place below the primary melting point of the reclaimed polymer are called leaching extractions, or simply leaching processes. Extraction solvents used in leaching extractions are called leaching solvents.

In the flooded leaching step of the current invention, the reclaimed polymer is contacted with excessive solvent during every stage and every time of the step. Such a leaching process is called a flooded leaching process. For the purposes of the present invention, “flooded leaching” and “leaching” are used interchangeably. Also, for the purposes of the present invention, “process”, “step”, “process step”, and their plurals are used interchangeably.

In a leaching step, the mass of leaching solvent to mass of reclaimed polymer exposed to the solvent at every point in time and in every stage of the process is preferably equal to or greater than about 5:1. In certain leaching steps, the solvent is rapidly stirred such that the reclaimed polymer is suspended in the solvent even when the density of the reclaimed polymer is greater than that of the solvent. Such leaching steps ensure complete contact between the surface of the reclaimed polymer and the leaching solvent, and lower the mass transfer resistance within the solvent boundary layer around the reclaimed polymer surface due to the convective motion. Beyond stirring, similar reduced boundary layer may be achieved in flooded leaching steps by allowing the reclaimed polymer to settle through the solvent by density gradient. Examples of flooded leaching steps include stirred tanks of the continuous (also known as continuous stirred tank reactor—CSTR), semi-continuous, and batch types. Additional examples of flooded leaching steps include settling tanks wherein the reclaimed polymer is allowed to settle out or through the solvent that is filled inside a tank or other vessel. The applicants have found that for flooded leaching steps of the current invention, the leaching solvent to reclaimed polymer mass ratio at any point in time and at any stage should preferably be greater than about 5:1, with more preferably being greater than 10:1 per stage, and most preferably be greater than about 20:1 to enable adequate dispersion and exfoliation of the reclaimed polymer within the leaching solvent.

In embodiments of the present invention, said flooded leaching step is conducted in a stirred tank. In embodiments of the present invention, said flooded leaching step is conducted in a CSTR. In embodiments of the present invention, said flooded leaching step is conducted in a batch stirred tank. For all stirred tank processes, the ability to expose the surface area of the reclaimed polymer to the leaching solvent is critical. The design of the reactor should include vigorous mechanical agitation and the potential use of extensive baffling.

For flooded leaching steps of the current invention, it may be beneficial to select a leaching solvent and operating temperature and pressure such that the leaching solvent is at its boiling point during the extraction. Such designs allow the solvent to be continuously refluxed, which may enable locally high concentration gradients as the refluxed solvent contacts the reclaimed polymer.

In embodiments of the present invention, said flooded leaching step operates at a temperature below the primary melting point of said reclaimed polymer and a pressure between about atmospheric and about 1,000 atm. In embodiments of the present invention, said flooded leaching step operates at a temperature below the primary melting point of said reclaimed polymer and a pressure about atmospheric. In embodiments of the present invention, said flooded leaching step operates at a temperature below the primary melting point of said reclaimed polymer and a pressure between about atmospheric and about 1,000 atm, using a leaching solvent, in a number of leaching stages, for a total residence time of said flooded leaching step and residence time for each said leaching stage.

In embodiments of the present invention, the leaching solvent is at or near the normal boiling point. For polyolefin reclaimed polymers, preferred leaching solvents for flooded leaching have boiling points in the 20° C. to 90° C. range. Non-limiting examples of such solvents are tetrahydrofuran (THF), di-ethyl ether, hexanes, acetone, ethanol, methanol, propanol, isopropanol, methyl ethyl ketone (MEK), and ethyl acetate. In embodiments of the present invention, said leaching solvent has a normal boiling point between 20° C. and 90° C. In embodiments of the present invention, the leaching solvent has a normal boiling point between 20° C. and 90° C. and the leaching temperature is at or near the boiling point. In embodiments of the present invention, the leaching solvent has a normal boiling point between 20° C. and 90° C., the leaching temperature is at or near the boiling point, and the leaching pressure is about atmospheric. The pressure may also be higher than atmospheric for such leaching solvents. In embodiments of the present invention, the leaching solvent has a normal boiling point between 20° C. and 90° C. and the leaching pressure is between above atmospheric and about 1,000 atm. The leaching solvent may also have a boiling point above the leaching temperature. In embodiments of the present invention, the leaching solvent has a normal boiling point above the leaching temperature. In embodiments of the present invention, the leaching solvent is ethyl acetate; the leaching temperature is between about 20° C. and about 120° C.; and the leaching pressure is between about atmospheric and about 1,000 atm. In embodiments of the present invention, the leaching temperature is between about 20° C. and about 90° C. and the leaching pressure is between about atmospheric and about 1,000 atm, the leaching solvent is ethyl acetate, the total residence time of the leaching step is less than about 360 min, and the average removal efficiency is about 55%. In embodiments of the present invention, the leaching solvent is hexanes; the leaching temperature is between about 20° C. and about 120° C.; and the leaching pressure is between about atmospheric and about 1,000 atm.

Leaching solvents with a normal boiling point below the leaching temperature are also preferred due to the elevated flooded leaching pressures. In embodiments of the present invention, the leaching solvent has a normal boiling point below the leaching temperature. In embodiments of the present invention, the leaching solvent is propane. In embodiments of the present invention, the leaching solvent is propane; the leaching temperature is between about 20° C. and about 120° C.; and the leaching pressure is between about 9 atm and about 1,000 atm. In embodiments of the present invention, the leaching solvent is di-methyl ether (DME). In embodiments of the present invention, said leaching solvent is DME; said leaching temperature is between about 20° C. and about 120° C.; and said leaching pressure is between about 6 atm and about 1,000 atm.

Leaching solvents with normal boiling point below the leaching temperature and with critical temperature below the leaching temperature are also preferred. In embodiments of the present invention, the leaching solvent has a normal boiling point below the leaching temperature and its critical temperature is below the leaching temperature. In embodiments of the present invention, the leaching solvent is ethane. In embodiments the present invention, the leaching solvent is critical or supercritical ethane. In embodiments of the present invention, said leaching solvent is ethane; said leaching temperature is between about 31° C. and about 120° C.; and said leaching pressure is between about 40 atm and about 1,000 atm. In embodiments the present invention, the leaching solvent is CO₂. In embodiments of the present invention, said leaching solvent is CO₂; said leaching temperature is between about 31° C. and about 120° C.; and said leaching pressure is between about 68 atm and about 1,000 atm. In embodiments the present invention, the leaching solvent is CO₂ with less than 5 wt % water.

The density of the leaching solvent is preferably less than the density of the reclaimed polymer at the temperature and pressure of the flooded leaching step. For reclaimed polyethylene, the density of the leaching solvent at the temperature and pressure of the flooded leaching step is preferably less than about 0.90 g/mL, but higher densities may still be used.

Preferred leaching solvents include solvents that have higher affinity for the chemical contaminants than for the reclaimed polymer. Solvents with high affinity for the chemical contaminants of interest in reclaimed polyolefins relative to the affinity of these for the polyolefins include, but are not limited to, diethyl ether, MEK, ethyl acetate, THF, acetone, methylene chloride, and methanol. Other oxygenated and polar hydrocarbon solvents likely have similar desired affinity. Solvents lacking such characteristics can still be used, but higher solvent to polymer ratios may be required. It is preferred that the solvent should not significantly dissolve the reclaimed polymer at the temperature and pressure of the flooded leaching step (less than about 5 wt % may be dissolved).

In embodiments of the present invention, said leaching solvent is an organic solvent or a mixture of organic solvents. In embodiments of the present invention, said leaching solvent is selected from the group comprising hydrocarbons. In embodiments of the present invention, said leaching solvent is selected from the group comprising aliphatic hydrocarbons. In embodiments of the present invention, said leaching solvent is selected from the group comprising aromatic hydrocarbons. In embodiments of the present invention, said leaching solvent is selected from the group comprising alkanes. In embodiments of the present invention, said leaching solvent is selected from the group comprising methane, ethane, propane, normal butane, isobutane, normal pentane, isopentane, neopentane, hexanes (normal hexane, isohexane, neohexane), heptanes, octanes, or mixtures thereof. In embodiments of the present invention, the leaching solvent is at least one of DME, diethyl ether, MEK, ethyl acetate, THF, acetone, methanol, and CO₂, or mixtures thereof.

The temperature may be changed during the course of the flooded leaching step but is generally consistent within a given stage of a unit operation. The pressure may be changed to vary solubility of the leaching solvent in the reclaimed polymer or to increase solubility of the chemical contaminant within the leaching solvent.

A flooded leaching extraction process may take place in stages and be combined with additional leaching steps of other types not discussed in this disclosure. The same is true for liquid-liquid extraction processes. In addition, a liquid-liquid extraction process may be combined with the flooded leaching step in various stages to form a given purification process. In embodiments of the present invention, the number of leaching stages is more than one. In embodiments of the present invention, the number of leaching stages is between about 1 and about 50. In embodiments of the present invention, the number of leaching stages is between about 2 and about 30. In embodiments of the present invention, the number of leaching stages is between about 5 and about 20. In embodiments of the present invention, the number of liquid-liquid stages is more than one. In embodiments of the present invention, the number of leaching stages is more than one. In embodiments of the present invention, the number of liquid-liquid stages is one or more and the number of leaching stages is one or more.

A single stirred tank reactor will achieve a certain removal efficiency. The efficiency can be improved by having multiple stirred tank reactors in series wherein the reclaimed polymer from the 1^{st} stage is predominately separated from the 1^{st} stage leaching solvent and this 1^{st} stage plastic is used in the 2^{nd} stage with fresh leaching solvent. This is repeated for each additional stage. This method improves the removal efficiency at the expense of additional reactors and complexity but maintains the overall time, throughput, and solvent utilization. Practically speaking, the number of reactor stages can be anywhere from 1 to about 10 for stirred tank systems. If a larger number of stages are needed, then a continuous counter-current method may be used.

While not wishing to be bound by theory, the theoretical maximum contaminant removal capacity for a flooded leaching step is based upon the thermodynamic equilibrium/partitioning of the chemical contaminants between the reclaimed polymer and leaching solvent at the temperature and pressure of the flooded leaching step. Thermodynamic equilibrium may not be achieved due to kinetic limitations in the flooded leaching step. This is true for the total flooded leaching step and is also true for each flooded leaching stage. A higher leaching solvent to reclaimed polymer mass ratio will drive both thermodynamics and kinetics in favor of leaching at the expense of greater leaching solvent consumption and greater leaching process size, which equals greater cost. Thus, a balance must be found between these important design and operational variables for the removal efficiency of the selected chemical contaminants.

In general, the applicants have found that the total fresh or renewed leaching solvent to reclaimed polymer mass ratio is preferably greater than about 5:1. In embodiments of the present invention, the total fresh or renewed leaching solvent to reclaimed polymer mass ratio is greater than about 10:1. In embodiments of the present invention, the total fresh or renewed leaching solvent to reclaimed polymer mass ratio is greater than about 15:1. In embodiments of the present invention, the total fresh or renewed leaching solvent to reclaimed polymer mass ratio is greater than about 20:1. In embodiments of the present invention, the total fresh or renewed leaching solvent to reclaimed polymer mass ratio is greater than about 30:1 and less than about 100:1.

If the flooded leaching is completed in progressive or sequential stages, then the leaching solvent to reclaimed polymer ratio per stage may be lower than this stated range (but still above the per stage minimum of about 5:1), but the total solvent used to the total reclaimed polymer represented by the sum of solvent used in all stages should be within this range. In addition, the contaminated solvent from any stage may be used “as-is” as the solvent for another stage. Contaminated solvent at any point in the process may be renewed through known methods of distillation, filtration, ion-exchange, etc. or combinations.

Another important kinetic driver is the average surface area to volume ratio of the reclaimed polymer within and exposed to the leaching solvent. In general, the time required to extract a chemical contaminant from a reclaimed polymer, is a strong function of the diffusion pathlength within the reclaimed polymer. The diffusion pathlength is indirectly proportional to the average surface area to volume ratio of the geometrical form of the reclaimed polymer and the ability to access the surface area with leaching solvent. Hence, a higher average surface area to volume ratio will produce a reduced diffusion pathlength and faster diffusion kinetics. For flooded leaching steps, a high average surface area to volume ratio is a critical parameter for quick and efficient contaminant removal both surface and bulk.

For flooded leaching steps, the average surface area to volume ratio of the reclaimed polymer within and exposed to the extracting solvent is essentially identical to the average surface area to volume ratio of the reclaimed polymer since the processing temperature is below the primary melting point. For film based reclaimed polymer, the flooded leaching step is ideal because of the extremely high inherent average surface area to volume ratio. If reclaimed polymer is provided in other forms with lower average surface area to volume ratio such as pellets, granulated bottles, granulated parts, etc., then it will be advantageous to increase the surface area to volume ratio by various means. These means include, but are not limited to, mechanical grinding, cryogenic grinding, calendaring, pressing, extension, etc.

A known means for increasing the effective mass transfer through a given surface area to volume ratio and given set of conditions at the reclaimed polymer—leaching solvent interface is through applying energy to the reclaimed polymer, such as but not limited to vibrational in the form of ultrasonic energy and/or microwave.

Following the flooded leaching step, the leached polymer may be devolatilized to remove the leaching solvent. The contaminated leaching solvent will contain a small amount of dissolved reclaimed polymer, the leached-out contaminants, and the pure leaching solvent. There are many ways to recover the purer polymer and leaching solvent independent of the leached-out contaminants.

In general, a small amount of reclaimed polymer may dissolve into the leaching solvent regardless of process type or leaching solvent. In particular, low MW waxes are particularly prone to solubilization into the leaching solvent. These may become problematic in distillation-based recovery of the purified leaching solvent due to deposition of the waxes on process equipment. Methods are known to reduce this tendency. One such method is to lower the temperature of the contaminated leaching solvent to below the cloud point to precipitate the polymer or wax phase followed by filtration. Unlike the reclaimed polymer, the residual plastic or waxes resulting plastic from the precipitation from the contaminated solvent may contain significant contamination.

Distillation of the contaminated leaching solvent may be used to regenerate the leaching solvent for re-use in the various leaching operations. However, distillation may not be economically feasible on-going considering the high leaching solvent volume utilized in the present invention. In addition, because the chemical contaminants of interest in this invention are extremely low in concentration, the concentration of these chemical contaminants in the contaminated leaching solvent may be correspondingly low or even lower. Thus, a preferred method to purify the contaminated leaching solvent is through direct removal of the contaminants without volatilizing the bulk leaching solvent phase. Such methods include ion exchange, adsorption/absorption methods, etc. Examples include passing the contaminated leaching solvent through a bed of activated carbon, alumina, or activated alumina. This method can be used alone or in combination with distillation to achieve the right level of purification at the right energy consumption. In addition, the contaminated leaching solvent from any leaching stage may be used “as-is” as the leaching solvent for another stage. Contaminated leaching solvent at any point in the process may be renewed through known methods of distillation, filtration, ion-exchange, etc. or combinations.

The leached polymer may contain small amounts of the leaching solvent in either physically adsorbed or bulk absorbed form. The concentration of the leaching solvent in the leached polymer may be reduced by devolatilization techniques. In embodiments of the present invention, said leached polymer is devolatilized to a content of less than 1 wt % leaching solvent in the leached polymer.

Stirred tank reactors operating at the boiling point of the leaching solvent provide improvements over existing methods. For example (EXAMPLES 1, 2, 3, and 4; and Tables 7, 8, 9, and 10), flooded leaching step conducted with ethyl acetate or THF provide removal efficiencies of the selected contaminants greater than about 88%.

In embodiments of the present invention, the leaching solvent is ethyl acetate. In embodiments of the present invention, the leaching solvent is ethyl acetate, and the leaching pressure is about atmospheric. In embodiments of the present invention (EXAMPLE 1 and Table 7), said flooded leaching step is conducted in a stirred tank, said leaching temperature is about 77.1° C., said leaching pressure is about atmospheric, and said leaching solvent comprising ethyl acetate. In embodiments of the present invention, said flooded leaching step is conducted in a stirred tank, said leaching temperature is about 77.1° C., said leaching pressure is about atmospheric, said leaching solvent comprises ethyl acetate; wherein the reclaimed polymer has a surface area to volume ratio of about 80 mm⁻¹; said number of leaching stages is 2, the ethyl acetate to reclaimed polymer mass ratio per stage is about 18:1, the flooded leaching residence time per stage is about 50 min, the total ethyl acetate to reclaimed polymer mass ratio is about 36:1, the total residence time is about 100 min; and the average of the reductions in concentration of 4-tert-pentylphenol, bis-phenol A, OCDD, PCB 118, and di-2-ethylhexyl phthalate is about 89%.

In embodiments of the present invention (EXAMPLE 2 and Table 8), said flooded leaching step is conducted in a stirred tank, said leaching temperature is about 77.1° C., said leaching pressure is about atmospheric, said leaching solvent comprises ethyl acetate; wherein the reclaimed polymer has a surface area to volume ratio of about 80 mm⁻¹; said number of leaching stages is 2, the ethyl acetate to reclaimed polymer mass ratio per stage is about 18:1, the flooded leaching residence time per stage is about 30 min, the total ethyl acetate to reclaimed polymer mass ratio is about 36:1, the total residence time is about 60 min; and the average of the reductions in concentration of 4-tert-pentylphenol, bis-phenol A, OCDD, PCB 118, and di-2-ethylhexyl phthalate is about 89%.

In embodiments of the present invention, the leaching solvent is THF. In embodiments of the present invention, the leaching solvent is THF, and the leaching pressure is about atmospheric. In embodiments of the present invention, said flooded leaching is conducted in a stirred tank, said leaching temperature is about 66° C., said leaching pressure is about atmospheric, and said leaching solvent comprises THF. In embodiments of the present invention (EXAMPLE 3 and Table 9), said flooded leaching step is conducted in a stirred tank, said number of leaching stages is 2, said leaching temperature is about 66° C., said leaching pressure is about atmospheric, said leaching solvent comprises THF, said reclaimed polymer has a surface area to volume ratio of about 80 mm⁻¹, said THF to reclaimed polymer ratio is about 18:1 per stage, said residence time for each leaching stage is about 50 min, said total THF to reclaimed polymer mass ratio is about 36:1, said total residence time of the flooded leaching step is about 100 min; and the average of the reductions in concentration of 4-tert-pentylphenol, bis-phenol A, OCDD, PCB 118, and di-2-ethylhexyl phthalate is about 90%.

In embodiments of the present invention, the leaching solvent is DME, the leaching temperature is about 70° C., and the leaching pressure is greater than about 18 atm. In embodiments of the present invention, the leaching solvent is DME, the reclaimed polymer has a surface area to volume ratio of about 80 mm⁻¹, the leaching temperature is about 70° C., and the leaching pressure is greater than about 18 atm. In embodiments of the present invention, the leaching solvent is CO₂, the leaching temperature is about 70° C., the leaching pressure is about 340 atm, and the reclaimed polymer has a surface area to volume ratio of about 80 mm⁻¹.

Following the flooded leaching step, the leached polymer may be physically wetted with the residual leaching solvent and potentially contain a small amount of absorbed leaching solvent. As discussed earlier, there are many ways to recover the leached polymer and leaching solvent independent of the leached contaminants. The leached polymer can be dried and devolatilized by many known commercial means. One method is through cyclonic drying. Another method is through melt extrusion with a devolatilization stage. In embodiments of the present invention, the leached polymer is processed to reduce the leaching solvent to below about 1 wt % in the reclaimed polymer. The contaminated leaching solvent can be cleaned with known methods of distillation, ion exchange, filtration, etc. The resulting devolatilized leached polymer may be used as it or may be further processed into other forms including pellets via various processes.

In embodiments of the present invention, the total residence time of the leaching step is less than about 600 min. In embodiments of the present invention, the total residence time of the leaching step is less than about 480 min. In embodiments of the present invention, the total residence time of the leaching step is less than about 360 min. In embodiments of the present invention, the total residence time of the leaching step is less than about 180 min. In embodiments of the present invention, the total residence time of the leaching step is less than about 60 min.

In embodiments of the present invention, the residence time of each of the leaching step is less than about 180 min. In embodiments of the present invention, the residence time of each of the leaching step is less than about 90 min. In embodiments of the present invention, the residence time of each of the leaching step is less than about 60 min. In embodiments of the present invention, the residence time of each of the leaching step is less than about 30 min. In embodiments of the present invention, the residence time of each of the leaching step is about 20 min.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of alkyl phenols, bisphenols, dioxins, PCBs, and phthalates; and b) leaching said alkyl phenols, bisphenols, dioxins, PCBs, or phthalates from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of alkyl phenols, bisphenols, dioxins, PCBs, or phthalates, each having a concentration; and wherein said average removal efficiency is greater than about 55%.

In embodiments of the present invention, wherein said leaching step is conducted in a continuous stirred tank reactor (CSTR); wherein said reclaimed polymer is surface washed in a non-densified state in a surface washing process prior to extraction; wherein said surface washing process results in greater than about 80% reduction in loosely bound surface contamination; wherein said reclaimed polymer prior to surface washing has an average surface area to volume ratio greater than about 1 mm⁻¹; wherein said surface washing process is of the de-inking type; wherein said de-inking process results in a ΔE change of less than about 10% between the de-inked polymer and the reclaimed polymer without surface printed ink; wherein said leaching solvent is ethyl acetate; wherein said CSTR involves 3 leaching stages; wherein said leaching temperature is about 77° C. and said leaching pressure is near atmospheric; wherein said residence time of each of said leaching stages is about 20 min; wherein said reclaimed polymer is de-volatilized and densified using melt extrusion to produce a leached polymer pellet; and wherein said average removal efficiency is greater than about 55%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of 4-tertpentylphenol, bisphenol A, OCDD, PCB 118, and 2-ethylhexyl phthalate; and b) leaching said 4-tertpentylphenol, bisphenol A, OCDD, PCB 118, and 2-ethylhexyl phthalate from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of 4-tertpentylphenol, bisphenol A, OCDD, PCB 118, and 2-ethylhexyl phthalate, each having a concentration; wherein said average removal efficiency is greater than about 55%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); and b) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, and PAHs, each having a concentration; and wherein said average removal efficiency of said leached polymer is greater than about 55%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); and b) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, and PAHs, each having a concentration; and wherein said average removal efficiency of said leached polymer is greater than about 70%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); and b) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, and PAHs, each having a concentration; and wherein said average removal efficiency of said leached polymer is greater than about 80%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); and b) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, and PAHs, each having a concentration; and wherein said average removal efficiency of said leached polymer is greater than about 90%.

### VII. Combination of Surface Purification and Flooded Leaching Processes

In general, the combination of the surface purification step with the flooded leaching step provides synergistic benefits to the overall removal of contamination. Surface purification steps will effectively remove surface contamination both impermeable and permeable including chemical contaminants and chemical contaminant precursors. Thus, the surface purification lowers the burden on the flooded leaching step and allows such to be more effective. If the reclaimed polymer is heavily contaminated with surface contamination, then such contamination is preferably removed first in a surface purification step and then followed by a flooded leaching step. Once the surface contamination is removed in the surface purification step, the remaining bulk permeable contamination will be removed by the flooded leaching step. The only contamination not significantly removed by this two-step approach is bulk impermeable contamination, such as heavy metals that were intentionally added during original plastic part production.

Preferred methods of surface washing have already been discussed in the surface purification Section. An even more preferred method of surface washing is the de-inking method also described in the surface purification method (COMPARATIVE EXAMPLE 3). This method not only removes surface contamination, such as dirt, but also removes surface printed inks. The method is also quite effective at removing paper labels, which are chemical contaminant precursors. In this method, the reclaimed polymer with the original surface area exposed is fed to a multi-step aqueous washing process where the surface contamination including surface printed inks, dirt, grit, paper, adhesives, etc. are removed. The resulting material is then dried. The dried material may be further densified into pellets using extrusion including devolatilization and melt filtration. For the purposes of this invention, a de-inking method is any surface washing method wherein said method removes surface print sufficient to produce less than about a 10% difference in the ΔE between the de-inked and the unprinted reclaimed polymer (ΔE measured using Method 3 in Section IX).

For nomenclature purposes, the reclaimed polymer is fed to the surface purification method and the resulting surface purified polymer will be termed surface washed polymer. The surface-washed polymer will then be fed to the flooded leaching step and the resulting polymer is termed leached polymer. The surface purification method may involve multiple surface purification processes. The flooded leaching process may involve multiple flooded leaching steps of various types. The removal efficiency for the combined surface purification and flooded leaching steps will be calculated from the reclaimed polymer concentration and the associated leached polymer. The combination of surface washing with flooded leaching steps provided an average reduction in concentration of bisphenol-A, 4-tert-pentylphenol, OCDD, PCB 108, and di-2-ethylhexyl phthalate of about 95% (EXAMPLE 4 and Table 10).

In embodiments of the present invention, a method for purifying a reclaimed polymer comprises: a) obtaining the reclaimed polymer; wherein the reclaimed polymer is selected from the group consisting of PCR polymers, PIR polymers, and combinations thereof; and wherein said reclaimed polymer comprises contaminants, each contaminant having a concentration; and wherein said reclaimed polymer contaminants comprise at least one of alkyl phenols, bisphenols, dioxins, PCBs, and phthalates; b) surface washing said reclaimed polymer to produce a surface-washed polymer; and c) leaching said alkyl phenols, bisphenols, dioxins, PCBs, and phthalates from said surface-washed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of alkyl phenols, bisphenols, dioxins, PCBs, and phthalates, each having a concentration; and wherein the average of said reductions in concentration is greater than about 55%.

In embodiments of the present invention, said flooded leaching step takes place after a surface washing. In embodiments of the present invention, said flooded leaching step takes place after a surface washing process; and wherein the reclaimed polymer is not densified prior to the surface washing process. In embodiments of the present invention, said flooded leaching takes place after a surface washing process; wherein the reclaimed polymer is not densified prior to the surface washing process; and wherein the surface-washed reclaimed polymer may be densified prior to the flooded leaching step.

In embodiments of the present invention, said flooded leaching step uses a leaching solvent at a temperature and pressure; wherein said flooded leaching step operates in a number of stages; and wherein said reclaimed polymer has been partially purified using a surface washing process.

In embodiments of the present invention (EXAMPLE 4 and Table 10), said surface washing process involves commercially available de-inking by Cadel; said de-inking results in a ΔE change of less than about 10% and a removal of loosely bound surface contamination greater than about 80%; said flooded leaching step is operated in a stirred tank; said leaching temperature is about 77.1° C.; said leaching pressure is about atmospheric; said leaching solvent comprises ethyl acetate; and said total residence time is about 60 min. In embodiments of the present invention, said surface washing involves commercially available de-inking by Cadel; said de-inking results in a ΔE change of less than about 10% and a removal of loosely bound surface contamination of greater than about 80%; said flooded leaching step is operated in a stirred tank involving 2 stages; said leaching temperature is about 77.1° C.; said leaching pressure is about atmospheric; said leaching solvent comprises ethyl acetate; said residence time per stage is about 30 min; and the reduction in concentration of OCDD is about 98%.

In embodiments of the present invention, said surface washing process involves any known surface washing method; said flooded leaching step uses a stirred tank; and said flooded leaching step uses a leaching solvent. In embodiments of the present invention, said flooded leaching step uses a stirred tank and comprises a number of leaching stages.

In embodiments of the present invention, wherein said reclaimed polymer is surface washed in a non-densified state in a surface washing step prior to the leaching step to produce a surface-washed polymer; wherein said surface washing results in greater than about 80% reduction in loosely bound surface contamination; wherein said reclaimed polymer prior to surface washing has an average surface area to volume ratio greater than about 1 mm⁻¹; wherein said surface washing process is of the de-inking type; wherein said de-inking process results in a ΔE change of less than about 10% between the de-inked polymer and the reclaimed polymer without surface printed ink; wherein said leaching step is conducted in a continuous stirred tank reactor (CSTR); wherein said leaching solvent is ethyl acetate; wherein said CSTR involves 3 leaching stages; wherein said leaching temperature is about 77° C. and said leaching pressure is near atmospheric; wherein said residence time of each of said leaching stages is about 20 min; wherein said average removal efficiency is greater than about 55%; and wherein said leached polymer is de-volatilized and densified using melt extrusion to produce a leached polymer pellet.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of 4-tertpentylphenol, bisphenol A, OCDD, PCB 118, and 2-ethylhexyl phthalate; b) surface washing said reclaimed polymer in a non-densified state to produce a surface-washed polymer; wherein said surface washing results in a greater than about 80% reduction in loosely bound surface contamination; and c) leaching said 4-tertpentylphenol, bisphenol A, OCDD, PCB 118, and 2-ethylhexyl phthalate from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of 4-tertpentylphenol, bisphenol A, OCDD, PCB 118, and 2-ethylhexyl phthalate, each having a concentration; wherein said average removal efficiency is greater than about 55%.

In embodiments of the present invention, a method for purifying a reclaimed polymer comprises: a) obtaining the reclaimed polyethylene; wherein the reclaimed polyethylene is post-consumer reclaimed (PCR) polyethylene; and wherein said reclaimed polyethylene comprises contaminants, each contaminant having a concentration; and wherein said reclaimed polymer contaminants comprise at least one of pesticides, alkylphenol ethoxylates, alkylphenols, bisphenols, dioxins and dioxin-like compounds, polychlorinated biphenyls (PCBs), metals, organotins, phthalates, and polycyclic aromatic hydrocarbons (PAHs); b) surface washing said reclaimed polymer in a non-densified state to produce a surface-washed polymer; wherein said surface washing results in a greater than about 80% reduction in loosely bound surface contamination; and c) leaching said pesticides, alkylphenol ethoxylates, alkylphenols, bisphenols, dioxins and dioxin-like compounds, PCBs, metals, organotins, phthalates, and PAHs from said reclaimed polymer with an average removal efficiency, at a temperature between about 55° C. and about 65° C. and at a pressure of about atmospheric, using ethyl acetate, in a counter-current auger extraction, for a total residence time, to produce a leached polymer comprising at least one of pesticides, alkylphenol ethoxylates, alkylphenols, bisphenols, dioxins and dioxin-like compounds, PCBs, metals, organotins, phthalates, and PAHs; each having a concentration; wherein said average removal efficiency of said leached polymer is greater than about 90%.

### VIII. Dissolution Recycling Process—Purifying Leached Polymers

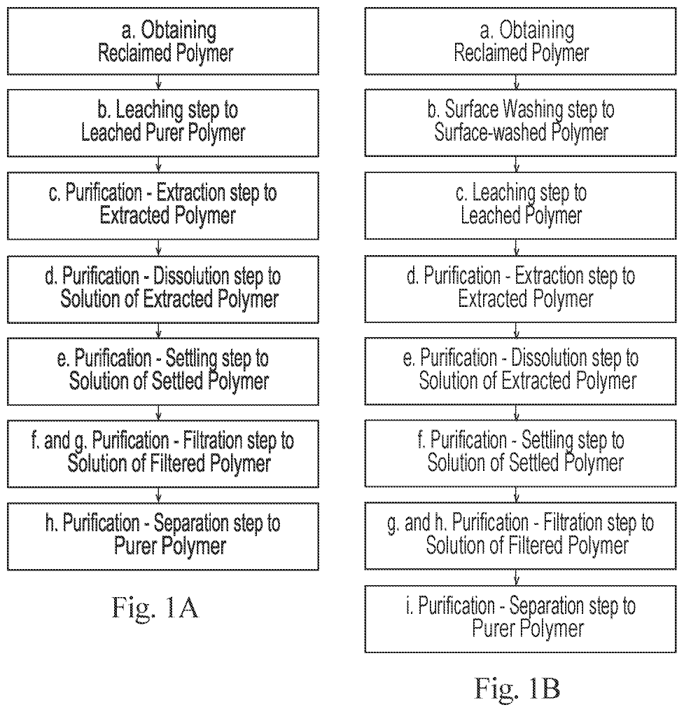

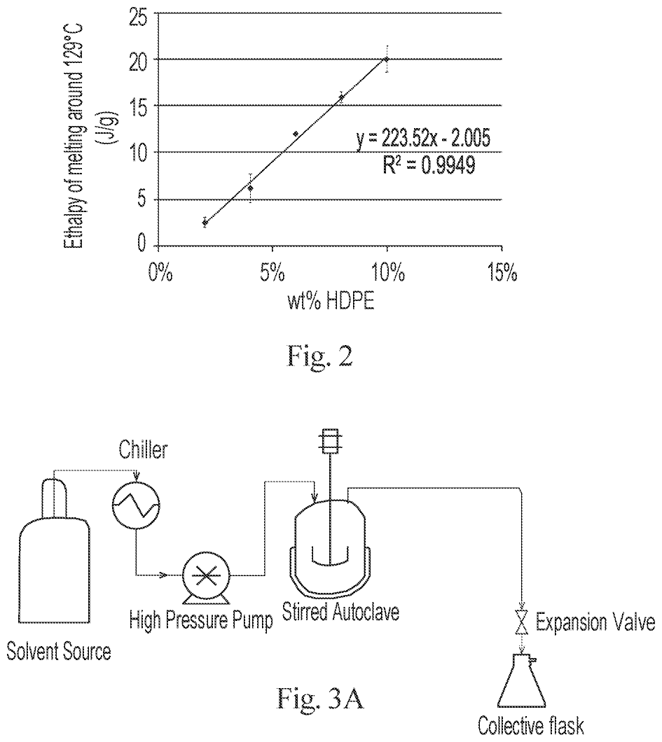

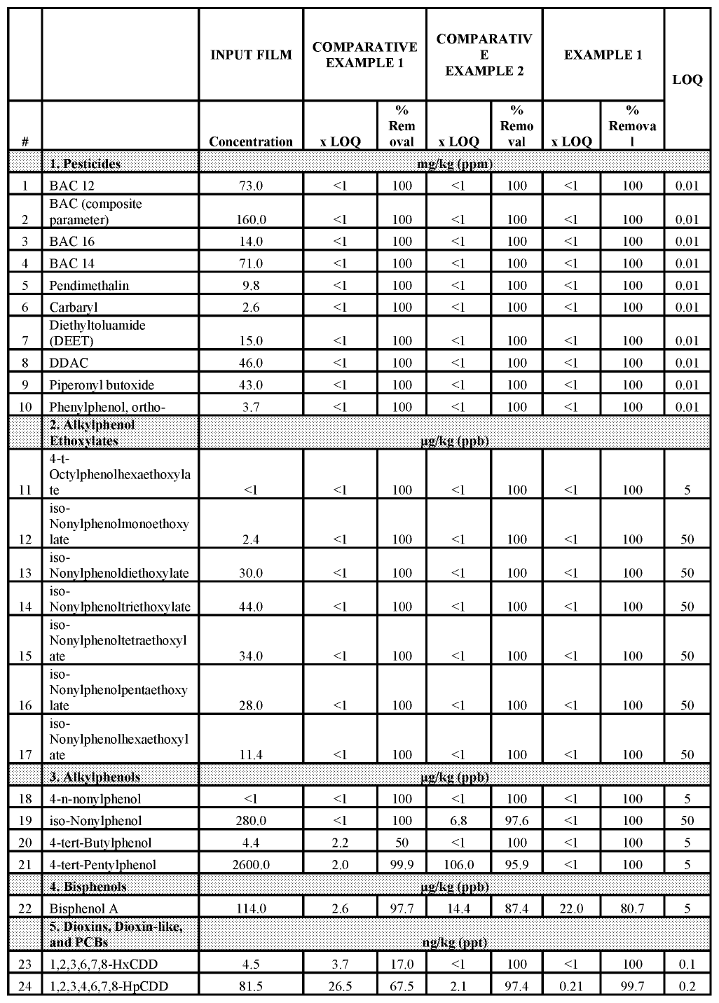

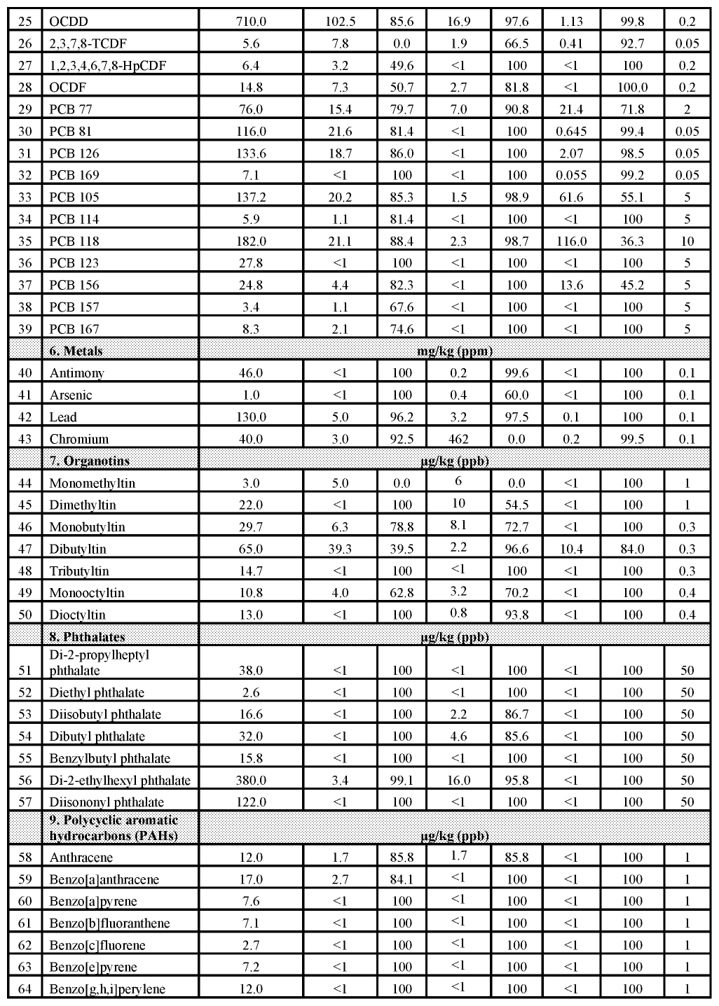

Surprisingly, it has been found that leached polymers in high MW polymer solutions are purified by filtration. This process, exemplified in FIGS. 1A and 1B, comprises: 1) extracting the leached polymer with a fluid solvent at an extraction temperature and an extraction pressure to produce an extracted polymer (step c in FIG. 1A and step din FIG. 1B); 2) dissolving the extracted polymer in a fluid solvent at a dissolution temperature and a dissolution pressure to produce a solution of the extracted polymer (step d in FIG. 1A and step e in FIG. 1B); 3) settling the solution of the extracted polymer at a dissolution temperature and a dissolution pressure to produce a solution of settled polymer (step e in FIG. 1A and step fin FIG. 1B); 4) filtering the solution of settled polymer at a dissolution temperature and a dissolution pressure to produce a solution of filtered polymer (step fin FIG. 1A and step g in FIG. 1B); and 5) separating the filtered polymer from the fluid solvent to produce a purer polymer (step g in FIG. 1A and step h in FIG. 1B). Note that the aforementioned temperature and pressures may vary in value from one step to another. The schematic of the experimental apparatus used in the extraction step is shown in FIG. 3A, and the schematic of the experimental apparatus used in the dissolution, settling, filtration, and separation steps is shown in FIG. 3B.

The dissolution recycling process comprises the steps of extraction, dissolution, settling, filtration, and separation in various sequences. In embodiments of the present invention, the purer polymer, which may be sourced from PCR streams, is essentially contaminant-free, pigment-free, odor-free, homogenous, and similar in properties to virgin polymer.

Fluid Solvent

In embodiments of the present invention, the fluid solvent has a standard boiling point less than about 70° C. In embodiments of the present invention, the fluid solvent has a standard boiling point less than about 70° C. and greater than about −45° C. In embodiments of the present invention, the fluid solvent has a standard boiling point less than about 70° C. and greater than about −45° C., and a standard enthalpy of vaporization of less than about +25 kJ/mol. Pressurization maintains solvents, which have standard boiling points below the operating temperature range of the present invention, in a state in which there is little or no solvent vapor.

In embodiments of the present invention, the fluid solvent is selected from the group consisting of olefinic hydrocarbons, aliphatic hydrocarbons, and mixtures thereof. In embodiments of the present invention, the aliphatic hydrocarbon of the fluid solvent is selected from the group consisting of C₁-C₆ aliphatic hydrocarbons and mixtures thereof. In embodiments of the present invention, the fluid solvent comprises n-butane, butane isomers, or mixtures thereof.

In embodiments of the present invention, the fluid solvent with a standard boiling point less than about 70° C. is selected from the group consisting of carbon dioxide, ketones, alcohols, ethers, esters, alkenes, alkanes, and mixtures thereof. Non-limiting examples of fluid solvents, with standard boing points less than about 70° C., are carbon dioxide, acetone, methanol, dimethyl ether, diethyl ether, ethyl methyl ether, tetrahydrofuran, methyl acetate, ethylene, propylene, 1-butene, 2-butene, isobutylene, 1-pentene, 2-pentene, branched isomers of pentene, 1-hexene, 2-hexene, methane, ethane, propane, n-butane, isobutane, n-pentane, isopentane, neopentane, n-hexane, isomers of isohexane, and other substances that may be apparent to those having ordinary skill in the art.

The selection of the appropriate fluid solvent or solvent mixture will depend on which polymer or polymer mixture is being purified by the present invention. Further, the selection of the polymer being purified, and the corresponding fluid solvent used will dictate the temperature and pressure ranges used to perform the steps of the present invention. A review of polymer phase behavior in fluid solvents of the kind described by the present invention is provided in the following reference: McHugh et al. (1999) Chem. Rev. 99:565-602.

Extraction

In embodiments of the present invention, a method for purifying leached polymers includes contacting a leached polymer with a fluid solvent at a temperature and at a pressure wherein the leached polymer is essentially insoluble in the fluid solvent. Although not wishing to be bound by any theory, applicants believe that the temperature and pressure-dependent solubility can be controlled in such a way to prevent the fluid solvent from fully solubilizing the leached polymer; however, the fluid solvent can diffuse into the leached polymer and extract any extractable contamination. The extractable contamination may be residual processing aides added to the polymer, residual product formulations which contacted the polymer, such as perfumes and flavors, dyes, and any other extractable material that may have been intentionally added or unintentionally became incorporated into the polymer, for example, during waste collection and subsequent accumulation with other waste materials.

In embodiments of the present invention, the controlled extraction may be accomplished by fixing the temperature of the polymer/fluid solvent system and then controlling the pressure below a pressure, or pressure range, where the polymer dissolves in the fluid solvent. In embodiments of the present invention, the controlled extraction is accomplished by fixing the pressure of the polymer/solvent system and then controlling the temperature below a temperature, or temperature range where the polymer dissolves in the fluid solvent. The temperature and pressure-controlled extraction of the leached polymer with a fluid solvent uses a suitable pressure vessel and may be configured in a way that allows for continuous extraction of the leached polymer with the fluid solvent. In embodiments of the present invention, the pressure vessel may be a continuous liquid-liquid extraction column where molten polymer is pumped into one end of the extraction column and the fluid solvent is pumped into the same or the opposite end of the extraction column. In embodiments of the present invention, the fluid containing extracted contamination is removed from the process. In embodiments of the present invention, the fluid containing extracted contamination is purified, recovered, and recycled for use in the extraction step or a different step in the process. In embodiments of the present invention, the extraction may be performed as a batch method, wherein the leached polymer is fixed in a pressure vessel and the fluid solvent is continuously pumped through the fixed polymer phase. The extraction time or the amount of fluid solvent used will depend on the desired purity of the final purer polymer and the amount of extractable contamination in the starting leached polymer. In embodiments of the present invention, the fluid containing extracted contamination is contacted with solid media in a separate step as described below. In embodiments of the present invention, a method for purifying leached polymers includes contacting a leached polymer with a fluid solvent at a temperature and at a pressure wherein the leached polymer is molten and in the liquid state. In embodiments of the present invention, the leached polymer is contacted with the fluid solvent at a temperature and at a pressure wherein the leached polymer is in the solid state.

In embodiments of the present invention, a method for purifying leached polymers includes contacting leached polymers with a fluid solvent at a temperature and a pressure wherein the polyethylene remains essentially undissolved. In embodiments of the present invention, a method for purifying leached polymers includes contacting a leached polymer with a fluid solvent at a temperature and a pressure wherein the leached polymer remains essentially undissolved. In embodiments of the present invention, a method for purifying leached polymers includes contacting a leached polymer with a fluid solvent at a temperature from about 80° C. to about 280° C. In embodiments of the present invention, a method for purifying leached polymers includes contacting a leached polymer with a fluid solvent at a temperature from about 110° C. to about 220° C. In embodiments of the present invention, a method for purifying leached polymers includes contacting a leached polymer with a fluid solvent at a pressure from about 150 psig (1.03 MPa) to about 8,000 psig (55.16 MPa). In embodiments of the present invention, a method for purifying leached polymers includes contacting a leached polymer with a fluid solvent at a pressure from about 400 psig (2.76 MPa) to about 2,400 psig (16.55 MPa). In embodiments of the present invention, the pressure in the extraction step is less than about 1,100 psig (7.58 MPa).

In embodiments of the present invention, a method for purifying leached polymers includes contacting leached polyethylene with n-butane at a temperature from about 80° C. to about 280° C. In embodiments of the present invention, a method for purifying leached polymers includes contacting leached polyethylene with n-butane at a temperature from about 100° C. to about 220° C. In embodiments of the present invention, a method for purifying leached polymers includes contacting leached polyethylene with n-butane at a temperature from about 130° C. to about 180° C. In embodiments of the present invention, a method for purifying leached polymers includes contacting leached polyethylene with n-butane at a pressure from about 400 psig (2.76 MPa) to about 6,000 psig (41.37 MPa). In embodiments of the present invention, a method for purifying leached polymers includes contacting leached polyethylene with n-butane at a pressure from about 800 psig (5.52 MPa) to about 5,000 psig (34.47 MPa). In embodiments of the present invention, a method for purifying leached polymers includes contacting leached polyethylene with n-butane at a pressure from about 1,000 psig (6.89 MPa) to about 4,500 psig (31.03 MPa).

In embodiments of the present invention, a method for purifying leached polymers includes contacting leached polyethylene with n-pentane at a temperature from about 80° C. to about 280° C. In embodiments of the present invention, a method for purifying leached polymers includes contacting leached polyethylene with n-pentane at a temperature from about 100° C. to about 220° C. In embodiments of the present invention, a method for purifying leached polymers includes contacting leached polyethylene with n-pentane at a temperature from about 130° C. to about 180° C. In embodiments of the present invention, a method for purifying leached polymers includes contacting leached polyethylene with n-pentane at a pressure from about 400 psig (2.78 MPa) to about 3,000 psig (20.68 MPa). In embodiments of the present invention, a method for purifying leached polymers includes contacting leached polyethylene with n-pentane at a pressure from about 800 psig (5.52 MPa) to about 2,800 psig (19.31 MPa). In embodiments of the present invention, a method for purifying leached polymers includes contacting leached polyethylene with n-pentane at a pressure from about 1,000 psig (6.89 MPa) to about 2,400 psig (16.55 MPa).

In embodiments of the present invention, a method for purifying leached polymers includes contacting leached polypropylene with n-butane at a temperature from about 80° C. to about 280° C. In embodiments of the present invention, a method for purifying leached polymers includes contacting leached polypropylene with n-butane at a temperature from about 100° C. to about 220° C. In embodiments of the present invention, a method for purifying leached polymers includes contacting leached polypropylene with n-butane at a temperature from about 130° C. to about 180° C. In embodiments of the present invention, a method for purifying leached polymers includes contacting leached polypropylene with n-butane at a pressure from about 150 psig (1.03 MPa) to about 3,000 psig (20.68 MPa). In embodiments of the present invention, a method for purifying leached polymers includes contacting leached polypropylene with n-butane at a pressure from about 1,000 psig (6.89 MPa) to about 2,750 psig (18.96 MPa). In embodiments of the present invention, a method for purifying leached polymers includes contacting leached polypropylene with n-butane at a pressure from about 1,500 psig (10.34 MPa) to about 2,500 psig (17.24 MPa).

In embodiments of the present invention, a method for purifying leached polymers includes contacting leached polypropylene with propane at a temperature from about 80° C. to about 280° C. In embodiments of the present invention, a method for purifying leached polymers includes contacting leached polypropylene with propane at a temperature from about 100° C. to about 220° C. In embodiments of the present invention, a method for purifying leached polymers includes contacting leached polypropylene with propane at a temperature from about 130° C. to about 180° C. In embodiments of the present invention, a method for purifying leached polymers includes contacting leached polypropylene with propane at a pressure from about 200 psig (1.38 MPa) to about 8,000 psig (55.16 MPa). In embodiments of the present invention, a method for purifying leached polymers includes contacting leached polypropylene with propane at a pressure from about 1,000 psig (6.89 MPa) to about 6,000 psig (41.37 MPa). In embodiments of the present invention, a method for purifying leached polymers includes contacting leached polypropylene with propane at a pressure from about 2,000 psig (13.79 MPa) to about 4,000 psig (27.58 MPa).

In embodiments of the present invention, a method for purifying leached polymers includes contacting leached polystyrene with a fluid solvent at a temperature and a pressure wherein the polystyrene remains essentially undissolved. In embodiments of the present invention, a method for purifying leached polymers includes contacting leached polystyrene with n-butane at a temperature from about 90° C. to about 280° C. In embodiments of the present invention, a method for purifying leached polymers includes contacting leached polystyrene with n-butane at a temperature from about 100° C. to about 220° C. In embodiments of the present invention, a method for purifying leached polymers includes contacting leached polystyrene with n-butane at a temperature from about 120° C. to about 180° C. In embodiments of the present invention, a method for purifying leached polymers includes contacting leached polystyrene with n-butane at a pressure from about 500 psig (3.45 MPa) to about 5,000 psig (34.47 MPa). In embodiments of the present invention, a method for purifying leached polymers includes contacting leached polystyrene with n-butane at a pressure from about 1,000 psig (6.89 MPa) to about 4,000 psig (27.58 MPa). In embodiments of the present invention, a method for purifying leached polymers includes contacting leached polystyrene with n-butane at a pressure from about 2,000 psig (13.79 MPa) to about 3,000 psig (20.68 MPa).

In embodiments of the present invention, a method for purifying leached polymers includes contacting leached poly(dimethylsiloxane) with a fluid solvent at a temperature and a pressure wherein the poly(dimethylsiloxane) remains essentially undissolved. In embodiments of the present invention, a method for purifying leached polymers includes contacting leached poly(dimethylsiloxane) with n-butane at a temperature from about 100° C. to about 280° C. In embodiments of the present invention, a method for purifying leached polymers includes contacting leached poly(dimethylsiloxane) with n-butane at a temperature from about 115° C. to about 220° C. In embodiments of the present invention, a method for purifying leached polymers includes contacting leached poly(dimethylsiloxane) with n-butane at a temperature from about 120° C. to about 180° C. In embodiments of the present invention, a method for purifying leached polymers includes contacting leached poly(dimethylsiloxane) with n-butane at a pressure from about 200 psig (1.38 MPa) to about 1,800 psig (12.41 MPa). In embodiments of the present invention, a method for purifying leached polymers includes contacting leached poly(dimethylsiloxane) with n-butane at a pressure from about 300 psig (2.07 MPa) to about 1,500 psig (10.34 MPa). In embodiments of the present invention, a method for purifying leached polymers includes contacting leached poly(dimethylsiloxane) with n-butane at a pressure from about 500 psig (3.45 MPa) to about 1,000 psig (6.89 MPa).

In embodiments of the present invention, a method for purifying a reclaimed polymer comprises extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer.

Dissolution

In embodiments of the present invention, a method for purifying reclaimed polymers includes dissolving the extracted polymer in a fluid solvent at a temperature and at a pressure wherein the polymer is dissolved in the fluid solvent. Although not wishing to be bound by any theory, applicants believe that the temperature and pressure can be controlled in such a way to enable thermodynamically favorable dissolution of the reclaimed polymer in a fluid solvent. Furthermore, the temperature and pressure can be controlled in such a way to enable dissolution of a particular polymer or polymer mixture while not dissolving other polymers or polymer mixtures. This controllable dissolution enables the separation of polymers from polymer mixtures.

In embodiments of the present invention, a method for purifying extracted polymers includes dissolving extracted polymers in a fluid solvent that does not dissolve the contaminants under the same conditions of temperature and pressure. The contaminants may include pigments, fillers, dirt, and other polymers. These contaminants are released from the extracted polymer upon dissolution and then removed from the polymer solution via a subsequent solid-liquid separation step.

In embodiments of the present invention, a method for purifying extracted polymers includes dissolving extracted polyethylene in a fluid solvent at a temperature and at a pressure wherein the polyethylene is dissolved in the fluid solvent. In embodiments of the present invention, a method for purifying extracted polymers includes dissolving an extracted polymer in a fluid solvent at a temperature from about 90° C. to about 280° C. In embodiments of the present invention, a method for purifying extracted polymers includes dissolving an extracted polymer in a fluid solvent at a temperature from about 110° C. to about 220° C. In embodiments of the present invention, a method for purifying extracted polymers includes dissolving an extracted polymer in a fluid solvent at a pressure from about 200 psig (1.38 MPa) to about 9,000 psig (62.05 MPa). In embodiments of the present invention, a method for purifying extracted polymers includes dissolving an extracted polymer in a fluid solvent at a pressure from about 400 psig (2.76 MPa) to about 2,600 psig (17.93 MPa).

In embodiments of the present invention, a method for purifying extracted polymers includes dissolving extracted polyethylene in n-butane at a temperature from about 90° C. to about 280° C. In embodiments of the present invention, a method for purifying extracted polymers includes dissolving extracted polyethylene in n-butane at a temperature from about 100° C. to about 220° C. In embodiments of the present invention, a method for purifying extracted polymers includes dissolving extracted polyethylene in n-butane at a temperature from about 130° C. to about 180° C. In embodiments of the present invention, a method for purifying extracted polymers includes dissolving extracted polyethylene in n-butane at a pressure from about 4,000 psig (27.58 MPa) to about 8,000 psig (55.16 MPa). In embodiments of the present invention, a method for purifying extracted polymers includes dissolving extracted polyethylene in n-butane at a pressure from about 4,200 psig (28.96 MPa) to about 7,000 psig (48.26 MPa). In embodiments of the present invention, a method for purifying extracted polymers includes dissolving extracted polyethylene in n-butane at a pressure from about 4,500 psig (31.03 MPa) to about 6,000 psig (41.37 MPa).

In embodiments of the present invention, a method for purifying extracted polymers includes dissolving extracted polyethylene in n-butane at a mass percent concentration of at least 0.5%. In embodiments of the present invention, the extracted polyethylene is dissolved at a mass percent concentration of at least 1%. In embodiments of the present invention, the extracted polyethylene is dissolved at a mass percent concentration of at least 2%. In embodiments of the present invention, the extracted polyethylene is dissolved at a mass percent concentration of at least 3%. In embodiments of the present invention, the extracted polyethylene is dissolved at a mass percent concentration of at least 4%. In embodiments of the present invention, the extracted polyethylene is dissolved at a mass percent concentration of at least 5%. In embodiments of the present invention, a method for purifying extracted polymers includes dissolving extracted polyethylene in n-butane at a mass percent concentration up to 20%. In embodiments of the present invention, the extracted polyethylene is dissolved at a mass percent concentration up to 18%. In embodiments of the present invention, the extracted polyethylene is dissolved at a mass percent concentration up to 16%. In embodiments of the present invention, the extracted polyethylene is dissolved at a mass percent concentration up to 14%. In embodiments of the present invention, the extracted polyethylene is dissolved at a mass percent concentration up to 12%.

In embodiments of the present invention, a method for purifying extracted polymers includes dissolving extracted polyethylene in propane at a temperature from about 90° C. to about 280° C. In embodiments of the present invention, a method for purifying extracted polymers includes dissolving extracted polyethylene in propane at a temperature from about 100° C. to about 220° C. In embodiments of the present invention, a method for purifying extracted polymers includes dissolving extracted polyethylene in propane at a temperature from about 130° C. to about 180° C. In embodiments of the present invention, a method for purifying extracted polymers includes dissolving extracted polyethylene in n-pentane at a pressure from about 800 psig (5.52 MPa) to about 4,000 psig (27.58 MPa). In embodiments of the present invention, a method for purifying extracted polymers includes dissolving extracted polyethylene in n-pentane at a pressure from about 900 psig (6.21 MPa) to about 3,000 psig (20.68 MPa). In embodiments of the present invention, a method for purifying extracted polymers includes dissolving extracted polyethylene in n-pentane at a pressure from about 1,000 psig (6.89 MPa) to about 2,400 psig (16.55 MPa).

In embodiments of the present invention, a method for purifying extracted polymers includes dissolving extracted polyethylene in n-pentane at a mass percent concentration of at least 0.5%. In embodiments of the present invention, the extracted polyethylene is dissolved at a mass percent concentration of at least 1%. In embodiments of the present invention, the extracted polyethylene is dissolved at a mass percent concentration of at least 2%. In embodiments of the present invention, the extracted polyethylene is dissolved at a mass percent concentration of at least 3%. In embodiments of the present invention, the extracted polyethylene is dissolved at a mass percent concentration of at least 4%. In embodiments of the present invention, the extracted polyethylene is dissolved at a mass percent concentration of at least 5%. In embodiments of the present invention, a method for purifying extracted polymers includes dissolving extracted polyethylene in n-pentane at a mass percent concentration up to 20%. In embodiments of the present invention, the extracted polyethylene is dissolved at a mass percent concentration up to 18%. In embodiments of the present invention, the extracted polyethylene is dissolved at a mass percent concentration up to 16%. In embodiments of the present invention, the extracted polyethylene is dissolved at a mass percent concentration up to 14%. In embodiments of the present invention, the extracted polyethylene is dissolved at a mass percent concentration up to 12%.

In embodiments of the present invention, a method for purifying extracted polymers includes dissolving extracted polypropylene in a fluid solvent at a temperature and a pressure wherein the polypropylene is dissolved in the fluid solvent. In embodiments of the present invention, a method for purifying extracted polymers includes dissolving extracted polypropylene in n-butane at a temperature from about 90° C. to about 280° C. In embodiments of the present invention, a method for purifying extracted polymers includes dissolving extracted polypropylene in n-butane at a temperature from about 100° C. to about 220° C. In embodiments of the present invention, a method for purifying extracted polymers includes dissolving extracted polypropylene in n-butane at a temperature from about 130° C. to about 180° C. In embodiments of the present invention, a method for purifying extracted polymers includes dissolving extracted polypropylene in n-butane at a pressure from about 350 psig (2.41 MPa) to about 4,000 psig (27.57 MPa). In embodiments of the present invention, a method for purifying extracted polymers includes dissolving extracted polypropylene in n-butane at a pressure from about 1,000 psig (6.89 MPa) to about 3,500 psig (24.13 MPa). In embodiments of the present invention, a method for purifying extracted polymers includes dissolving extracted polypropylene in n-butane at a pressure from about 2,000 psig (13.79 MPa) to about 3,000 psig (20.68 MPa).

In embodiments of the present invention, a method for purifying extracted polymers includes dissolving extracted polypropylene in n-butane at a mass percent concentration of at least 0.5%. In embodiments of the present invention, the extracted polypropylene is dissolved at a mass percent concentration of at least 1%. In embodiments of the present invention, the extracted polypropylene is dissolved at a mass percent concentration of at least 2%. In embodiments of the present invention, the extracted polypropylene is dissolved at a mass percent concentration of at least 3%. In embodiments of the present invention, the extracted polypropylene is dissolved at a mass percent concentration of at least 4%. In embodiments of the present invention, the extracted polypropylene is dissolved at a mass percent concentration of at least 5%. In embodiments of the present invention, a method for purifying extracted polymers includes dissolving extracted polypropylene in n-butane at a mass percent concentration up to 20%. In embodiments of the present invention, the extracted polypropylene is dissolved at a mass percent concentration up to 18%. In embodiments of the present invention, the extracted polypropylene is dissolved at a mass percent concentration up to 16%. In embodiments of the present invention, the extracted polypropylene is dissolved at a mass percent concentration up to 14%. In embodiments of the present invention, the extracted polypropylene is dissolved at a mass percent concentration up to 12%.

In embodiments of the present invention, a method for purifying extracted polymers includes dissolving extracted polypropylene in propane at a temperature from about 90° C. to about 280° C. In embodiments of the present invention, a method for purifying extracted polymers includes dissolving extracted polypropylene in propane at a temperature from about 100° C. to about 220° C. In embodiments of the present invention, a method for purifying extracted polymers includes dissolving extracted polypropylene in propane at a temperature from about 130° C. to about 180° C. In embodiments of the present invention, a method for purifying extracted polymers includes dissolving extracted polypropylene in propane at a pressure from about 2,000 psig (13.79 MPa) to about 8,000 psig (55.16 MPa). In embodiments of the present invention, a method for purifying extracted polymers includes dissolving extracted polypropylene in propane at a pressure from about 3,000 psig (20.68 MPa) to about 6,000 psig (41.37 MPa). In embodiments of the present invention, a method for purifying extracted polymers includes dissolving extracted polypropylene in propane at a pressure from about 3,500 psig (24.13 MPa) to about 5,000 psig (34.47 MPa).

In embodiments of the present invention, a method for purifying extracted polymers includes dissolving extracted polypropylene in propane at a mass percent concentration of at least 0.5%. In embodiments of the present invention, the extracted polypropylene is dissolved at a mass percent concentration of at least 1%. In embodiments of the present invention, the extracted polypropylene is dissolved at a mass percent concentration of at least 2%. In embodiments of the present invention, the extracted polypropylene is dissolved at a mass percent concentration of at least 3%. In embodiments of the present invention, the extracted polypropylene is dissolved at a mass percent concentration of at least 4%. In embodiments of the present invention, the extracted polypropylene is dissolved at a mass percent concentration of at least 5%. In embodiments of the present invention, a method for purifying extracted polymers includes dissolving extracted polypropylene in propane at a mass percent concentration up to 20%. In embodiments of the present invention, the extracted polypropylene is dissolved at a mass percent concentration up to 18%. In embodiments of the present invention, the extracted polypropylene is dissolved at a mass percent concentration up to 16%. In embodiments of the present invention, the extracted polypropylene is dissolved at a mass percent concentration up to 14%. In embodiments of the present invention, the extracted polypropylene is dissolved at a mass percent concentration up to 12%.

In embodiments of the present invention, a method for purifying extracted polymers includes dissolving extracted polystyrene in a fluid solvent at a temperature and a pressure wherein the extracted polystyrene is dissolved in the fluid solvent. In embodiments of the present invention, a method for purifying extracted polymers includes dissolving extracted polystyrene in n-butane at a temperature from about 90° C. to about 280° C. In embodiments of the present invention, a method for purifying extracted polymers includes dissolving extracted polystyrene in n-butane at a temperature from about 100° C. to about 220° C. In embodiments of the present invention, a method for purifying extracted polymers includes dissolving extracted polystyrene in n-butane at a temperature from about 130° C. to about 180° C. In embodiments of the present invention, a method for purifying extracted polymers includes dissolving extracted polystyrene in n-butane at a pressure from about 1,000 psig (6.89 MPa) to about 9,000 psig (62.05 MPa). In embodiments of the present invention, a method for purifying extracted polymers includes dissolving extracted polystyrene in n-butane at a pressure from about 2,000 psig (13.79 MPa) to about 8,000 psig (55.16 MPa). In embodiments of the present invention, a method for purifying extracted polymers includes dissolving extracted polystyrene in n-butane at a pressure from about 4,500 psig (31.03 MPa) to about 7,500 psig (51.71 MPa).

In embodiments of the present invention, a method for purifying extracted polystyrene includes dissolving extracted polystyrene in n-butane at a mass percent concentration of at least 0.5%. In embodiments of the present invention, the extracted polystyrene is dissolved at a mass percent concentration of at least 1%. In embodiments of the present invention, the extracted polystyrene is dissolved at a mass percent concentration of at least 2%. In embodiments of the present invention, the extracted polystyrene is dissolved at a mass percent concentration of at least 3%. In embodiments of the present invention, the extracted polystyrene is dissolved at a mass percent concentration of at least 4%. In embodiments of the present invention, the extracted polystyrene is dissolved at a mass percent concentration of at least 5%. In embodiments of the present invention, a method for purifying extracted polystyrene includes dissolving extracted polystyrene in n-butane at a mass percent concentration up to 20%. In embodiments of the present invention, the extracted polystyrene is dissolved at a mass percent concentration up to 18%. In embodiments of the present invention, the extracted polystyrene is dissolved at a mass percent concentration up to 16%. In embodiments of the present invention, the extracted polystyrene is dissolved at a mass percent concentration up to 14%. In embodiments of the present invention, the extracted polystyrene is dissolved at a mass percent concentration up to 12%.

In embodiments of the present invention, a method for purifying extracted polymers includes dissolving extracted poly(dimethylsiloxane) in a fluid solvent at a temperature and a pressure wherein the extracted poly(dimethylsiloxane) is dissolved in the fluid solvent. In embodiments of the present invention, a method for purifying extracted polymers includes dissolving extracted poly(dimethylsiloxane) in n-butane at a temperature from about 115° C. to about 280° C. In embodiments of the present invention, a method for purifying extracted polymers includes dissolving extracted poly(dimethylsiloxane) in n-butane at a temperature from about 120° C. to about 220° C. In embodiments of the present invention, a method for purifying extracted polymers includes dissolving extracted poly(dimethylsiloxane) in n-butane at a temperature from about 140° C. to about 180° C. In embodiments of the present invention, a method for purifying extracted polymers includes dissolving extracted poly(dimethylsiloxane) in n-butane at a pressure from about 500 psig (3.45 MPa) to about 2,100 psig (14.48 MPa). In embodiments of the present invention, a method for purifying extracted polymers includes dissolving extracted poly(dimethylsiloxane) in n-butane at a pressure from about 700 psig (4.83 MPa) to about 1,400 psig (9.65 MPa). In embodiments of the present invention, a method for purifying extracted polymers includes dissolving extracted poly(dimethylsiloxane) in n-butane at a pressure from about 800 psig (5.52 MPa) to about 1,300 psig (8.96 MPa).

In embodiments of the present invention, a method for purifying extracted poly(dimethylsiloxane) includes dissolving extracted poly(dimethylsiloxane) in n-butane at a mass percent concentration of at least 0.5%. In embodiments of the present invention, the extracted poly(dimethylsiloxane) is dissolved at a mass percent concentration of at least 1%. In embodiments of the present invention, the extracted poly(dimethylsiloxane) is dissolved at a mass percent concentration of at least 2%. In embodiments of the present invention, the extracted poly(dimethylsiloxane) is dissolved at a mass percent concentration of at least 3%. In embodiments of the present invention, the extracted poly(dimethylsiloxane) is dissolved at a mass percent concentration of at least 4%. In embodiments of the present invention, the extracted poly(dimethylsiloxane) is dissolved at a mass percent concentration of at least 5%. In embodiments of the present invention, a method for purifying extracted poly(dimethylsiloxane) includes dissolving extracted poly(dimethylsiloxane) in n-butane at a mass percent concentration up to 20%. In embodiments of the present invention, the extracted poly(dimethylsiloxane) is dissolved at a mass percent concentration up to 18%. In embodiments of the present invention, the extracted poly(dimethylsiloxane) is dissolved at a mass percent concentration up to 16%. In embodiments of the present invention, the extracted poly(dimethylsiloxane) is dissolved at a mass percent concentration up to 14%. In embodiments of the present invention, the extracted poly(dimethylsiloxane) is dissolved at a mass percent concentration up to 12%.

In embodiments of the present invention, a method for purifying a reclaimed polymer comprises dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant.

In embodiments of the present invention, the extracted polymer is dissolved in the fluid solvent, or fluid solvent mixture, at a mass percent concentration of at least 0.5%. In embodiments of the present invention, the temperature in the dissolution step is from about 110° C. to about 220° C. In embodiments of the present invention, the pressure in the dissolution step is from about 400 psig (2.76 MPa) to about 2,600 psig (17.93 MPa).

Settling

In embodiments of the present invention, a method for purifying polymers includes separating the undissolved contaminants from the polymer solution via a settling step at a temperature and at a pressure wherein the polymer remains dissolved in the fluid solvent. In embodiments of the present invention, the settling step causes the undissolved contaminants to experience a force that uniformly moves the undissolved contaminants in the direction of the force. Typically the applied settling force is gravity, but can also be a centrifugal, centripetal, or some other force. The amount of applied force and duration of settling time will depend upon several parameters, including, but not limited to: particle size of the contaminant particles, contaminant particle densities, density of the fluid or solution, and the viscosity of the fluid or solution. The following equation is a relationship between the aforementioned parameters and the settling velocity, which is a measure of the contaminant settling rate: v=2gr²(ρₚ−ρ_{f})/9η, where v is the settling velocity, ρₚ is the density of the contaminant particle, ρ_{f} is the density of the fluid or solution, g is the acceleration due to the applied force (typically gravity), r is the radius of the contaminant particle, and η is the dynamic viscosity of the fluid or solution. Some of the key parameters that determine the solution viscosity are: the chemical composition of the fluid solvent, the MW of the polymer dissolved in the fluid solvent, the concentration of dissolved polymer in the fluid solvent, the temperature of the fluid solvent solution, and the pressure of the fluid solvent solution.

In embodiments of the present invention, a method for purifying reclaimed polymers includes settling contaminants from a polyethylene/fluid solvent solution at a temperature and at a pressure wherein the polyethylene remains dissolved in the fluid solvent. In embodiments of the present invention, a method for purifying reclaimed polymers includes settling contaminants from a polyethylene/fluid solvent solution at a temperature from about 90° C. to about 280° C. In embodiments of the present invention, a method for purifying reclaimed polymers includes settling contaminants from a polyethylene/fluid solvent solution at a temperature from about 110° C. to about 220° C. In embodiments of the present invention, a method for purifying reclaimed polymers includes settling contaminants from a polyethylene/fluid solvent solution at a pressure from about 200 psig (1.38 MPa) to about 9,000 psig (62.05 MPa). In embodiments of the present invention, a method for purifying reclaimed polymers includes settling contaminants from a polyethylene/fluid solvent solution at a pressure from about 400 psig (2.76 MPa) to about 2,600 psig (17.93 MPa).

In embodiments of the present invention, a method for purifying reclaimed polymers includes settling contaminants from a polyethylene/n-butane solution at a temperature from about 90° C. to about 280° C. In embodiments of the present invention, a method for purifying reclaimed polymers includes settling contaminants from a polyethylene/n-butane solution at a temperature from about 100° C. to about 220° C. In embodiments of the present invention, a method for purifying reclaimed polymers includes settling contaminants from a polyethylene/n-butane solution at a temperature from about 130° C. to about 180° C. In embodiments of the present invention, a method for purifying reclaimed polymers includes settling contaminants from a polyethylene/n-butane solution at a pressure from about 4,000 psig (27.58 MPa) to about 8,000 psig (55.16 MPa). In embodiments of the present invention, a method for purifying reclaimed polymers includes settling contaminants from a polyethylene/n-butane solution at a pressure about 4,200 psig (28.96 MPa) to about 7,000 psig (48.26 MPa). In embodiments of the present invention, a method for purifying reclaimed polymers includes settling contaminants from a polyethylene/n-butane solution at a pressure from about 4,500 psig (31.03 MPa) to about 6,000 psig (41.37 MPa).

In embodiments of the present invention, a method for purifying reclaimed polymers includes settling contaminants from a polyethylene/n-butane solution wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes settling contaminants from a polyethylene/n-butane solution where in the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes settling contaminants from a polyethylene/n-pentane solution at a temperature from about 90° C. to about 280° C. In embodiments of the present invention, a method for purifying reclaimed polymers includes settling contaminants from a polyethylene/n-pentane solution at a temperature from about 100° C. to about 220° C. In embodiments of the present invention, a method for purifying reclaimed polymers includes settling contaminants from a polyethylene/n-pentane solution at a temperature from about 130° C. to about 180° C. In embodiments of the present invention, a method for purifying reclaimed polymers includes settling contaminants from a polyethylene/n-pentane solution at a pressure from about 800 psig (5.52 MPa) to about 3,000 psig (20.68 MPa). In embodiments of the present invention, a method for purifying reclaimed polymers includes settling contaminants from a polyethylene/n-pentane solution at a pressure from about 900 psig (6.21 MPa) to about 3,000 psig (20.68 MPa). In embodiments of the present invention, a method for purifying reclaimed polymers includes settling contaminants from a polyethylene/n-pentane solution at a pressure from about 1,000 psig (6.89 MPa) to about 2,400 psig (16.55 MPa).

In embodiments of the present invention, a method for purifying reclaimed polymers includes settling contaminants from a polyethylene/n-pentane solution wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes settling contaminants from a polyethylene/n-pentane solution where in the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes settling contaminants from a polypropylene/fluid solvent solution at a temperature and at a pressure wherein the polypropylene remains dissolved in the fluid solvent. In embodiments of the present invention, a method for purifying reclaimed polymers includes settling contaminants from a polypropylene/n-butane solution at a temperature from about 90° C. to about 280° C. In embodiments of the present invention, a method for purifying reclaimed polymers includes settling contaminants from a polypropylene/n-butane solution at a temperature from about 100° C. to about 220° C. In embodiments of the present invention, a method for purifying reclaimed polymers includes settling contaminants from a polypropylene/n-butane solution at a temperature from about 130° C. to about 180° C. In embodiments of the present invention, a method for purifying reclaimed polymers includes settling contaminants from a polypropylene/n-butane solution at a pressure from about 350 psig (2.41 MPa) to about 4,000 psig (27.57 MPa). In embodiments of the present invention, a method for purifying reclaimed polymers includes settling contaminants from a polypropylene/n-butane solution at a pressure from about 1,000 psig (6.89 MPa) to about 3,500 psig (24.13 MPa). In embodiments of the present invention, a method for purifying reclaimed polymers includes settling contaminants from a polypropylene/n-butane solution at a pressure from about 2,000 psig (13.79 MPa) to about 3,000 psig (20.68 MPa).

In embodiments of the present invention, a method for purifying reclaimed polymers includes settling contaminants from a polypropylene/n-butane solution wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes settling contaminants from a polypropylene/n-butane solution where in the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes settling contaminants from a polypropylene/propane solution at a temperature from about 90° C. to about 280° C. In embodiments of the present invention, a method for purifying reclaimed polymers includes settling contaminants from a polypropylene/propane solution at a temperature from about 100° C. to about 220° C. In embodiments of the present invention, a method for purifying reclaimed polymers includes settling contaminants from a polypropylene/propane solution at a temperature from about 130° C. to about 180° C. In embodiments of the present invention, a method for purifying reclaimed polymers includes settling contaminants from a polypropylene/propane solution at a pressure from about 2,000 psig (13.79 MPa) to about 8,000 psig (55.16 MPa). In embodiments of the present invention, a method for purifying reclaimed polymers includes settling contaminants from a polypropylene/propane solution at a pressure from about 3,000 psig (20.68 MPa) to about 6,000 psig (41.37 MPa). In embodiments of the present invention, a method for purifying reclaimed polymers includes settling contaminants from a polypropylene/propane solution at a pressure from about 3,500 psig (24.13 MPa) to about 5,000 psig (34.47 MPa).

In embodiments of the present invention, a method for purifying reclaimed polymers includes settling contaminants from a polypropylene/propane solution wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes settling contaminants from a polypropylene/propane solution where in the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes settling contaminants from a polystyrene/fluid solvent solution at a temperature and at a pressure wherein the polystyrene remains dissolved in the fluid solvent. In embodiments of the present invention, a method for purifying reclaimed polymers includes settling contaminants from a polystyrene/n-butane solution at a temperature from about 90° C. to about 280° C. In embodiments of the present invention, a method for purifying reclaimed polymers includes settling contaminants from a polystyrene/n-butane solution at a temperature from about 100° C. to about 220° C. In embodiments of the present invention, a method for purifying reclaimed polymers includes settling contaminants from a polystyrene/n-butane solution at a temperature from about 130° C. to about 180° C. In embodiments of the present invention, a method for purifying reclaimed polymers includes settling contaminants from a polystyrene/n-butane solution at a pressure from about 1,000 psig (6.89 MPa) to about 9,000 psig (62.05 MPa). In embodiments of the present invention, a method for purifying reclaimed polymers includes settling contaminants from a polystyrene/n-butane solution at a pressure from about 2,000 psig (13.79 MPa) to about 8,000 psig (55.16 MPa). In embodiments of the present invention, a method for purifying reclaimed polymers includes settling contaminants from a polystyrene/n-butane solution at a pressure from about 4,500 psig (31.03 MPa) to about 7,500 psig (51.71 MPa).

In embodiments of the present invention, a method for purifying reclaimed polymers includes settling contaminants from a polystyrene/n-butane solution wherein the polystyrene is dissolved at a mass percent concentration of at least 0.5%. In embodiments of the present invention, the polystyrene is dissolved at a mass percent concentration of at least 1%. In embodiments of the present invention, the polystyrene is dissolved at a mass percent concentration of at least 2%. In embodiments of the present invention, the polystyrene is dissolved at a mass percent concentration of at least 3%. In embodiments of the present invention, the polystyrene is dissolved at a mass percent concentration of at least 4%. In embodiments of the present invention, the polystyrene is dissolved at a mass percent concentration of at least 5%. In embodiments of the present invention, a method for purifying reclaimed polymers includes settling contaminants from a polystyrene/n-butane solution where in the polystyrene is dissolved at a mass percent concentration up to 20%. In embodiments of the present invention, the polystyrene is dissolved at a mass percent concentration up to 18%. In embodiments of the present invention, the polystyrene is dissolved at a mass percent concentration up to 16%. In embodiments of the present invention, the polystyrene is dissolved at a mass percent concentration up to 14%. In embodiments of the present invention, the polystyrene is dissolved at a mass percent concentration up to 12%.

In embodiments of the present invention, a method for purifying reclaimed polymers includes settling contaminants from a poly(dimethylsiloxane)/fluid solvent solution at a temperature and at a pressure wherein the poly(dimethylsiloxane) remains dissolved in the fluid solvent. In embodiments of the present invention, a method for purifying reclaimed polymers includes settling contaminants from a poly(dimethylsiloxane)/n-butane solution at a temperature from about 115° C. to about 280° C. In embodiments of the present invention, a method for purifying reclaimed polymers includes settling contaminants from a poly(dimethylsiloxane)/n-butane solution at a temperature from about 120° C. to about 220° C. In embodiments of the present invention, a method for purifying reclaimed polymers includes settling contaminants from a poly(dimethylsiloxane)/n-butane solution at a temperature from about 140° C. to about 180° C. In embodiments of the present invention, a method for purifying reclaimed polymers includes settling contaminants from a poly(dimethylsiloxane)/n-butane solution at a pressure from about 500 psig (3.45 MPa) to about 2,100 psig (14.48 MPa). In embodiments of the present invention, a method for purifying reclaimed polymers includes settling contaminants from a poly(dimethylsiloxane)/n-butane solution at a pressure from about 700 psig (4.83 MPa) to about 1,400 psig (9.65 MPa). In embodiments of the present invention, a method for purifying reclaimed polymers includes settling contaminants from a poly(dimethylsiloxane)/n-butane solution with solid media at a pressure from about 800 psig (5.52 MPa) to about 1,300 psig (8.96 MPa).

In embodiments of the present invention, a method for purifying reclaimed polymers includes settling contaminants from a poly(dimethylsiloxane)/n-butane solution wherein the poly(dimethylsiloxane) is dissolved at a mass percent concentration of at least 0.5%. In embodiments of the present invention, the poly(dimethylsiloxane) is dissolved at a mass percent concentration of at least 1%. In embodiments of the present invention, the poly(dimethylsiloxane) is dissolved at a mass percent concentration of at least 2%. In embodiments of the present invention, the poly(dimethylsiloxane) is dissolved at a mass percent concentration of at least 3%. In embodiments of the present invention, the poly(dimethylsiloxane) is dissolved at a mass percent concentration of at least 4%. In embodiments of the present invention, the poly(dimethylsiloxane) is dissolved at a mass percent concentration of at least 5%. In embodiments of the present invention, a method for purifying reclaimed polymers includes settling contaminants from a poly(dimethylsiloxane)/n-butane solution where in the poly(dimethylsiloxane) is dissolved at a mass percent concentration up to 20%. In embodiments of the present invention, the poly(dimethylsiloxane) is dissolved at a mass percent concentration up to 18%. In embodiments of the present invention, the poly(dimethylsiloxane) is dissolved at a mass percent concentration up to 16%. In embodiments of the present invention, the poly(dimethylsiloxane) is dissolved at a mass percent concentration up to 14%. In embodiments of the present invention, the poly(dimethylsiloxane) is dissolved at a mass percent concentration up to 12%.

In embodiments of the present invention, a method for purifying a reclaimed polymer comprises settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant.

In embodiments of the present invention, the temperature in the settling step is from about 110° C. to about 220° C. In embodiments of the present invention, the pressure in the settling step is from about 400 psig (2.76 MPa) to about 2,600 psig (17.93 MPa).

Mechanical Filtration

For the purposes of the present invention and unless specifically mentioned, the term “filtration” indicates “mechanical filtration” or “adsorptive filtration”, or the term is inclusive of both types of filtration. A typical filtration system comprises a filter medium, a filter container, a filter inlet, and a filter outlet. The filter medium comprises filter particles that are contained within the filter container. The filter inlet is in fluid communication with the filter container and carries the filtration feed stream in the filter container, and the filter outlet is in fluid communication with the filtration system and carries the filtrate stream out of the filter container. A filtration system can comprise one or more filter media, filter containers, and filter inlets and outlets in series or in parallel. Also, a filtration system can operate in radial or axial flow, or it can operate in up flow, downflow, or crossflow. A non-limiting example of a radial flow filter is a candle filter. Furthermore, the filtration can be of depth filtration type or surface filtration type and is based on mechanical mode of action. A non-limiting example of a mechanical mode of action is size exclusion, where a suspended (dispersed) contaminant gets retained by the filtration medium, and thus separated from the filtration feed stream, because the suspended contaminant's size is larger than the pores of the filtration medium. As described, size exclusion is an inter-particle phenomenon.

The filter medium used in depth filtration comprises an aggregate of filter particles, which can be either homogeneous or heterogeneous. The filter particles can be uniformly or non-uniformly distributed (e.g., layers of different filter particles) within the filter medium. The filter particles forming the filter medium also need not be identical in shape or size and may be provided in either a loose or interconnected form. For example, a filter medium might comprise filter particles, which can be either in loose association, or partially or wholly bonded by a polymeric binder or other means to form an integral structure.

Also, the filter particles can be provided in a variety of shapes and sizes. For example, and not by way of limitation, the filter particles can be provided in simple forms, such as powder, granules, fibers, and beads. The filter particles can be provided in the shape of a sphere, polyhedron, cylinder, as well as other symmetrical, asymmetrical, and irregular shapes. Further, the filter particles can also be formed into complex forms such as webs, screens, meshes, non-wovens, wovens, and bonded blocks, which may or may not be formed from the simple forms described above. The filter particles can vary in size, from impalpable filter particles (e.g., a very fine powder) to palpable filter particles. Furthermore, the size of the filter particles need not be uniform among the filter particles which are used in any single filtration system. In fact, it can be desirable to provide filter particles having different sizes in a single filter.

In embodiments of the present invention, the size of the filter particles varies between about 0.1 mm and about 10 mm. In embodiments of the present invention, the size of the filter particles varies between about 10 mm and about 8 mm. In embodiments of the present invention, the size of the filter particles varies between about 100 mm and about 5 mm. In embodiments of the present invention, the size of the filter particles varies between about 1 mm and about 4 mm. In embodiments of the present invention, the size of the filter particles varies between about 10 μm and about 100 μm. For spherical and cylindrical particles (e.g., fibers, beads, etc.), the above-described dimensions refer to the diameter of the filter particles. For filter particles having substantially different shapes, the above-described dimensions refer to the largest dimension (e.g., length, width, or height).

Non-limiting examples of filter particles are silicon oxide (silica), silica gel, aluminum oxide (alumina), activated alumina, iron oxide, aluminum silicate, magnesium silicate, amorphous volcanic glass, reclaimed glass, sand, quartz, diatomaceous earth, zeolite, molecular sieve, perlite, clay, fuller's earth, bentonite clay, metal organic framework (MOF), covalent organic framework (COF), zeolitic imidazolate framework (ZIF), cellulose, lignocellulose, anthracite coal, carbon black, coke, and activated carbon. In embodiments of the present invention, the filter particles are selected from the group consisting of silica, activated alumina, silica gel, volcanic glass, fuller's earth, bentonite clay, and mixtures thereof. In embodiments of the present invention, the filter particles are selected from the group consisting of activated carbon, activated alumina, diatomaceous earth, and mixtures thereof. In embodiments of the present invention, the filter particles are selected from the group consisting of MOF, COF, ZIF, activated carbon, activated alumina, and mixtures thereof. In embodiments of the present invention, the filter particles are selected from the group consisting of diatomaceous earth, activated alumina, and mixtures thereof.

Non-limiting examples of filter media used in surface filtration are a thin layer of filter particles, porous ceramics, filter paper, filter cloths, plastic membrane, screen, non-woven, woven, porous frit/sintered metal, and perforated plate. In a typical surface filtration, the retained contaminants form a cake on top of the filter medium that increases in thickness as the filtration proceeds. Typically, after a certain filtration time, the filter cake needs to be removed, as it offers unsustainable pressure drop, either by mechanical action or back-flushing. In embodiments of the present invention, the filter medium used in surface filtration is selected from the group consisting of a thin layer of diatomaceous earth particles deposited onto a woven metal porous core (typically called sock). The porous core supports the filter medium and allows the filtration feed stream to flow through. Non-limiting examples of cores are perforated tubes and screen sleeves.

Filter aids may be used in filtration. Non-limiting examples of filter aids are diatomaceous earth (also called kieselguhr), cellulose, and perlite. These filter aids can be used either as a pre-coat to the filter media or added into the filtration feed stream. In the latter case (also called body feed), the filter aids increase the porosity of the cake formed onto the filter media thus reducing the pressure drop through the cake during filtration. At the end of their useful life, filters can either be removed from the operation and get replaced with fresh ones or get regenerated. Non-limiting examples of regeneration are back-flushing, thermal regeneration, and solvent regeneration.

In embodiments of the present invention, the surface filter comprises a candle filter. In embodiments of the present invention, the candle filter comprises a thin layer of diatomaceous earth deposited onto a woven metal porous core. In embodiments of the present invention, the thickness of the diatomaceous earth layer is between about 1 mm and about 20 mm. In embodiments of the present invention, the thickness of the diatomaceous earth layer is between about 2 mm and about 10 mm. In embodiments of the present invention, the thickness of the diatomaceous earth layer is between about 3 mm and about 5 mm.

The permeability of the filter medium is measured (as it is well known to those skilled in the art) by passing a fluid stream through the filter medium and measuring the flow rate and pressure drop. The unit of measurement is millidarcy (mD), and 1 mD is equivalent to the passage of 1 mL of fluid with 1 mPa·s (1 cP) viscosity, flowing in 1 s under a pressure of 1 atm, through a filter medium 1 cm² in cross-sectional area and 1 cm in thickness. In embodiments of the present invention, the permeability of the diatomaceous earth medium is between about 30 mD and about 20,000 mD. In embodiments of the present invention, the permeability of the diatomaceous earth medium is between about 400 mD and about 8,000 mD. In embodiments of the present invention, the permeability of the diatomaceous earth medium is between about 1,000 mD and about 4,000 mD. In embodiments of the present invention, the permeability of the diatomaceous earth medium is between about 2,300 mD and about 3,400 mD.

In embodiments of the present invention, the diatomaceous earth medium retains suspended particles with diameter larger than about 0.3 μm. In embodiments of the present invention, the diatomaceous earth medium retains suspended particles with diameter larger than about 0.8 μm. In embodiments of the present invention, the diatomaceous earth medium retains suspended particles with diameter larger than about 1 μm. In embodiments of the present invention, the diatomaceous earth medium retains suspended particles with diameter larger than about 1.7 μm. In embodiments of the present invention, the diatomaceous earth medium retains suspended particles with diameter larger than about 4 μm.

In embodiments of the present invention, the candle filter comprises a thin diatomaceous earth medium deposited on a woven metal core; wherein the thickness of the diatomaceous earth medium is between about 2 mm and about 10 mm; wherein the permeability of the diatomaceous earth medium is between about 2,300 mD and 3,400 mD; and wherein the diatomaceous earth medium retains suspended particles with diameter larger than about 1.7 μm.

In embodiments of the present invention, a method for purifying reclaimed polymers includes filtering contaminants from a polyethylene/fluid solvent solution at a temperature and at a pressure wherein the polyethylene remains dissolved in the fluid solvent. In embodiments of the present invention, a method for purifying reclaimed polymers includes filtering contaminants from a polyethylene/fluid solvent solution at a temperature from about 90° C. to about 280° C. In embodiments of the present invention, the temperature in the filtration step is from about 110° C. to about 220° C. In embodiments of the present invention, a method for purifying reclaimed polymers includes filtering contaminants from a polyethylene/fluid solvent solution at a pressure from about 200 psig (1.38 MPa) to about 9,000 psig (62.05 MPa). In embodiments of the present invention, the pressure in the filtration step is from about 400 psig (2.76 MPa) to about 2,600 psig (17.93 MPa).

In embodiments of the present invention, a method for purifying reclaimed polymers includes filtering contaminants from a polyethylene/n-butane solution at a temperature from about 90° C. to about 280° C. In embodiments of the present invention, a method for purifying reclaimed polymers includes filtering contaminants from a polyethylene/n-butane solution at a temperature from about 100° C. to about 220° C. In embodiments of the present invention, a method for purifying reclaimed polymers includes filtering contaminants from a polyethylene/n-butane solution at a temperature from about 130° C. to about 180° C. In embodiments of the present invention, a method for purifying reclaimed polymers includes filtering contaminants from a polyethylene/n-butane solution at a pressure from about 4000 psig (27.58 MPa) to about 8,000 psig (55.16 MPa). In embodiments of the present invention, a method for purifying reclaimed polymers includes filtering contaminants from a polyethylene/n-butane solution at a pressure from about 4,200 psig (28.96 MPa) to about 7,000 psig (48.26 MPa). In embodiments of the present invention, a method for purifying reclaimed polymers includes filtering contaminants from a polyethylene/n-butane solution at a pressure from about 4,500 psig (31.03 MPa) to about 6,000 psig (41.37 MPa).

In embodiments of the present invention, a method for purifying reclaimed polymers includes filtering contaminants from a polyethylene/n-butane solution wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes filtering contaminants from a polyethylene/n-butane solution where in the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes filtering contaminants from a polyethylene/n-pentane solution at a temperature from about 90° C. to about 280° C. In embodiments of the present invention, a method for purifying reclaimed polymers includes filtering contaminants from a polyethylene/n-pentane solution at a temperature from about 100° C. to about 220° C. In embodiments of the present invention, a method for purifying reclaimed polymers includes filtering contaminants from a polyethylene/n-pentane solution at a temperature from about 130° C. to about 180° C. In embodiments of the present invention, a method for purifying reclaimed polymers includes filtering contaminants from a polyethylene/n-pentane solution at a pressure from about 800 psig (5.52 MPa) to about 4,000 psig (27.58 MPa). In embodiments of the present invention, a method for purifying reclaimed polymers includes filtering contaminants from a polyethylene/n-pentane solution at a pressure from about 900 psig (6.21 MPa) to about 3,000 psig (20.68 MPa). In embodiments of the present invention, a method for purifying reclaimed polymers includes filtering contaminants from a polyethylene/n-pentane solution at a pressure from about 1,000 psig (6.89 MPa) to about 2,400 psig (16.55 MPa).

In embodiments of the present invention, a method for purifying reclaimed polymers includes filtering contaminants from a polyethylene/n-pentane solution wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes filtering contaminants from a polyethylene/n-pentane solution where in the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes filtering contaminants from a polypropylene/n-butane solution at a temperature from about 90° C. to about 280° C. In embodiments of the present invention, a method for purifying reclaimed polymers includes filtering contaminants from a polypropylene/n-butane solution at a temperature from about 100° C. to about 220° C. In embodiments of the present invention, a method for purifying reclaimed polymers includes filtering contaminants from a polypropylene/n-butane solution at a temperature from about 130° C. to about 180° C. In embodiments of the present invention, a method for purifying reclaimed polymers includes filtering contaminants from a polypropylene/n-butane solution at a pressure from about 350 psig (2.41 MPa) to about 4,000 psig (27.57 MPa). In embodiments of the present invention, a method for purifying reclaimed polymers includes filtering contaminants from a polypropylene/n-butane solution at a pressure from about 1,000 psig (6.89 MPa) to about 3,500 psig (24.13 MPa). In embodiments of the present invention, a method for purifying reclaimed polymers includes filtering contaminants from a polypropylene/n-butane solution at a pressure from about 2,000 psig (13.79 MPa) to about 3,000 psig (20.68 MPa).

In embodiments of the present invention, a method for purifying reclaimed polymers includes filtering contaminants from a polypropylene/n-butane solution wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes filtering contaminants from a polypropylene/n-butane solution where in the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes filtering contaminants from a polypropylene/propane solution at a temperature from about 90° C. to about 280° C. In embodiments of the present invention, a method for purifying reclaimed polymers includes filtering contaminants from a polypropylene/propane solution at a temperature from about 100° C. to about 220° C. In embodiments of the present invention, a method for purifying reclaimed polymers includes filtering contaminants from a polypropylene/propane solution at a temperature from about 130° C. to about 180° C. In embodiments of the present invention, a method for purifying reclaimed polymers includes filtering contaminants from a polypropylene/propane solution at a pressure from about 2,000 psig (13.79 MPa) to about 8,000 psig (55.16 MPa). In embodiments of the present invention, a method for purifying reclaimed polymers includes filtering contaminants from a polypropylene/propane solution at a pressure from about 3,000 psig (20.68 MPa) to about 6,000 psig (41.37 MPa). In embodiments of the present invention, a method for purifying reclaimed polymers includes filtering contaminants from a polypropylene/propane solution at a pressure from about 3,500 psig (24.13 MPa) to about 5,000 psig (34.47 MPa).

In embodiments of the present invention, a method for purifying reclaimed polymers includes filtering contaminants from a polypropylene/propane solution wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes filtering contaminants from a polypropylene/propane solution where in the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes filtering contaminants from a polystyrene/fluid solvent solution at a temperature and at a pressure wherein the polystyrene remains dissolved in the fluid solvent. In embodiments of the present invention, a method for purifying reclaimed polymers includes filtering contaminants from a polystyrene/n-butane solution at a temperature from about 90° C. to about 280° C. In embodiments of the present invention, a method for purifying reclaimed polymers includes filtering contaminants from a polystyrene/n-butane solution at a temperature from about 100° C. to about 220° C. In embodiments of the present invention, a method for purifying reclaimed polymers includes filtering contaminants from a polystyrene/n-butane solution at a temperature from about 130° C. to about 180° C. In embodiments of the present invention, a method for purifying reclaimed polymers includes filtering contaminants from a polystyrene/n-butane solution at a pressure from about 1,000 psig (6.89 MPa) to about 9,000 psig (62.05 MPa). In embodiments of the present invention, a method for purifying reclaimed polymers includes filtering contaminants from a polystyrene/n-butane solution at a pressure from about 2,000 psig (13.79 MPa) to about 8,000 psig (55.16 MPa). In embodiments of the present invention, a method for purifying reclaimed polymers includes filtering contaminants from a polystyrene/n-butane solution at a pressure from about 4,500 psig (31.03 MPa) to about 7,500 psig (51.71 MPa).

In embodiments of the present invention, a method for purifying reclaimed polymers includes filtering contaminants from a polystyrene/n-butane solution wherein the polystyrene is dissolved at a mass percent concentration of at least 0.5%. In embodiments of the present invention, the polystyrene is dissolved at a mass percent concentration of at least 1%. In embodiments of the present invention, the polystyrene is dissolved at a mass percent concentration of at least 2%. In embodiments of the present invention, the polystyrene is dissolved at a mass percent concentration of at least 3%. In embodiments of the present invention, the polystyrene is dissolved at a mass percent concentration of at least 4%. In embodiments of the present invention, the polystyrene is dissolved at a mass percent concentration of at least 5%. In embodiments of the present invention, a method for purifying reclaimed polymers includes filtering contaminants from a polystyrene/n-butane solution wherein the polystyrene is dissolved at a mass percent concentration up to 20%. In embodiments of the present invention, the polystyrene is dissolved at a mass percent concentration up to 18%. In embodiments of the present invention, the polystyrene is dissolved at a mass percent concentration up to 16%. In embodiments of the present invention, the polystyrene is dissolved at a mass percent concentration up to 14%. In embodiments of the present invention, the polystyrene is dissolved at a mass percent concentration up to 12%.

In embodiments of the present invention, a method for purifying reclaimed polymers includes filtering contaminants from a poly(dimethylsiloxane)/fluid solvent solution at a temperature and at a pressure wherein the poly(dimethylsiloxane) remains dissolved in the fluid solvent. In embodiments of the present invention, a method for purifying reclaimed polymers includes filtering contaminants from a poly(dimethylsiloxane)/n-butane solution at a temperature from about 115° C. to about 280° C. In embodiments of the present invention, a method for purifying reclaimed polymers includes filtering contaminants from a poly(dimethylsiloxane)/n-butane solution at a temperature from about 120° C. to about 220° C. In embodiments of the present invention, a method for purifying reclaimed polymers includes filtering contaminants from a poly(dimethylsiloxane)/n-butane solution at a temperature from about 140° C. to about 180° C. In embodiments of the present invention, a method for purifying reclaimed polymers includes filtering contaminants from a poly(dimethylsiloxane)/n-butane solution at a pressure from about 500 psig (3.45 MPa) to about 2,100 psig (14.48 MPa). In embodiments of the present invention, a method for purifying reclaimed polymers includes filtering contaminants from a poly(dimethylsiloxane)/n-butane solution at a pressure from about 700 psig (4.83 MPa) to about 1,400 psig (9.65 MPa). In embodiments of the present invention, a method for purifying reclaimed polymers includes filtering contaminants from a poly(dimethylsiloxane)/n-butane solution at a pressure from about 800 psig (5.52 MPa) to about 1,300 psig (8.96 MPa).

In embodiments of the present invention, a method for purifying reclaimed polymers includes filtering contaminants from a poly(dimethylsiloxane)/n-butane solution wherein the poly(dimethylsiloxane) is dissolved at a mass percent concentration of at least 0.5%. In embodiments of the present invention, the poly(dimethylsiloxane) is dissolved at a mass percent concentration of at least 1%. In embodiments of the present invention, the poly(dimethylsiloxane) is dissolved at a mass percent concentration of at least 2%. In embodiments of the present invention, the poly(dimethylsiloxane) is dissolved at a mass percent concentration of at least 3%. In embodiments of the present invention, the poly(dimethylsiloxane) is dissolved at a mass percent concentration of at least 4%. In embodiments of the present invention, the poly(dimethylsiloxane) is dissolved at a mass percent concentration of at least 5%. In embodiments of the present invention, a method for purifying reclaimed polymers includes filtering contaminants from a poly(dimethylsiloxane)/n-butane solution wherein the poly(dimethylsiloxane) is dissolved at a mass percent concentration up to 20%. In embodiments of the present invention, the poly(dimethylsiloxane) is dissolved at a mass percent concentration up to 18%. In embodiments of the present invention, the poly(dimethylsiloxane) is dissolved at a mass percent concentration up to 16%. In embodiments of the present invention, the poly(dimethylsiloxane) is dissolved at a mass percent concentration up to 14%. In embodiments of the present invention, the poly(dimethylsiloxane) is dissolved at a mass percent concentration up to 12%.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of alkyl phenols, bisphenols, dioxins, PCBs, and phthalates; b) leaching said alkyl phenols, bisphenols, dioxins, PCBs, or phthalates from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of alkyl phenols, bisphenols, dioxins, PCBs, or phthalates, each having a concentration; and wherein said average removal efficiency is greater than about 55%; c) extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer; d) dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant; e) settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant; and f) filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant.

In embodiments of the present invention, a method for purifying a reclaimed polymer comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of 4-tertpentylphenol, bisphenol A, OCDD, PCB 118, and 2-ethylhexyl phthalate; b) surface washing said reclaimed polymer in a non-densified state to produce a surface-washed polymer; wherein said surface washing results in a greater than about 80% reduction in loosely bound surface contamination; c) leaching said 4-tertpentylphenol, bisphenol A, OCDD, PCB 118, and 2-ethylhexyl phthalate from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of 4-tertpentylphenol, bisphenol A, OCDD, PCB 118, and 2-ethylhexyl phthalate, each having a concentration; wherein said average removal efficiency is greater than about 55%; d) extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer; e) dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant; f) settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant; g) filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant.

Adsorptive Filtration

In embodiments of the present invention, a method for purifying polyethylene includes contacting a contaminated polymer solution with solid media at a temperature and at a pressure wherein the polymer remains dissolved in the fluid solvent. The solid media of the present invention, also referred to throughout the present invention as adsorption media or adsorption filtration media, comprise solid media particles and are any solid materials that remove at least some of the contamination from a solution of reclaimed polyethylene dissolved in the fluid solvent of the present invention. Although not wishing to be bound by any theory, the applicants believe that the solid media remove contamination by a variety of mechanisms. Non-limiting examples of possible mechanisms include adsorption, absorption, electrostatics, size exclusion, ion exclusion, ion exchange, and other mechanisms that may be apparent to those having ordinary skill in the art. Furthermore, the pigments and other contaminants commonly found in reclaimed polyethylene may be polar compounds or may have polar compounds on their surfaces and may preferentially interact with the solid media, which may also be at least slightly polar. The polar-polar interactions are especially favorable when non-polar solvents, such as alkanes, are used as the fluid solvent.

In embodiments of the present invention, the solid media are selected from the group consisting of inorganic substances, carbon-based substances, or mixtures thereof. Useful examples of inorganic substances include oxides of silicon, oxides of aluminum, oxides of iron, aluminum silicates, magnesium silicates, amorphous volcanic glasses, silica, silica gel, diatomite, sand, quartz, reclaimed glass, alumina, perlite, fuller's earth, bentonite, and mixtures thereof. Useful examples of carbon-based substances include anthracite coal, carbon black, coke, activated carbon, cellulose, and mixtures thereof. In embodiments of the present invention, the solid media are recycled glasses. In embodiments of the present invention, the solid media particles are selected from the group consisting of solid particles of silicon oxide (silica), silica gel, aluminum oxide (alumina), activated alumina, iron oxide, aluminum silicate, magnesium silicate, sand, quartz, diatomaceous earth, zeolite, molecular sieve, perlite, clay, fuller's earth, bentonite clay, metal organic framework (MOF), covalent organic framework (COF), zeolitic imidazolate framework (ZIF), cellulose, and lignocellulose. In embodiments of the present invention, the solid media are selected from the group consisting of silica, activated alumina, silica gel, fuller's earth, bentonite clay, and mixtures thereof. In embodiments of the present invention, the solid media are selected from the group consisting of activated carbon, activated alumina, diatomaceous earth, and mixtures thereof. In embodiments of the present invention, the solid media are selected from the group consisting of MOF, COF, ZIF, activated carbon, activated alumina, and mixtures thereof. In embodiments of the present invention, the solid media are selected from the group consisting of diatomaceous earth, activated alumina, and mixtures thereof.

A non-limiting example of the physical mode of action is physical adsorption (also called physisorption), where a dissolved contaminant gets adsorbed onto the external surface or internal surface of pores of a filter particle due to van der Waals forces, and thus separated from the filtration feed stream. Another non-limiting example of the physical mode of action is electrostatic adsorption, where a suspended contaminant gets adsorbed onto the surface of a filter particle due to electrostatic attraction. The filter particles and media that remove contaminants primarily by adsorption are called adsorption filter particles and adsorption filter media, respectively.

The adsorption filtration medium is typically contained in a cylindrical filter container as either a loose medium or a bonded block, and the adsorption filtration can be either axial flow or radial flow. The cylindrical adsorption filter medium in axial flow has an aspect ratio defined as the ratio of the height to the diameter of the cylindrical adsorption filter medium. In embodiments of the present invention, the aspect ratio of the cylindrical adsorption filter medium is equal to or greater than about 1. In embodiments of the present invention, the aspect ratio of the cylindrical adsorption filter medium is equal to or greater than about 2. In embodiments of the present invention, the aspect ratio of the cylindrical adsorption filter medium is equal to or greater than about 5. In embodiments of the present invention, the aspect ratio of the cylindrical adsorption filter medium is equal to or greater than about 10. In embodiments of the present invention, the aspect ratio of the cylindrical adsorption filter medium is equal to or greater than about 30. In embodiments of the present invention, the aspect ratio of the cylindrical adsorption filter medium is equal to or greater than about 50. In embodiments of the present invention, the aspect ratio of the cylindrical adsorption filter medium is equal to or greater than about 70.

In embodiments of the present invention, the height of the cylindrical adsorption filter medium is equal to or greater than about 5 cm. In embodiments of the present invention, the height of the cylindrical adsorption filter medium is equal to or greater than about 20 cm. In embodiments of the present invention, the height of the cylindrical adsorption filter medium is equal to or greater than about 50 cm. In embodiments of the present invention, the height of the cylindrical adsorption filter medium is equal to or greater than about 1 m. In embodiments of the present invention, the height of the cylindrical adsorption filter medium is equal to or greater than about 1.5 m. In embodiments of the present invention, the height of the cylindrical adsorption filter medium is equal to or greater than about 3 m. In embodiments of the present invention, the height of the cylindrical adsorption filter medium is equal to or greater than about 6 m.

In embodiments of the present invention, the adsorption filter medium is cylindrical; wherein the filter medium comprises loose adsorption filter particles; wherein the height of the cylindrical adsorption medium is about 122 cm; wherein the diameter of the cylindrical adsorption medium is about 1.7 cm; wherein the adsorption filter particles comprise activated alumina; and wherein the particle size of the adsorption filter particles is 7×14 mesh.

In embodiments of the present invention, the solid media are contacted with the polymer in a vessel for a specified amount of time while the solid media are agitated. In embodiments of the present invention, the solid media are removed from the purer polymer solution via a solid-liquid separation step. Non-limiting examples of solid-liquid separation steps include filtration, decantation, centrifugation, and settling. In embodiments of the present invention, the contaminated polymer solution is passed through a stationary bed of solid media. In embodiments of the present invention, the solid media are replaced as needed to maintain a desired purity of polymer. In embodiments of the present invention, the solid media are regenerated and re-used in the purification step. In embodiments of the present invention, the solid media are regenerated by fluidizing the solid media during a backwashing step.

In embodiments of the present invention, a method for purifying reclaimed polymers includes contacting a polyethylene/fluid solvent solution with solid media at a temperature and at a pressure wherein the polyethylene remains dissolved in the fluid solvent. In embodiments of the present invention, a method for purifying reclaimed polymers includes contacting a polyethylene/fluid solvent solution with solid media at a temperature from about 90° C. to about 280° C. In embodiments of the present invention, a method for purifying reclaimed polymers includes contacting a polyethylene/fluid solvent solution with solid media at a temperature from about 110° C. to about 220° C. In embodiments of the present invention, a method for purifying reclaimed polymers includes contacting a polyethylene/fluid solvent solution with solid media at a pressure from about 200 psig (1.38 MPa) to about 9,000 psig (62.05 MPa). In embodiments of the present invention, a method for purifying reclaimed polymers includes contacting a polyethylene/fluid solvent solution with solid media at a pressure from about 400 psig (2.76 MPa) to about 2,600 psig (17.93 MPa).

In embodiments of the present invention, a method for purifying reclaimed polymers includes contacting a polyethylene/n-butane solution with solid media at a temperature from about 90° C. to about 280° C. In embodiments of the present invention, a method for purifying reclaimed polymers includes contacting a polyethylene/n-butane solution with solid media at a temperature from about 100° C. to about 220° C. In embodiments of the present invention, a method for purifying reclaimed polymers includes contacting a polyethylene/n-butane solution with solid media at a temperature from about 130° C. to about 180° C. In embodiments of the present invention, a method for purifying reclaimed polymers includes contacting a polyethylene/n-butane solution with solid media at a pressure from about 4000 psig (27.58 MPa) to about 8,000 psig (55.16 MPa). In embodiments of the present invention, a method for purifying reclaimed polymers includes contacting a polyethylene/n-butane solution with solid media at a pressure from about 4,200 psig (28.96 MPa) to about 7,000 psig (48.26 MPa). In embodiments of the present invention, a method for purifying reclaimed polymers includes contacting a polyethylene/n-butane solution with solid media at a pressure from about 4,500 psig (31.03 MPa) to about 6,000 psig (41.37 MPa).

In embodiments of the present invention, a method for purifying reclaimed polymers includes contacting a polyethylene/n-butane solution with solid media wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes contacting a polyethylene/n-butane solution with solid media wherein the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes contacting a polyethylene/n-pentane solution with solid media at a temperature from about 90° C. to about 280° C. In embodiments of the present invention, a method for purifying reclaimed polymers includes contacting a polyethylene/n-pentane solution with solid media at a temperature from about 100° C. to about 220° C. In embodiments of the present invention, a method for purifying reclaimed polymers includes contacting a polyethylene/n-pentane solution with solid media at a temperature from about 130° C. to about 180° C. In embodiments of the present invention, a method for purifying reclaimed polymers includes contacting a polyethylene/n-pentane solution with solid media at a pressure from about 800 psig (5.52 MPa) to about 4,000 psig (27.58 MPa). In embodiments of the present invention, a method for purifying reclaimed polymers includes contacting a polyethylene/n-pentane solution with solid media at a pressure from about 900 psig (6.21 MPa) to about 3,000 psig (20.68 MPa). In embodiments of the present invention, a method for purifying reclaimed polymers includes contacting a polyethylene/n-pentane solution with solid media at a pressure from about psig (31.03 MPa) to about 6,000 psig (41.37 MPa).

In embodiments of the present invention, a method for purifying reclaimed polymers includes contacting a polyethylene/n-pentane solution with solid media wherein the polyethylene is dissolved at a mass percent concentration of at least 0.5%. In embodiments of the present invention, the polyethylene is dissolved at a mass percent concentration of at least 1%. In embodiments of the present invention, the polyethylene is dissolved at a mass percent concentration of at least 2%. In embodiments of the present invention, the polyethylene is dissolved at a mass percent concentration of at least 3%. In embodiments of the present invention, the polyethylene is dissolved at a mass percent concentration of at least 4%. In embodiments of the present invention, the polyethylene is dissolved at a mass percent concentration of at least 5%. In embodiments of the present invention, a method for purifying reclaimed polymers includes contacting a polyethylene/n-pentane solution with solid media wherein the polyethylene is dissolved at a mass percent concentration up to 20%. In embodiments of the present invention, the polyethylene is dissolved at a mass percent concentration up to 18%. In embodiments of the present invention, the polyethylene is dissolved at a mass percent concentration up to 16%. In embodiments of the present invention, the polyethylene is dissolved at a mass percent concentration up to 14%. In embodiments of the present invention, the polyethylene is dissolved at a mass percent concentration up to 12%.

In embodiments of the present invention, a method for purifying reclaimed polymers includes contacting a polypropylene/n-butane solution with solid media at a temperature from about 90° C. to about 280° C. In embodiments of the present invention, a method for purifying reclaimed polymers includes contacting a polypropylene/n-butane solution with solid media at a temperature from about 100° C. to about 220° C. In embodiments of the present invention, a method for purifying reclaimed polymers includes contacting a polypropylene/n-butane solution with solid media at a temperature from about 130° C. to about 180° C. In embodiments of the present invention, a method for purifying reclaimed polymers includes contacting a polypropylene/n-butane solution with solid media at a pressure from about 350 psig (2.41 MPa) to about 4,000 psig (27.57 MPa). In embodiments of the present invention, a method for purifying reclaimed polymers includes contacting a polypropylene/n-butane solution with solid media at a pressure from about 1,000 psig (6.89 MPa) to about 3,500 psig (24.13 MPa). In embodiments of the present invention, a method for purifying reclaimed polymers includes contacting a polypropylene/n-butane solution with solid media at a pressure from about 2,000 psig (13.79 MPa) to about 3,000 psig (20.68 MPa).

In embodiments of the present invention, a method for purifying reclaimed polymers includes contacting a polypropylene/n-butane solution with solid media wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes contacting a polypropylene/n-butane solution with solid media wherein the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes contacting a polypropylene/propane solution with solid media at a temperature from about 90° C. to about 280° C. In embodiments of the present invention, a method for purifying reclaimed polymers includes contacting a polypropylene/propane solution with solid media at a temperature from about 100° C. to about 220° C. In embodiments of the present invention, a method for purifying reclaimed polymers includes contacting a polypropylene/propane solution with solid media at a temperature from about 130° C. to about 180° C. In embodiments of the present invention, a method for purifying reclaimed polymers includes contacting a polypropylene/propane solution with solid media at a pressure from about 2,000 psig (13.79 MPa) to about 8,000 psig (55.16 MPa). In embodiments of the present invention, a method for purifying reclaimed polymers includes contacting a polypropylene/propane solution with solid media at a pressure from about 3,000 psig (20.68 MPa) to about 6,000 psig (41.37 MPa). In embodiments of the present invention, a method for purifying reclaimed polymers includes contacting a polypropylene/propane solution with solid media at a pressure from about 3,500 psig (24.13 MPa) to about 5,000 psig (34.47 MPa).

In embodiments of the present invention, a method for purifying reclaimed polymers includes contacting a polypropylene/propane solution with solid media wherein the polypropylene is dissolved at a mass percent concentration of at least 0.5%. In embodiments of the present invention, the polypropylene is dissolved at a mass percent concentration of at least 1%. In embodiments of the present invention, the polypropylene is dissolved at a mass percent concentration of at least 2%. In embodiments of the present invention, the polypropylene is dissolved at a mass percent concentration of at least 3%. In embodiments of the present invention, the polypropylene is dissolved at a mass percent concentration of at least 4%. In embodiments of the present invention, the polypropylene is dissolved at a mass percent concentration of at least 5%. In embodiments of the present invention, a method for purifying reclaimed polymers includes contacting a polypropylene/propane solution with solid media wherein the polypropylene is dissolved at a mass percent concentration up to 20%. In embodiments of the present invention, the polypropylene is dissolved at a mass percent concentration up to 18%. In embodiments of the present invention, the polypropylene is dissolved at a mass percent concentration up to 16%. In embodiments of the present invention, the polypropylene is dissolved at a mass percent concentration up to 14%. In embodiments of the present invention, the polypropylene is dissolved at a mass percent concentration up to 12%.

In embodiments of the present invention, a method for purifying reclaimed polymers includes contacting a polystyrene/fluid solvent solution with solid media at a temperature and at a pressure wherein the polystyrene remains dissolved in the fluid solvent. In embodiments of the present invention, a method for purifying reclaimed polymers includes contacting a polystyrene/n-butane solution with solid media at a temperature from about 90° C. to about 280° C. In embodiments of the present invention, a method for purifying reclaimed polymers includes contacting a polystyrene/n-butane solution with solid media at a temperature from about 100° C. to about 220° C. In embodiments of the present invention, a method for purifying reclaimed polymers includes contacting a polystyrene/n-butane solution with solid media at a temperature from about 130° C. to about 180° C. In embodiments of the present invention, a method for purifying reclaimed polymers includes contacting a polystyrene/n-butane solution with solid media at a pressure from about 1,000 psig (6.89 MPa) to about 9,000 psig (62.05 MPa). In embodiments of the present invention, a method for purifying reclaimed polymers includes contacting a polystyrene/n-butane solution with solid media at a pressure from about 2,000 psig (13.79 MPa) to about 8,000 psig (55.16 MPa). In embodiments of the present invention, a method for purifying reclaimed polymers includes contacting a polystyrene/n-butane solution with solid media at a pressure from about 4,500 psig (31.03 MPa) to about 7,500 psig (51.71 MPa).

In embodiments of the present invention, a method for purifying reclaimed polymers includes contacting a polystyrene/n-butane solution with solid media wherein the polystyrene is dissolved at a mass percent concentration of at least 0.5%. In embodiments of the present invention, the polystyrene is dissolved at a mass percent concentration of at least 1%. In embodiments of the present invention, the polystyrene is dissolved at a mass percent concentration of at least 2%. In embodiments of the present invention, the polystyrene is dissolved at a mass percent concentration of at least 3%. In embodiments of the present invention, the polystyrene is dissolved at a mass percent concentration of at least 4%. In embodiments of the present invention, the polystyrene is dissolved at a mass percent concentration of at least 5%. In embodiments of the present invention, a method for purifying reclaimed polymers includes contacting a polystyrene/n-butane solution with solid media wherein the polystyrene is dissolved at a mass percent concentration up to 20%. In embodiments of the present invention, the polystyrene is dissolved at a mass percent concentration up to 18%. In embodiments of the present invention, the polystyrene is dissolved at a mass percent concentration up to 16%. In embodiments of the present invention, the polystyrene is dissolved at a mass percent concentration up to 14%. In embodiments of the present invention, the polystyrene is dissolved at a mass percent concentration up to 12%.

In embodiments of the present invention, a method for purifying reclaimed polymers includes contacting a poly(dimethylsiloxane)/fluid solvent solution with solid media at a temperature and at a pressure wherein the poly(dimethylsiloxane) remains dissolved in the fluid solvent. In embodiments of the present invention, a method for purifying reclaimed polymers includes contacting a poly(dimethylsiloxane)/n-butane solution with solid media at a temperature from about 115° C. to about 280° C. In embodiments of the present invention, a method for purifying reclaimed polymers includes contacting a poly(dimethylsiloxane)/n-butane solution with solid media at a temperature from about 120° C. to about 220° C. In embodiments of the present invention, a method for purifying reclaimed polymers includes contacting a poly(dimethylsiloxane)/n-butane solution with solid media at a temperature from about 140° C. to about 180° C. In embodiments of the present invention, a method for purifying reclaimed polymers includes contacting a poly(dimethylsiloxane)/n-butane solution with solid media at a pressure from about 500 psig (3.45 MPa) to about 2,100 psig (14.48 MPa). In embodiments of the present invention, a method for purifying reclaimed polymers includes contacting a poly(dimethylsiloxane)/n-butane solution with solid media at a pressure from about 700 psig (4.83 MPa) to about 1,400 psig (9.65 MPa). In embodiments of the present invention, a method for purifying reclaimed polymers includes contacting a poly(dimethylsiloxane)/n-butane solution with solid media at a pressure from about 800 psig (5.52 MPa) to about 1,300 psig (8.96 MPa).

In embodiments of the present invention, a method for purifying reclaimed polymers includes contacting a poly(dimethylsiloxane)/n-butane solution with solid media wherein the poly(dimethylsiloxane) is dissolved at a mass percent concentration of at least 0.5%. In embodiments of the present invention, the poly(dimethylsiloxane) is dissolved at a mass percent concentration of at least 1%. In embodiments of the present invention, the poly(dimethylsiloxane) is dissolved at a mass percent concentration of at least 2%. In embodiments of the present invention, the poly(dimethylsiloxane) is dissolved at a mass percent concentration of at least 3%. In embodiments of the present invention, the poly(dimethylsiloxane) is dissolved at a mass percent concentration of at least 4%. In embodiments of the present invention, the poly(dimethylsiloxane) is dissolved at a mass percent concentration of at least 5%. In embodiments of the present invention, a method for purifying reclaimed polymers includes contacting a poly(dimethylsiloxane)/n-butane solution with solid media wherein the poly(dimethylsiloxane) is dissolved at a mass percent concentration up to 20%. In embodiments of the present invention, the poly(dimethylsiloxane) is dissolved at a mass percent concentration up to 18%. In embodiments of the present invention, the poly(dimethylsiloxane) is dissolved at a mass percent concentration up to 16%. In embodiments of the present invention, the poly(dimethylsiloxane) is dissolved at a mass percent concentration up to 14%. In embodiments of the present invention, the poly(dimethylsiloxane) is dissolved at a mass percent concentration up to 12%.

In embodiments of the present invention, a method for purifying a reclaimed polymer is disclosed. The method comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of alkyl phenols, bisphenols, dioxins, PCBs, and phthalates; b) leaching said alkyl phenols, bisphenols, dioxins, PCBs, or phthalates from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of alkyl phenols, bisphenols, dioxins, PCBs, or phthalates, each having a concentration; and wherein said average removal efficiency is greater than about 55%; c) extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer; d) dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant; e) settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant; f) filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant; and g) filtering the third solution by adsorptive filtration at a temperature from about 90° C. to about 280° C. and at a pressure from about 200 psig (1.38 MPa) to about 9,000 psig (62.05 MPa) to produce a fourth solution comprising a filtered polymer.

In embodiments of the present invention, a method for purifying a reclaimed polymer is disclosed. The method comprises: a) obtaining the reclaimed polymer; wherein the reclaimed polymer is selected from the group consisting of post-consumer reclaimed (PCR) polymers, post-industrial reclaimed (PIR) polymers, and combinations thereof; and wherein said reclaimed polymer comprises contaminants, each contaminant having a concentration; and wherein said reclaimed polymer contaminants comprise at least one of 4-tertpentylphenol, bisphenol A, OCDD, PCB 118, and 2-ethylhexyl phthalate; b) surface washing said reclaimed polymer in a non-densified state to produce a surface-washed polymer; wherein said surface washing results in a greater than about 80% reduction in loosely bound surface contamination; c) leaching said 4-tertpentylphenol, bisphenol A, OCDD, PCB 118, and 2-ethylhexyl phthalate from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of 4-tertpentylphenol, bisphenol A, OCDD, PCB 118, and 2-ethylhexyl phthalate, each having a concentration; wherein said average removal efficiency is greater than about 55%; d) extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer; e) dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant; f) settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant; g) filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant; and h) filtering the third solution by adsorptive filtration at a temperature from about 90° C. to about 280° C. and at a pressure from about 200 psig (1.38 MPa) to about 9,000 psig (62.05 MPa) by contacting the third solution with one or more solid media to produce a fourth solution comprising a twice filtered polymer.

In embodiments of the present invention, the temperature in the extraction, dissolution, settling, and filtration steps is from about 110° C. to about 220° C. In embodiments of the present invention, the pressure in the dissolution, settling, and filtration steps is from about 400 psig (2.76 MPa) to about 2,600 psig (17.93 MPa).

Separation

In embodiments of the present invention, a method for purifying reclaimed polymers includes separating the purer polymer from the fluid solvent at a temperature and at a pressure wherein the polymer precipitates from solution and is no longer dissolved in the fluid solvent. In embodiments of the present invention, the precipitation of the purer polymer from the fluid solvent is accomplished by reducing the pressure at a fixed temperature. In embodiments of the present invention, the precipitation of the purer polymer from the fluid solvent is accomplished by reducing the temperature at a fixed pressure. In embodiments of the present invention, the precipitation of the purer polymer from the fluid solvent is accomplished by increasing the temperature at a fixed pressure. In embodiments of the present invention, the precipitation of the purer polymer from the fluid solvent is accomplished by reducing both the temperature and pressure. The solvent can be partially or completely converted from the liquid to the vapor phase by controlling the temperature and pressure. In embodiments of the present invention, the precipitated polymer is separated from the fluid solvent without completely converting the fluid solvent into a 100% vapor phase by controlling the temperature and pressure of the solvent during the separation step. The separation of the precipitated purer polymer is accomplished by any method of liquid-liquid or liquid-solid separation. Non-limiting examples of liquid-liquid or liquid-solid separations include filtration, decantation, centrifugation, and settling.

In embodiments of the present invention, a method for purifying reclaimed polymers includes separating polyethylene from a polyethylene/fluid solvent solution at a temperature and a pressure wherein the polyethylene precipitates from solution. In embodiments of the present invention, a method for purifying reclaimed polymers includes separating polyethylene from a polyethylene/n-butane solution at a temperature from about 0° C. to about 280° C. In embodiments of the present invention, a method for purifying reclaimed polymers includes separating polyethylene from a polyethylene/n-butane solution at a temperature from about 50° C. to about 175° C. In embodiments of the present invention, a method for purifying reclaimed polymers includes separating polyethylene from a polyethylene/n-butane solution at a temperature from about 100° C. to about 220° C. In embodiments of the present invention, a method for purifying reclaimed polymers includes separating polyethylene from a polyethylene/n-butane solution at a pressure from about 0 psig (0 MPa) to about 4,000 psig (27.58 MPa). In embodiments of the present invention, a method for purifying reclaimed polymers includes separating polyethylene from a polyethylene/n-butane solution at a pressure from about 50 psig (0.34 MPa) to about 2,000 psig (13.79 MPa). In embodiments of the present invention, a method for purifying reclaimed polymers includes separating polyethylene from a polyethylene/n-butane solution at a pressure from about 75 psig (0.52 MPa) to about 1,000 psig (6.89 MPa).

In embodiments of the present invention, a method for purifying reclaimed polymers includes separating polyethylene from a polyethylene/n-pentane solution at a temperature from about 0° C. to about 280° C. In embodiments of the present invention, a method for purifying reclaimed polymers includes separating polyethylene from a polyethylene/n-pentane solution at a temperature from about 30° C. to about 150° C. In embodiments of the present invention, a method for purifying reclaimed polymers includes separating polyethylene from a polyethylene/n-pentane solution at a temperature from about 50° C. to about 130° C. In embodiments of the present invention, a method for purifying reclaimed polymers includes separating polyethylene from a polyethylene/n-pentane solution at a pressure from about 0 psig (0 MPa) to about 2,000 psig (13.79 MPa). In embodiments of the present invention, a method for purifying reclaimed polymers includes separating polyethylene from a polyethylene/n-pentane solution at a pressure from about 50 psig (0.34 MPa) to about 1,500 psig (10.34 MPa). In embodiments of the present invention, a method for purifying reclaimed polymers includes separating polyethylene from a polyethylene/n-pentane solution at a pressure from about 75 psig (0.52 MPa) to about 1,000 psig (6.89 MPa).

In embodiments of the present invention, a method for purifying reclaimed polymers includes separating polypropylene from a polypropylene/fluid solvent solution at a temperature and at a pressure wherein the polypropylene precipitates from solution. In embodiments of the present invention, a method for purifying reclaimed polymers includes separating polypropylene from a polypropylene/n-butane solution at a temperature from about 0° C. to about 220° C. In embodiments of the present invention, a method for purifying reclaimed polymers includes separating polypropylene from a polypropylene/n-butane solution at a temperature from about 100° C. to about 200° C. In embodiments of the present invention, a method for purifying reclaimed polymers includes separating polypropylene from a polypropylene/n-butane solution at a temperature from about 130° C. to about 180° C. In embodiments of the present invention, a method for purifying reclaimed polymers includes separating polypropylene from a polypropylene/n-butane solution at a pressure from about 0 psig (0 MPa) to about 2,000 psig (13.79 MPa). In embodiments of the present invention, a method for purifying reclaimed polymers includes separating polypropylene from a polypropylene/n-butane solution at a pressure from about 50 psig (0.34 MPa) to about 1,500 psig (10.34 MPa). In embodiments of the present invention, a method for purifying reclaimed polymers includes separating polypropylene from a polypropylene/n-butane solution at a pressure from about 75 psig (0.52 MPa) to about 1,000 psig (6.89 MPa).

In embodiments of the present invention, a method for purifying reclaimed polymers includes separating polypropylene from a polypropylene/propane solution at a temperature from about −42° C. to about 220° C. In embodiments of the present invention, a method for purifying reclaimed polymers includes separating polypropylene from a polypropylene/propane solution at a temperature from about 0° C. to about 150° C. In embodiments of the present invention, a method for purifying reclaimed polymers includes separating polypropylene from a polypropylene/propane solution at a temperature from about 50° C. to about 130° C. In embodiments of the present invention, a method for purifying reclaimed polymers includes separating polypropylene from a polypropylene/propane solution at a pressure from about 0 psig (0 MPa) to about 6,000 psig (41.37 MPa). In embodiments of the present invention, a method for purifying reclaimed polymers includes separating polypropylene from a polypropylene/propane solution at a pressure from about 50 psig (0.34 MPa) to about 3,000 psig (20.68 MPa). In embodiments of the present invention, a method for purifying reclaimed polymers includes separating polypropylene from a polypropylene/propane solution at a pressure from about 75 psig (0.52 MPa) to about 1,000 psig (6.89 MPa).

In embodiments of the present invention, a method for purifying reclaimed polymers includes separating polystyrene from a polystyrene/fluid solvent solution at a temperature and at a pressure wherein the polystyrene precipitates from solution. In embodiments of the present invention, a method for purifying reclaimed polymers includes separating polystyrene from a polystyrene/n-butane solution at a temperature from about 0° C. to about 220° C. In embodiments of the present invention, a method for purifying reclaimed polymers includes separating polystyrene from a polystyrene/n-butane solution at a temperature from about 100° C. to about 200° C. In embodiments of the present invention, a method for purifying reclaimed polymers includes separating polystyrene from a polystyrene/n-butane solution at a temperature from about 130° C. to about 180° C. In embodiments of the present invention, a method for purifying reclaimed polymers includes separating polystyrene from a polystyrene/n-butane solution at a pressure from about 0 psig (0 MPa) to about 2,000 psig (13.79 MPa). In embodiments of the present invention, a method for purifying reclaimed polymers includes separating polystyrene from a polystyrene/n-butane solution at a pressure from about 50 psig (0.34 MPa) to about 1,500 psig (10.34 MPa). In embodiments of the present invention, a method for purifying reclaimed polymers includes separating polystyrene from a polystyrene/n-butane solution at a pressure from about 75 psig (0.52 MPa) to about 1,000 psig (6.89 MPa).

In embodiments of the present invention, a method for purifying reclaimed polymers includes separating poly(dimethylsiloxane) from a poly(dimethylsiloxane)/fluid solvent solution at a temperature and at a pressure wherein the poly(dimethylsiloxane) precipitates from solution. In embodiments of the present invention, a method for purifying reclaimed polymers includes separating poly(dimethylsiloxane) from a poly(dimethylsiloxane)/n-butane solution at a temperature from about 0° C. to about 220° C. In embodiments of the present invention, a method for purifying reclaimed polymers includes separating poly(dimethylsiloxane) from a poly(dimethylsiloxane)/n-butane solution at a temperature from about 115° C. to about 200° C. In embodiments of the present invention, a method for purifying reclaimed polymers includes separating poly(dimethylsiloxane) from a poly(dimethylsiloxane)/n-butane solution at a temperature from about 120° C. to about 180° C. In embodiments of the present invention, a method for purifying reclaimed polymers includes separating poly(dimethylsiloxane) from a poly(dimethylsiloxane)/n-butane solution at a pressure from about 0 psig (0 MPa) to about 1,500 psig (10.34 MPa). In embodiments of the present invention, a method for purifying reclaimed polymers includes separating poly(dimethylsiloxane) from a poly(dimethylsiloxane)/n-butane solution at a pressure from about 50 psig (0.34 MPa) to about 1,000 psig (6.89 MPa). In embodiments of the present invention, a method for purifying reclaimed polymers includes separating poly(dimethylsiloxane) from a poly(dimethylsiloxane)/n-butane solution at a pressure from about 75 psig (0.52 MPa) to about 500 psig (3.45 MPa).

In embodiments of the present invention, the filtered polymer is separated from the fourth solution at a temperature from about 0° C. to about 280° C. and a pressure from about 0 psig (0 MPa) to about 2,000 psig (13.79 MPa).

### IX. Test Methods

The test methods described herein are used to measure the effectiveness of various methods for purifying polymers. Specifically, the methods described demonstrate the effectiveness of a given purification method at improving color and translucency/clarity (i.e., making the color and opacity of the reclaimed polymer closer to that of an uncolored virgin polymer), reducing or eliminating elemental contamination (i.e., removing heavy metals), reducing or eliminating non-combustible contamination (i.e., inorganic fillers), reducing or eliminating volatile compounds (especially volatile compounds that contribute to the malodor of reclaimed polymers), and reducing or eliminating polymeric contamination (i.e., polyethylene contamination in polypropylene).

Color and Opacity Measurement

The color and opacity/translucency of a polymer are important parameters that determine whether or not a polymer can achieve the desired visual aesthetics of an article manufactured from the polymer. Reclaimed polymers, especially PCR polymers, are typically dark in color and opaque due to residual pigments, fillers, and other contamination. Thus, color and opacity measurements are important parameters in determining the effectiveness of a method for purifying polymers. Prior to color measurement, samples of either polymeric powders or pellets were compression molded into 30 mm wide×30 mm long×1 mm thick square test specimens (with rounded corners). Powder samples were first densified at room temperature (ca. 20-23° C.) by cold pressing the powder into a sheet using clean, un-used aluminum foil as a contact-release layer between stainless steel platens. Approximately 0.85 g of either cold-pressed powder or pellets was then pressed into test specimens on a Carver Press Model C (Carver, Inc., Wabash, IN 46992-0554 USA) pre-heated to 200° C. using aluminum platens, unused aluminum foil release layers, and a stainless-steel shim with a cavity corresponding to aforementioned dimensions of the square test specimens. Samples were heated for 5 min prior to applying pressure. After 5 min, the press was then compressed with at least 2 tons (1.81 metric tons) of hydraulic pressure for at least 5 seconds and then released. The molding stack was then removed and placed between two thick flat metal heat sinks for cooling. The aluminum foil contact release layers were then peeled from the sample and discarded. The flash around the sample on at least one side was peeled to the mold edge and then the sample was pushed through the form. Each test specimen was visually evaluated for voids/bubble defects and only samples with no defects in the color measurement area (0.7″ (17.78 mm) diameter minimum) were used for color measurement.

The color of each sample was characterized using the International Commission on Illumination (CIE) L*, a*, b* three-dimensional color space. The dimension L* is a measure of the lightness of a sample, with L*=0 corresponding to the darkest black sample and L*=100 corresponding to the brightest white sample. The dimension a* is a measure of the red or green color of a sample with positive values of a* corresponding with a red color and negative values of a* corresponding with a green color. The dimension b* is a measure of the blue or yellow color of a sample with positive values of b* corresponding with a yellow color and negative values of b* corresponding with a blue color. The L*a*b* values of each 30 mm wide×30 mm long×1 mm thick square test specimen sample were measured on a Hunter Lab model LabScan XE spectrophotometer (Hunter Associates Laboratory, Inc., Reston, VA 20190-5280, USA). The spectrophotometer was configured with D65 as the standard illuminant, an observer angle of 10°, an area diameter view of 1.75″ (44.45 mm), and a port diameter of 0.7″ (17.78 mm).

The opacity of each sample, which is a measure of how much light passes through the sample (i.e., a measure of the sample's translucency), was determined using the aforementioned Hunter Lab spectrophotometer using the contrast ratio opacity mode. Two measurements were made to determine the opacity of each sample. One to measure the brightness value of the sample backed with a white backing, Y_{White Backing}, and one to measure the brightness value of the sample backed with a black backing, Y_{Black Backing}. The opacity was then calculated from the brightness values using the following equation:

$$\% Opacity = \frac{{Y}_{Black Backing}}{{Y}_{White Backing}} * 100.$$

Elemental Analysis

Many reclaimed polymers have unacceptably high concentrations of heavy metal contamination. The presence of heavy metals, for example lead, mercury, cadmium, and chromium, may prevent the use of reclaimed polymers in certain applications, such as food or drug contact applications or medical device applications. Thus, measuring the concentration of heavy metals is important when determining the effectiveness of a method for purifying polymers.

Elemental analysis was performed using Inductively Coupled Plasma Mass Spectrometry (ICP-MS). Test solutions were prepared in n=2 to n=6 depending on sample availability by combing about 0.25 g sample with 4 mL of concentrated nitric acid and 1 mL of concentrated hydrofluoric acid (HF). The samples were digested using an Ultrawave Microwave Digestion protocol consisting of a 20 min ramp to 125° C., a 10 min ramp to 250° C. and a 20 min hold at 250° C. Digested samples were cooled to room temperature. The digested samples were diluted to 50 mL after adding 0.25 mL of 100 ppm Ge and Rh as the internal standard. In order to assess accuracy of measurement, pre-digestion spikes were prepared by spiking virgin polymer. Virgin polymer spiked samples were weighed out using the same procedure mentioned above and spiked with the appropriate amount of each single element standard of interest, which included the following: Na, Al, Ca, Ti, Cr, Fe, Ni, Cu, Zn, Cd, and Pb. Spikes were prepared at two different levels: a “low level spike” and a “high level spike”. Each spike was prepared in triplicate. In addition to spiking virgin polymer, a blank was also spiked to verify that no errors occurred during pipetting and to track recovery through the process. The blank spiked samples were also prepared in triplicate at the two different levels and were treated in the same way as the spiked virgin polymer and the test samples. A 9-point calibration curve was made by making 0.05, 0.1, 0.5, 1, 5, 10, 50, 100, and 500 ppb solutions containing Na, Al, Ca, Ti, Cr, Fe, Ni, Cu, Zn, Cd, and Pb. All calibration standards were prepared by dilution of neat standard reference solutions and 0.25 mL of 100 ppm Ge and Rh as the internal standard with 4 mL of concentrated nitric and 1 mL of concentrated HF. Prepared standards, test samples, and spiked test samples were analyzed using an Agilent's 8800 ICP-QQQMS, optimized according to manufacturer recommendations. The monitored m/z for each analyte and the collision cell gas that was used for analysis was as follows: Na, 23 m/z, H₂; Al, 27 m/z, H₂; Ca, 40 m/z, H₂; Ti, 48 m/z, H₂; Cr, 52 m/z, He; Fe, 56 m/z, H₂; Ni, 60 m/z; no gas; Cu, 65 m/z, no gas; Zn, 64 m/z, He; Cd, 112 m/z; H₂; Pb, sum of 206≥206, 207≥207, 208≥208 m/z, no gas; Ge, 72 m/z, all modes; Rh, 103 m/z, all modes. Ge was used as an internal standard for all elements lower than 103 m/z and Rh was used for all elements greater than 103 m/z.

Residual Ash Content

Many reclaimed polymers contain various fillers, for example calcium carbonate, talcum, and glass fiber. While useful in the original application of the reclaimed polymer, these fillers alter the physical properties of a polymer in way that may be undesired for the next application of the reclaimed polymer. Thus, measuring the amount of filler is important when determining the effectiveness of a method for purifying polymers.

Thermogravimetric analysis (TGA) was performed to quantify the amount of non-combustible materials in the sample (also sometimes referred to as Ash Content). About 5-15 mg of sample was loaded onto a platinum sample pan and heated to 700° C. at a rate of 20° C./min in an air atmosphere in a TA Instruments model Q500 TGA instrument. The sample was held isothermal for 10 min at 700° C. The percentage residual mass was measured at 700° C. after the isothermal hold.

Odor Analysis

Odor sensory analysis was performed by placing about 3 g of each sample in a 20 mL glass vial and equilibrating the sample at room temperature for at least 30 min. After equilibration, each vial was opened, and the headspace was sniffed (bunny sniff) by a trained grader to determine odor intensity and descriptor profile. Odor intensity was graded according to the following scale: 5=Very Strong; 4=Strong; 3=Moderate; 2=Weak to Moderate; 1=Weak; and 0=No odor.

Polymeric Contamination Analysis

Many reclaimed polymers, especially reclaimed polymers originating from mixed-stream sources, may contain undesired polymeric contamination. Without wishing to be bound by any theory, polymeric contamination, for example polyethylene contamination in polypropylene, may influence the physical properties of the polymer due to the presence of heterogeneous phases and the resulting weak interfaces. Furthermore, the polymeric contamination may also increase the opacity of the polymer and have an influence on the color. Thus, measuring the amount of polymeric contamination is important when determining the effectiveness of a method for purifying polymers.

Semi-crystalline polymeric contamination was evaluated using Differential Scanning calorimetry (DSC). For example, to measure the amount of polyethylene contamination in polypropylene, a set of five polypropylene/polyethylene blends were prepared with 2, 4, 6, 8, and 10 wt % of Formolene® HB5502F HDPE (Formosa Plastics Corporation, USA) in Pro-fax 6331 polypropylene (LyondellBasell Industries Holdings, B.V.). Approximately 5-15 mg of each sample was sealed in an aluminum DSC pan and analyzed on a TA Instruments model Q2000 DSC with the following method:
1. Equilibrate at 30.00° C.
2. Ramp 20.00° C./min to 200.00° C.
3. Mark end of cycle 0
4. Ramp 20.00° C./min to 30.00° C.
5. Mark end of cycle 1
6. Ramp 20.00° C./min to 200.00° C.
7. Mark end of cycle 2
8. Ramp 20.00° C./min to 30.00° C.
9. Mark end of cycle 3
10. Ramp 5.00° C./min to 200.00° C.
11. Mark end of cycle 4

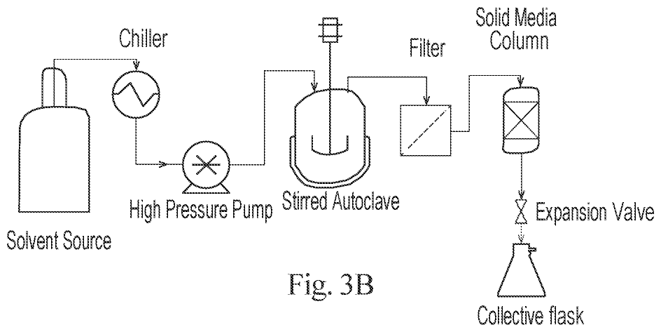

The enthalpy of melting for the HDPE peak around 128° C. was calculated for each sample of known HDPE content using the 5.00° C./min DSC thermogram. A linear calibration curve, shown in FIG. 2, was established plotting enthalpy of melting versus known HDPE concentration in wt %.

Samples having unknown PE content were analyzed using the same aforementioned DSC equipment and method. PE content was calculated using the aforementioned calibration curve. The specific HDPE used to generate the calibration curve will more than likely have a different degree of crystallinity than the polyethylene (or polyethylene blend) contamination that may be present in a reclaimed polymer sample. The degree of crystallinity may independently influence the measured enthalpy of melting for polyethylene and thus influence the resulting calculation of polyethylene content. However, the DSC test method described herein is meant to serve as a relative metric to compare the effectiveness of different methods to purify polymers and is not meant to be a rigorous quantification of the polyethylene content in a polymer blend. While the aforementioned method described the measurement of polyethylene contamination in polypropylene, this method may be applied to measurement of other semi-crystalline polymers using different temperature ranges and peaks in the DSC thermogram. Furthermore, alternative methods, such as nuclear magnetic resonance (NMR) spectroscopy, may also be used to measure the amount of both semi-crystalline and amorphous polymeric contamination in a sample.

Analytical Determination of Chemical Contaminants

For pesticides, the EN 15662:2018-07 Modular QuEChERS-method was applied. For alkylphenol ethoxylates, alkyl phenols, and bisphenols the following technique was applied: the samples were cut, homogenized, and weighted; then, an internal standard (deuterated bisphenol A) was added, the samples were then extracted with hexane at room temperature, MSTFA (N-Methyl-N-(trimethylsilyl)trifluoroacetamide) was added for derivatization, and the contaminant level was determined by GC-MSD. For dioxins, furans, and PCBs: the ISO/IEC 17025:2005 method was applied. The samples were cut into small pieces, 13C/12C-labeled PCDD/F internal standards to an aliquot of the sample material were added, extraction and destroying of the matrix by hexane and H₂SO₄ for 1 h was employed, re-extraction with hexane (3 times for 30 min) was employed, multi-step chromatographic clean-up was applied, 13C/12C-labeled PCDD/F-recovery standards to the measurement solutions were added, and quantification via the internal labelled PCDD/F-standards (isotope dilution technique and internal standard technique) was applied. For organotins: the method followed the EDANA-Protocol (WSP 351) for organotin compounds in absorbent hygiene products and their constituent raw materials. More specifically, the samples were extracted with a sodium diethyldithiocarbamate solution in ethanol, alkylated with sodium tetraethyl borate, and transferred by extraction with hexane into the organic phase. Then, the tetrasubstituted organotin compounds were separated by using capillary gas chromatography, proven with an AED or MS as detector. GC-ICP-MS was used as detector system for the organometallic analysis. For phthalates: the samples were cut, homogenized, and weighted. An internal standard and extraction by hexane at room temperature were then employed. The extracted phthalates were then identified and quantified by GC-MSD. For PAHs: the samples were cut, homogenized, and weighted. Then, an internal standard of deuterated PAHs was added, and the samples were extracted with hexane. The extracted PAHs were purer with silica gel, concentrated, and then characterized by GC-MSD.

Amount of Loosely Bound Surface Contamination

The amount of loosely bound surface contamination is determined by the following method: Approximately 20 g of plastic are added to a 1,000 mL round bottom flask. Approximately 300 mL of distilled water are added to the 1,000 mL round bottom flask. The round bottom flask is capped and then vigorously shaken for about 60 s. The water is decanted from the flask. Approximately 600 mL of additional distilled water are added to the 1,000 mL flask and then immediately decanted to leave the original reclaimed polymer with a small amount of water. The reclaimed polymer is removed from the round bottom and allowed to dry at 60° C. overnight in a convection oven. The % mass change of the plastic is the amount of loosely bound surface contamination.

Color Measurements for ΔE Calculations

Color measurements were obtained with a Minolta Spectrophotometer, Model CM580d. The ‘white’ portion of a Leneta card was used as a common background and as the reference point for ΔE calculations. ΔE is the color difference between a sample color and a reference color. Color measurements were taken using a D65 illuminant and a 10° observer. A minimum of three measurements were taken for each of the compressed thermoplastic starch composition samples. L, a, b values are averaged and reported along with ΔE values. ΔE values for the pure white Leneta card are zero and positive deviations from zero indicate increased discoloration. Those skilled in the art will know how to calculate the ΔE value.

### X. Examples

### Comparative Example 1—Purification of Post-Commercial Film Using the Dissolution Recycling Process

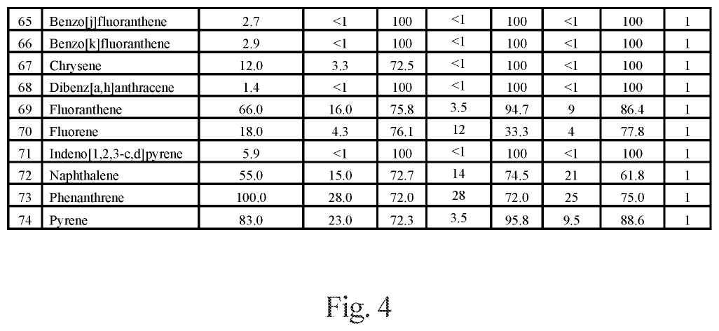

A sample from a post-commercial reclaimed (PCR) film (called input film), with concentration of 74 chemical contaminants measured by GALAB Laboratories GmbH (Am Schleusengraben 7, 21029 Hamburg, Germany) using the methods disclosed in Section IX and shown in FIG. 4, was processed using the experimental apparatuses shown in FIGS. 3A and 3B and the following procedure (at Phasex Corporation, 125 Flagship Drive, North Andover, MA). 30 g of the input film was loaded into a 300 mL (working volume) autoclave equipped with an overhead mechanical stirrer. The air from the autoclave headspace was removed with three repeat cycles of vacuuming and N₂ purging. The autoclave was then filled with n-butane and its contents were equilibrated at an internal temperature of about 160° C. and pressure of about 3,000 psig (20.7 MPa), i.e., extraction conditions. At those extraction conditions the material in the autoclave is in a two-phase regime, i.e., one phase with n-butane and a small amount of low-molecular-weight product film dissolved in it (light or extract phase), and the other phase with a large amount of product film dissolved in n-butane (heavy or raffinate phase). The autoclave material was then extracted two times using the experimental configuration of FIG. 3A and the following procedure: the autoclave material was stirred for about 10 min, then it was allowed to settle for about 10 min, and finally n-butane was flushed through the autoclave into the extract collection flask through an expansion valve. The above extraction procedure was repeated one more time. The remaining autoclave material was then dissolved in n-butane at the dissolution conditions of about 160° C. and about 4,700 psig (32.4 MPa), thus creating a one-phase system. The dissolved material was purified and collected using the experimental configuration of FIG. 3B and the following procedure: the autoclave material was stirred for about 60 min, then it was allowed to settle for about 60 min, then the autoclave material was removed from the autoclave by opening the autoclave valve and allowing it to pass through an axial flow filter with diatomaceous earth, an activated alumina column, an expansion valve, and get collected into the product collection flask. The axial flow filter contained 23 g of diatomaceous earth (Celatom® FW-80; EP Minerals, LLC; Reno, NV) and had 1 in. (2.54 cm) length and 1⅜ in. ID (3.5 cm). The activated alumina column had about 0.68 in. (1.73 cm) ID and about 30 in. (76.2 cm) length, and it was charged with about 97 g of activated alumina particles 28×48 mesh (0.39-0.71 mm; Sorbent Technologies, Inc.; Norcross, GA). The average particle size of the activated alumina particles was 0.55 mm. Samples from the product film were analyzed for the chemical contaminants shown in FIG. 4 by GALAB Laboratories GmbH (Am Schleusengraben 7, 21029 Hamburg, Germany) using the methods disclosed in Section IX. The average removal efficiency of these chemical contaminants by the dissolution recycling process was calculated as 86.8%.

### Comparative Example 2—Purification of Post-Commercial Film Using the Flooded Leaching Process in Counter-Current Screw Auger Equipment with Ethyl Acetate

About 4 kg of the same post-commercial reclaimed (PCR) film used in COMPARATIVE EXAMPLE 1 was processed in a continuous counter-current auger extraction, rotating at 3 rpm, with about 400 L of ethyl acetate, at 55-65° C., as the extractant to produce a product film. Samples from the product film were analyzed for the chemical contaminants shown in FIG. 4 by GALAB Laboratories GmbH using the methods disclosed in Section IX. The average removal efficiency of these chemical contaminants by the flooded leaching process was calculated as 91.6%.

### Example 1—Purification of Product Film from Comparative Example 2 Using the Dissolution Recycling Process

A sample of the product film from COMPARATIVE EXAMPLE 2 was processed using the experimental apparatuses shown in FIGS. 3A and 3B and the procedure disclosed in COMPARATIVE EXAMPLE 1. The main product fraction was labelled “PEC4-37 F2A” and samples from that fraction were analyzed for the chemical contaminants shown in FIG. 4 by GALAB Laboratories GmbH using the methods disclosed in Section IX.

The average removal efficiency of these chemical contaminants was calculated as 95.3%, which was higher than the average removal efficiency from either one of the component processes: 1) dissolution recycling alone (COMPARATIVE EXAMPLE 1) of 86.8% and 2) flooded leaching alone (COMPARATIVE EXAMPLE 2) of 91.6% (see FIG. 4). In addition to that, the product film of EXAMPLE 1 had 56 (out of the 74; i.e., 76%) chemical contaminants with levels below LOQ and 7 (out of the remaining 16 chemical contaminants; i.e., 44%) with removal efficiency above 90% each. For comparison, the product film of COMPARATIVE EXAMPLE 1 had 41 (out of the 74; i.e., 55%) chemical contaminants with levels below LOQ and 5 (out of the remaining 33 chemical contaminants; i.e., 15%) with removal efficiency above 90% each, and the product film of COMPARATIVE EXAMPLE 2 had 45 (out of the 74; i.e., 61%) chemical contaminants with levels below LOQ and 14 (out of the remaining 29 chemical contaminants; i.e., 48%) with removal efficiency above 90% each. Based on these average removal efficiency levels, the conclusion is that the combination of the flooded leaching and dissolution recycling processes provided a synergistic benefit in the removal of the chemical contaminants compared to either one of these individual processes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, comprising any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for purifying a reclaimed polymer comprising:
a. obtaining the reclaimed polymer; wherein the reclaimed polymer is at least one of post-consumer reclaimed (PCR) polymers, post-industrial reclaimed (PIR) polymers, or combinations thereof; and wherein said reclaimed polymer comprises contaminants, each contaminant having a concentration; and wherein said reclaimed polymer contaminants comprise at least one of pesticides, alkylphenol ethoxylates, alkylphenol s, bisphenols, dioxins and dioxin-like compounds, polychlorinated biphenyls (PCBs), metals, organotins, phthalates, or polycyclic aromatic hydrocarbons (PAHs);
b. leaching said pesticides, alkylphenol ethoxylates, alkylphenol s, bisphenols, dioxins and dioxin-like compounds, PCBs, metals, organotins, phthalates, and PAHs from said reclaimed polymer with an average removal efficiency, at a temperature below the primary melting point of said reclaimed polymer and a pressure between about atmospheric and about 1,000 atm, using a leaching solvent, in a number of leaching stages, for a total residence time and residence time for each said leaching stage, to produce a leached polymer comprising at least one of pesticides, alkyl phenol ethoxylates, alkylphenols, bisphenols, dioxins and dioxin-like compounds, PCBs, metals, organotins, phthalates, or PAHs, each having a concentration; and wherein said average removal efficiency of said leached polymer is greater than about 55%;
c. extracting the leached polymer at a temperature from about 80° C. to about 280° C. and at a pressure from about 150 psig (1.03 MPa) to about 8,000 psig (55.16 MPa) with a first fluid solvent having a standard boiling point less than about 70° C., to produce an extracted polymer;
d. dissolving the extracted polymer in a solvent selected from the group consisting of the first fluid solvent, a second fluid solvent, and mixtures thereof, at a temperature from about 90° C. to about 280° C. and a pressure from about 200 psig (1.38 MPa) to about 9,000 psig (62.05 MPa) to produce a first solution comprising a dissolved polymer, at least one dissolved contaminant, and at least one suspended contaminant;
e. settling the first solution at a temperature from about 90° C. to about 280° C. and at a pressure from about 200 psig (1.38 MPa) to about 9,000 psig (62.05 MPa) to produce a second solution comprising a settled polymer, at least one dissolved contaminant, and less of the at least one suspended contaminant;
f. filtering the second solution by mechanical filtration at a temperature from about 90° C. to about 280° C. and at a pressure from about 200 psig (1.38 MPa) to about 9,000 psig (62.05 MPa) to produce a third solution comprising a filtered polymer, at least one dissolved contaminant, and even less of the at least one suspended contaminant;
g. filtering the third solution by adsorptive filtration at a temperature from about 90° C. to about 280° C. and at a pressure from about 200 psig (1.38 MPa) to about 9,000 psig (62.05 MPa) to produce a fourth solution comprising a filtered polymer; and
h. separating the filtered polymer from the fourth solution to produce a purer polymer with an average removal efficiency; wherein said purer polymer comprises at least one of pesticides, alkylphenol ethoxylates, alkylphenols, bisphenols, dioxins and dioxin-like compounds, PCBs, metals, organotins, phthalates, or PAHs each having a concentration; wherein the second fluid solvent has the same chemical composition or a different chemical composition as the first fluid solvent; and wherein said average removal efficiency of said purer polymer is greater than about 75%.

2. The method of claim 1, wherein said alkyl phenols, bisphenols, dioxins, PCBs, and phthalates comprise at least one of 4-tertpentylphenol, bisphenol A, OCDD, PCB 118, or 2-ethylhexyl phthalate.

3. The method of claim 1, wherein said number of leaching stages is between about 1 and about 50.

4. The method of claim 1, wherein said reclaimed polymer has an average surface area to volume ratio greater than about 1 mm⁻¹.

5. The method of claim 1, wherein said total residence time of said leaching step is less than about 360 min.

6. The method of claim 1, wherein said leaching solvent is an organic solvent or a mixture of organic solvents.

7. The method of claim 6, wherein said leaching solvent is at least one of DME, diethyl ether, MEK, ethyl acetate, THF, acetone, methanol, CO₂, or mixtures thereof.

8. The method of claim 2, wherein said leaching temperature is between about 20° C. and 90° C. and said leaching pressure is between about atmospheric and about 1,000 atm; wherein said leaching solvent is ethyl acetate; wherein said total residence time of said leaching step is less than about 360 min; and wherein said average removal efficiency is about 55%.

9. The method of claim 1, wherein said reclaimed polymer is surface washed in a non-densified state in a surface washing step or steps prior to said leaching step; wherein said surface washing step or steps results in a greater than about 80% reduction in loosely bound surface contamination; and wherein said reclaimed polymer prior to said surface washing step has an average surface area to volume ratio greater than about 1 mm⁻¹.

10. The method of claim 1, wherein said reclaimed polymer is surface washed in a non-densified state in a surface washing step prior to the leaching step to produce a surface-washed polymer; wherein said surface washing results in greater than about 80% reduction in loosely bound surface contamination; wherein said reclaimed polymer prior to surface washing has an average surface area to volume ratio greater than about 1 mm⁻¹; wherein said surface washing process is of the de-inking type; wherein said de-inking process results in a ΔE change of less than about 10% between the de-inked polymer and the reclaimed polymer without surface printed ink; wherein said leaching step is conducted in a continuous stirred tank reactor (CSTR); wherein said leaching solvent is ethyl acetate; wherein said CSTR involves 3 leaching stages; wherein said leaching temperature is about 77° C. and said leaching pressure is near atmospheric; wherein said residence time of each of said leaching stages is about 20 min; wherein said average removal efficiency is greater than about 55%; and wherein said leached polymer is de-volatilized and densified using melt extrusion to produce a leached polymer pellet.

11. The method of claim 1, wherein the filtered polymer is separated from the fourth solution at a temperature from about 0° C. to about 280° C. and a pressure from about 0 psig (0 MPa) to about 2,000 psig (13.79 MPa).

12. The method of claim 1, wherein the extracted polymer is dissolved in the fluid solvent, or fluid solvent mixture, at a mass percent concentration of at least 0.5%.

13. The method of claim 1, wherein the reclaimed polymer is PCR polymer.

14. The method of claim 1, wherein the reclaimed polymer is a polypropylene homopolymer or a primarily polypropylene copolymer.

15. The method of claim 1, wherein the reclaimed polymer is a polyethylene homopolymer or a primarily polyethylene copolymer.

16. The method of claim 1, wherein the fluid solvent has a standard boiling point less than about 0° C. and greater than about −45° C. and a standard enthalpy change of vaporization of less than about +25 kJ/mol.

17. The method of claim 1, wherein the fluid solvent is at least one of olefinic hydrocarbons, aliphatic hydrocarbons, or mixtures thereof.

18. The method of claim 17, wherein the aliphatic hydrocarbon is at least one of C₁-C₆ aliphatic hydrocarbons or mixtures thereof.

19. The method of claim 18, wherein the fluid solvent comprises n-butane, butane isomers, or mixtures thereof.

20. The method of claim 1, wherein the temperature in the extraction, dissolution, settling, and filtration steps is from about 110° C. to about 220° C.

21. The method of claim 1, wherein the pressure in the extraction step is from about 400 psig (2.76 MPa) to about 2,400 psig (16.55 MPa).

22. The method of claim 1, wherein the pressure in the extraction step is less than about 1,100 psig (7.58 MPa).

23. The method of claim 1, wherein the pressure in the dissolution, settling, and filtration steps is from about 400 psig (2.76 MPa) to about 2,600 (17.93 MPa).

24. A method for purifying a reclaimed polyethylene comprising:
a. obtaining the reclaimed polyethylene; wherein the reclaimed polyethylene is post-consumer reclaimed (PCR) polyethylene; and wherein said reclaimed polyethylene comprises contaminants, each contaminant having a concentration; and wherein said reclaimed polymer contaminants comprise at least one of pesticides, alkylphenol ethoxylates, alkylphenol s, bisphenols, dioxins and dioxin-like compounds, polychlorinated biphenyls (PCBs), metals, organotins, phthalates, or polycyclic aromatic hydrocarbons (PAHs);
b. surface washing said reclaimed polymer in a non-densified state to produce a surface-washed polymer; wherein said surface washing results in a greater than about 80% reduction in loosely bound surface contamination;
c. leaching said pesticides, alkylphenol ethoxylates, alkylphenol s, bisphenols, dioxins and dioxin-like compounds, PCBs, metals, organotins, phthalates, and PAHs from said reclaimed polymer with an average removal efficiency, at a temperature between about 55° C. and about 65° C. and at a pressure of about atmospheric, using ethyl acetate, in a counter-current auger extraction, for a total residence time, to produce a leached polymer comprising at least one of pesticides, alkylphenol ethoxylates, alkylphenol s, bisphenols, dioxins and dioxin-like compounds, PCBs, metals, organotins, phthalates, or PAHs, each having a concentration; wherein said average removal efficiency of said leached polymer is greater than about 90%;
d. extracting the leached polymer at a temperature of about 160° C. and at a pressure of about 3,000 psig (20.7 MPa) with normal butane to produce an extracted polymer;
e. dissolving the extracted polymer in normal butane at a temperature of about 160° C. and at a pressure of about 4,700 psig (32.4 MPa) to produce a first solution comprising a dissolved polymer, at least one dissolved contaminant, and at least one suspended contaminant;
f. settling the first solution at a temperature of about 160° C. and at a pressure of about 4,700 psig (32.4 MPa) to produce a second solution comprising a settled polymer, at least one dissolved contaminant, and less of the at least one suspended contaminant;
g. filtering the second solution by mechanical filtration at a temperature of about 160° C. and at a pressure of about 4,700 psig (32.4 MPa) to produce a third solution comprising a filtered polymer, at least one dissolved contaminant, and even less of the at least one suspended contaminant;
h. filtering the third solution by adsorptive filtration at a temperature of about 160° C. and at a pressure of about 4,700 psig (32.4 MPa) by contacting the third solution with one or more solid media to produce a fourth solution comprising a twice filtered polymer; and
i. separating the filtered polymer from the fourth solution to produce a purer polymer with an average removal efficiency; wherein said purer polymer comprises at least one of pesticides, alkylphenol ethoxylates, alkylphenols, bisphenols, dioxins and dioxin-like compounds, PCBs, metals, organotins, phthalates, or PAHs each having a concentration; and wherein said average removal efficiency of said purer polymer is greater than about 95%.
